(19) United States
(12) Patent Application Publication
(10) Pub. No.: US 2002/0065828 A1
(43) Pub. Date: May 30, 2002

(54) Network communication using telephone number URI/URL identification handle

(76) Inventor: John D. Goodspeed, Annapolis, MD (US)

Correspondence Address: SUGHRUE, MION, ZINN,, MACPEAK & SEAS, PLLC, 2100 Pennsylvania Avenue, NW, Washington, DC, 20037-3213, US

(21) Appl. No.: 09/903,560

(22) Filed: Jul. 13, 2001

Related U.S. Application Data
(60) Provisional application No. 60/218,178, filed on Jul. 14, 2000.

(51) Int. Cl. G06F 17/30; G06F 7/00; G06F 15/16

(52) U.S. Cl. 707/100; 707/10; 709/218

(57) ABSTRACT

A method and device for enabling Internet users to communicate with one another or access information more easily, without requiring lengthy, hard-to-remember addresses. The method also enables personnel and resource management by providing easily updated databases containing information related to the resource or person of interest. By using an associated telephone number associated with the person, or resource, as an Internet address or URL, messages are sent, or access to information is enabled, by routing the message or request for information to the appropriate location.

### CROSS REFERENCE TO RELATED APPLICATIONS

This application is filed under 35 U.S.C. §111(a), claiming benefit pursuant to 35 U.S.C. §119(e)(1) of the filing date of the Provisional Application No. 60/218,178 filed on Jul. 14, 2000 pursuant to 35 U.S.C. §111(b). The Provisional Application is incorporated herein by reference for all it discloses.

### FIELD OF THE INVENTION

The present invention relates generally to the field of locating web sites and transmitting e-mail messages, and in particular to a method of improving the facility for sending and receiving e-mail messages, locating and accessing web sites and performing time and resource management.

### BACKGROUND OF THE INVENTION

People have rapidly embraced the Internet age of electronic communication. Web site visitation, e-mail, instant messaging, alpha paging, voice mail etc. have all become accepted methods of information and knowledge exchange. A present difficulty with e-mail or instant messaging is the requirement that the sender know in advance the e-mail or instant message address of the recipient to be able to send the message. Such an address commonly consists of a name, or arbitrary identification handle associated with the recipient and a domain name associated with a particular corporate e-mail server with which the recipient has established an e-mail account. The easy to remember e-mail addresses are all long gone, most people today end up with non-intuitive e-mail addresses. People have also become ever more burdened with the need to track all of their own multiple account numbers, Personal Identification Number (PIN), computer logon names and passwords and the telephone numbers of all the parties with whom they regularly communicate. The need to also remember the often abstract e-mail and web site addresses of friends and business associates can add a degree of anxiety to what would otherwise be a convenient method of communication.

The current state-of-the-art in computer-to-computer messaging requires that a user get what is commonly called an “e-mail account” and/or for immediate device-to-device messaging, a symbolic identification number. These e-mail accounts are available from various Internet Service Providers such as AOL and Microsoft's Hotmail and many others. Instant or immediate messaging accounts are available from AOL, Netscape, ICQ and others. These addresses currently have the form: somename@someplace.somewhere i.e., John123@aol.com or mary17@compuserve.com. The user is forced to communicate using a specific named 3^{rd} party corporate empire. The symbolic serial numbers employed for direct device-to-device (a device being a PC, laptop, PDA/PCD, etc.). Internet paging, signaling and real-time text and/or voice/video conversation are typically 6 to 12 character numeric or alphanumeric identifiers with only abstract intuitive meaning to their owners and generally no meaning to others. In addition, the contact initiator must know in advance which proprietary or corporate system the recipient belongs to. There is no intuitive way of knowing how to initiate text or multimedia communication with another party.

One problem with the current messaging approach to date is that you must remember an abstract naming convention which often bears little resemblance to the person whom you are trying to reach. You may know a person named John Doe to whom you need to send a document or short message, but how do you know what his e-mail address would be? What would his Internet paging and real-time conversation addresses be? What device is he currently near? How far is he from me now and what is his ETA? What data conversions are needed to work with the devices that he is using at this instant? You will not know his e-mail address or Internet instant messaging/paging address unless you look it up somehow or call him or her and ask for it which leads to telephone tag and wastes precious time.

The same drawbacks that exist in message addressing also exist when trying to access a specific Internet web site. As mentioned above, web site addresses that are easy to remember are virtually no longer available. Today, many web site names are 20 or more characters long where there is little hope of remembering them all, let alone typing them in correctly.

The state-of-the-art in people, personnel and resource status monitoring, group collaboration and task, project, schedule, time and reminder management and location -tracking requires that people, personnel and resources be registered to a private system that issues each user or resource an abstract symbolic tracking ID.

The problem with the current status monitoring, status updating and collaboration approach to date is that you must remember an abstract naming convention often bearing little resemblance to the person or device that you are trying to monitor. You may know of a person named John Doe who's current location, status, task assignment or meeting ETA you would like to be apprised of, but how do you know where to look for this information? The current information retrieval approach to date is that you must remember an abstract naming convention (such as an e-mail address or non-pneumonic jumble of letters and numbers) which often bears little resemblance to the person, company or device the status of which you are trying to determine. Public Safety Agencies have no citizen status, location history, medical condition and alternative contact numbers with which to work when they receive a 911 call from a cellular telephone, PDA or PCD.

### SUMMARY OF THE INVENTION

In view of the aforementioned problems with the current conventional approach to e-mail transmission, instant message transmission and web site access, the present invention provides significant improvement. This invention allows an Internet user to access a web site directly by using at least one of the telephone numbers associated with the web site as the web site's URI/URL address. This invention also allows an Internet user to transmit an e-mail message or an instant message directly to an intended recipient by using one of the recipients telephone numbers directly as the e-mail address URI. This invention allows all forms of Internet communication to be initiated using the telephone number as the basic URI or URL Internet address. This invention automatically gives every telephone number subscriber worldwide a personal web site Internet URI/URL addressable by telephone number and an Internet e-mail account URI/URL addressable by telephone number.

The invention allows for resource, time, place, task, schedule and group management organized by a URI/IRL handle primarily composed of the telephone number of the party of interest. The status, activity, location, Estimated Time of Arrival (ETA), Estimated Time of Departure (ETD), Estimated Time of Completion (ETC) and other data sets pertaining to people and resources, companies and equipment and/or any special groupings thereof can be instantly determined and intermittently or continuously monitored or updated simply by knowing any of their associated telephone numbers.

With this invention the telephone number is used as the primary URI/URL address and is entered wherever appropriate such as directly into an Internet browser's (whether it be executing on PC, laptop, pager, PDA/PCD, handheld computer etc.) URI/URL address field or e-mail address field for processing.

Status, task list, schedule, location and other information pertaining to a given telephone number subscriber may also be determined or updated using telephony DTMF touch tones, text to voice, voice to text, voice commands or by sending an e-mail, document or other media containing embedded commands directly to the telephone number. Collections of resources (people or things) can be assembled into named relationships by logical groupings (Ex. group project collaboration, appliances in a household).

This invention also allows electronic mail, voice mail and other forms of electronically communicated commands, messages and media to be sent from a wide variety of sources using various forms of the recipient's telephone number or other handle containing or relating to the telephone number as the target URI/URL address for the message.

The invention also allows for one Internet user to be directly hailed or paged for a real-time interactive voice, video, mixed media and/or text conversation or conference by another Internet user using a telephone number as the Internet address.

The invention takes into account the capabilities and limitations (fax/audio/video/text etc.) of the telephone number's handle associated devices performing data conversions or reroutes of data accordingly. The invention makes it easier for a given low intelligence device to automatically contact and command or send messages to another set of devices without need of direct human intervention. Through the invention, a device can quickly command another device or set of devices to perform various actions automatically without need of their owner's involvement. Because telephone numbers are ubiquitous, through this invention they can become a universal means of direct contact and routing among all communication methods and devices with or without human intervention.

This invention also benefits citizens and Public Safety Agencies (PSA) during emergencies. For example, a Public Safety Agency can gain detailed access to a citizen's past and current health, current environment, location, building floorplan layout, emergency contacts etc. just by using the citizen's telephone number as the URI/URL address of their personal web site. The PSA can contact all citizens in a suspected danger zone by sending emergency e-mail by telephone number to all telephone numbers currently indicated to be within the zone of danger.

To be most effective and beneficial for all, this invention needs to be applied intact across the broadest range of networked platforms under the authority of a single guiding entity.

### BRIEF DESCRIPTION OF THE DRAWINGS

The object and features of the present invention will become more readily apparent from the following detailed description of the preferred embodiments taken in conjunction with the accompanying drawings in which:

Table 1 is a table of the symbolically acceptable formats for URI/URL telephone number entry along with the symbolic definitions of the telephone number formats. These formats are exemplary only. These formats cover example forms of telephone numbers both national and international, present formats and future anticipated formats. The omission of a particular format example does not indicate its lack viability or lack of inclusion in this invention.

Table 2 is a table of subscriber defined command verbs, objects, locations etc. along with their associated two digit numeric definition (useful for touch tone DTMF applications) and one or more interchangeable shorthand abbreviations. The omission of a particular verb, object or location etc. example does not indicate its lack of viability or lack of inclusion in this invention, particularly as this is a table left to the subscriber's own imagination and needs

Table 3 is a set of examples of subscriber defined group relationships in accordance with the present invention.

FIGS. 1-10 represent computer application software screen copies and show a few representative examples of the telephone number web URI/URL address invention at work in one or two example Internet browsing applications Microsoft Internet Explorer and Netscape Navigator. Some examples are only shown for Internet Explorer or for Netscape Navigator, however all the examples would still apply to either of these browsers and to all other web browsers and web accessing applications operating on any Internet connected device.

FIGS. 1 through 10 show example screen prints of Microsoft Internet Explorer® and Netscape Navigator® browser screens employing the telephone number URL retrieval addressing invention in some of its various forms as derived from the prototype addresses listed in Table 1. The examples (FIG. 1 through FIG. 10) do not show every instance of a Table 1 prototype in use. However, each example prototype shown in Table 1 would work interchangeably with the examples shown in FIGS. 1 through 10. The returned sample “Harmony Garden Interiors” web page (also reachable as www.harmony-gardens.com) is the web site currently associated with telephone number 301.261.8680 and is just one simple example of a possible web page that might be returned for a given telephone number. These examples would also apply to all other Internet browser programs or applets.

FIGS. 11-20 represent computer application software screen copies and show a few representative examples of the telephone number e-mail URI/URL address invention at work in one or two example Internet messaging applications Microsoft Outlook Express and Netscape Communicator. Some examples are only shown for Outlook Express or Netscape Communicator, however the example would still apply to all other browsers and e-mail applications and instant messaging applications operating on any Internet connected device.

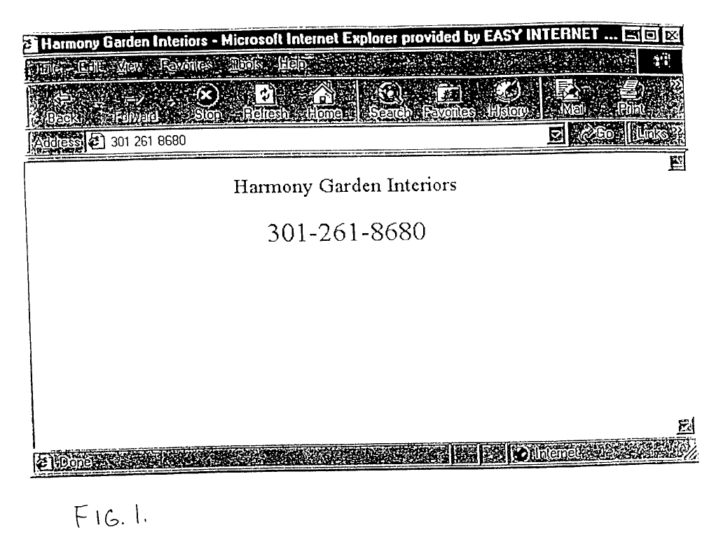

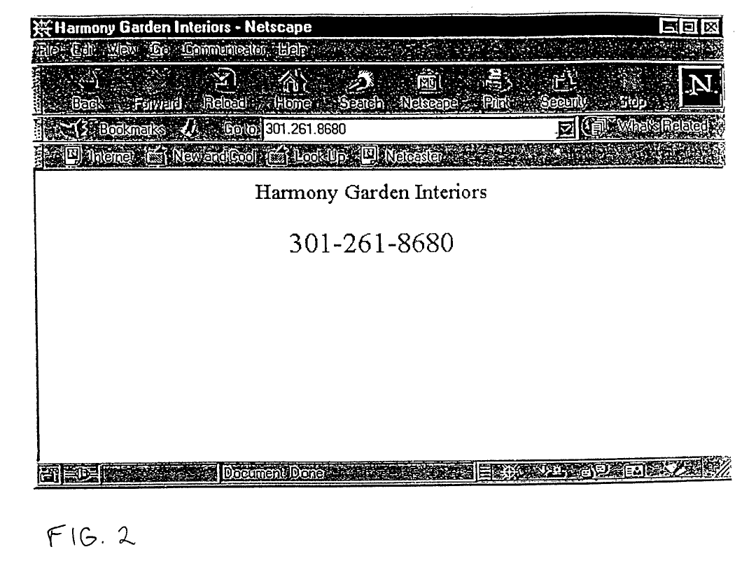

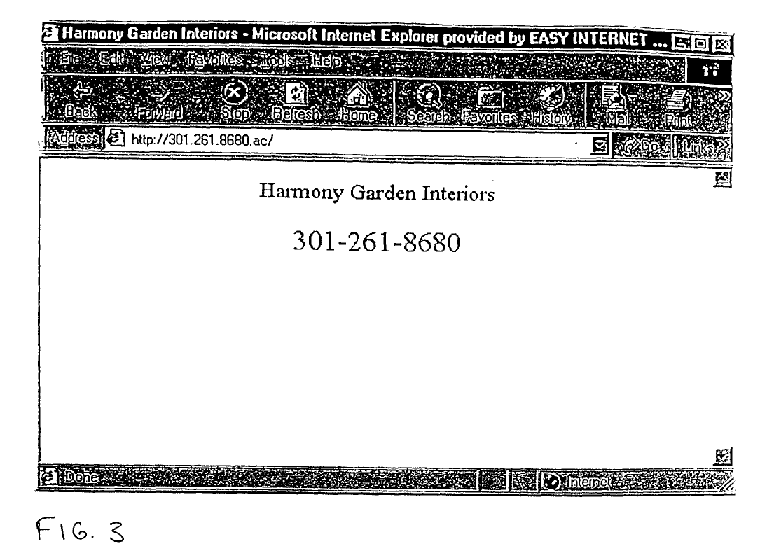

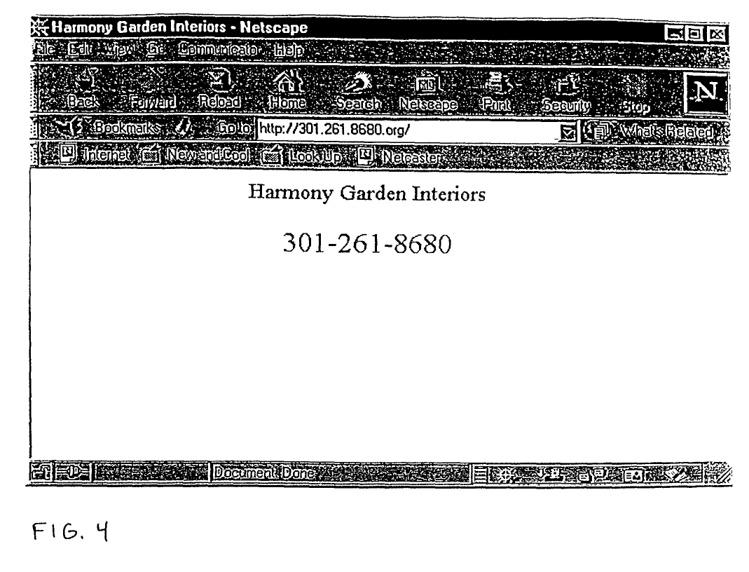

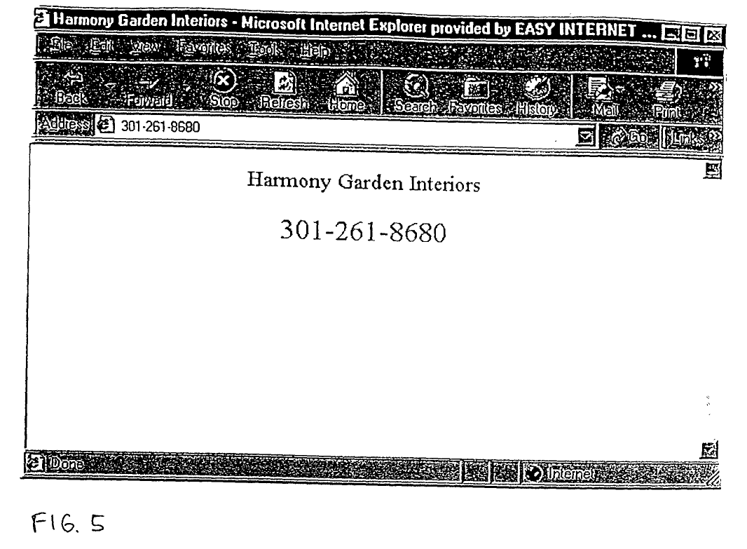

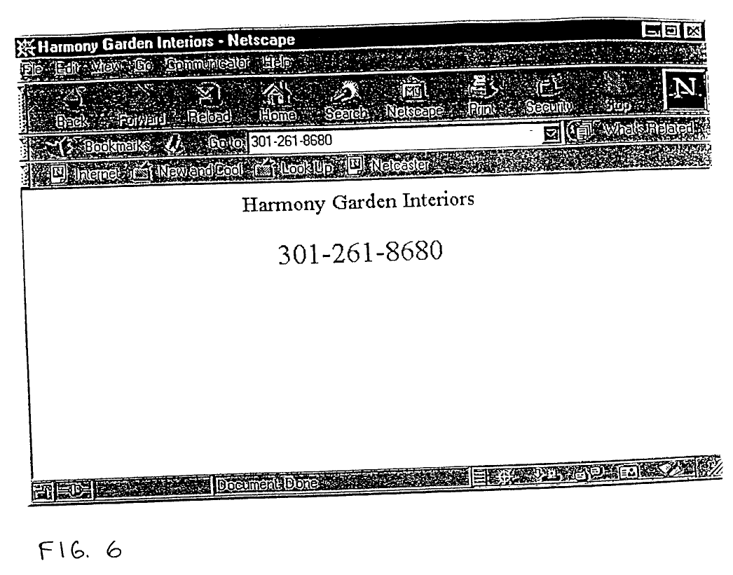

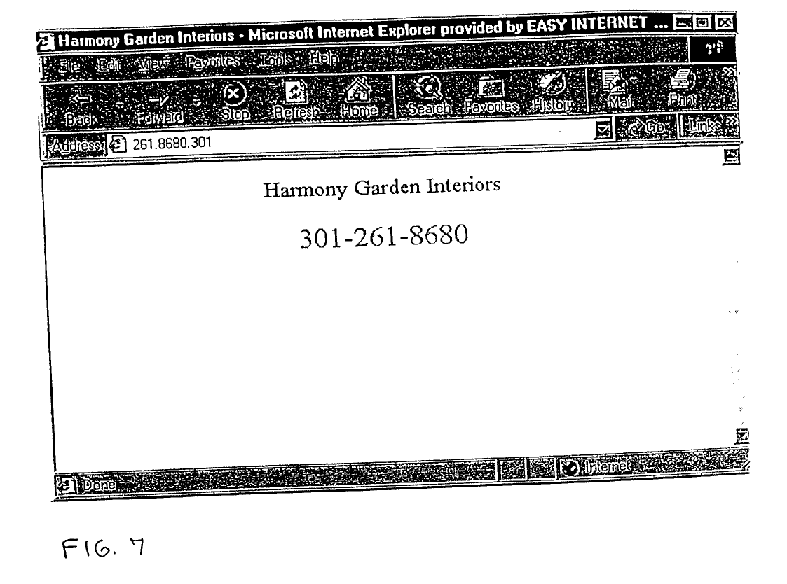

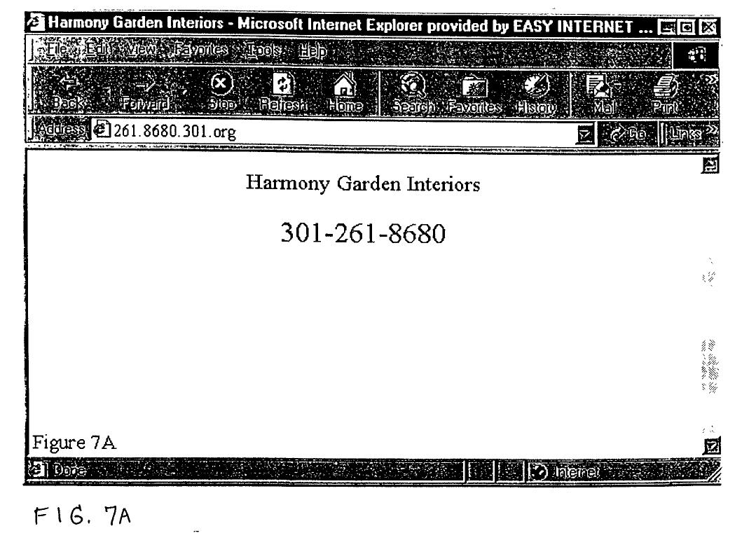

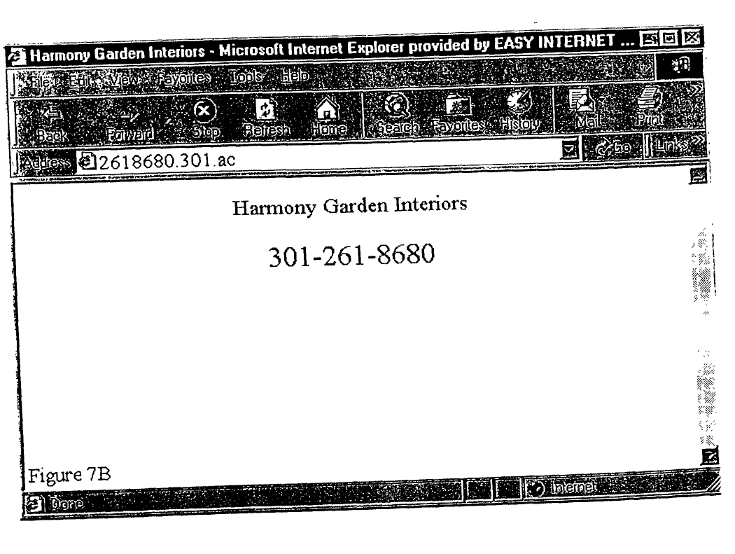

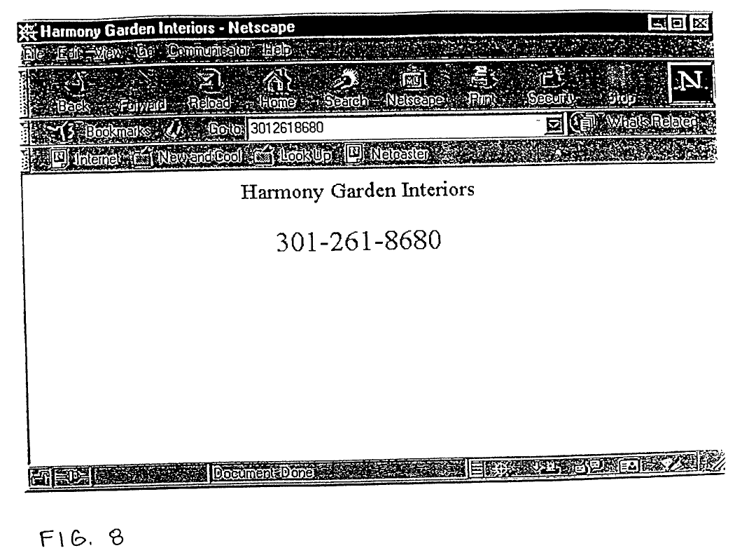

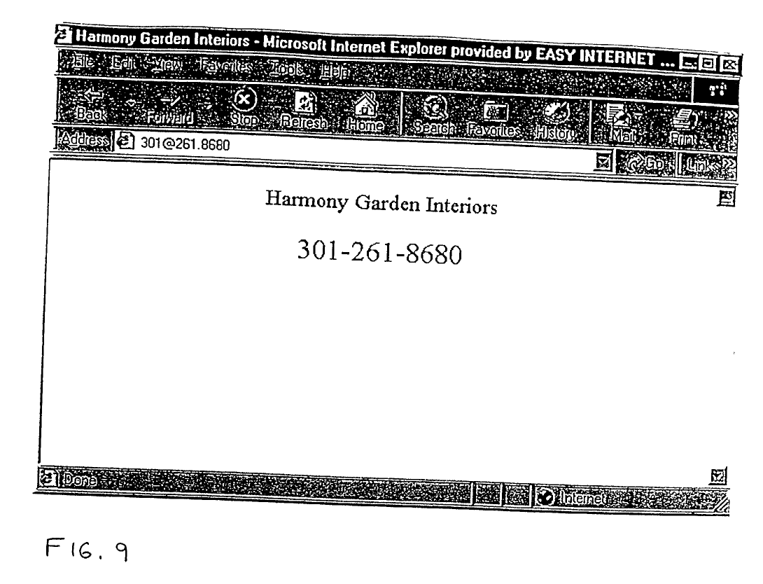

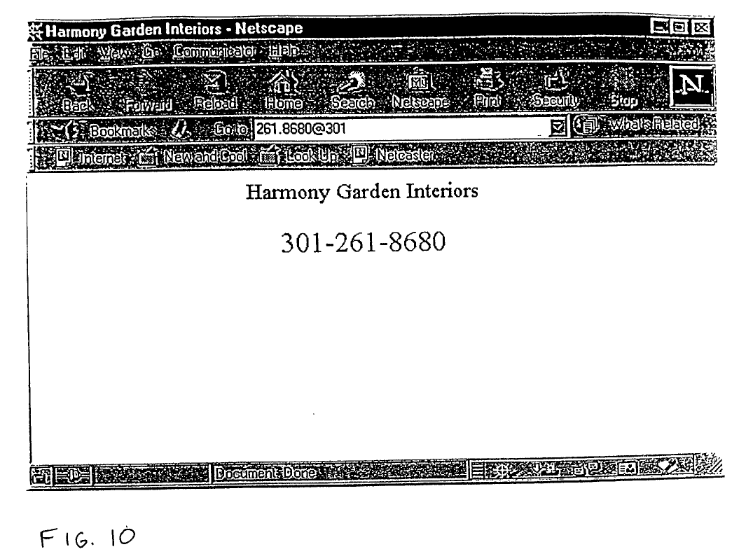

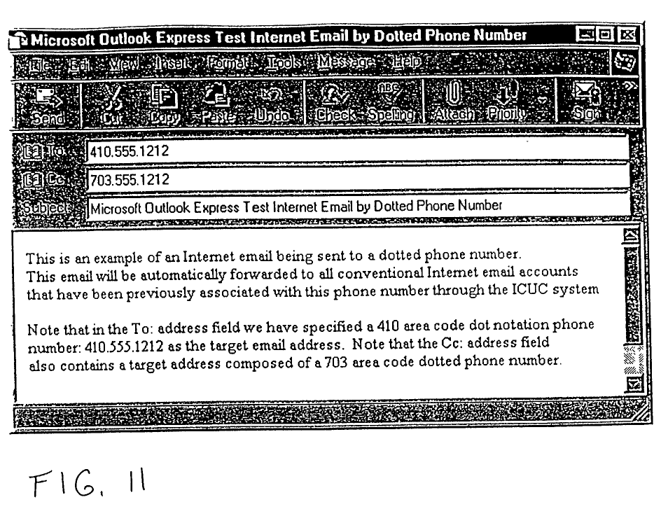

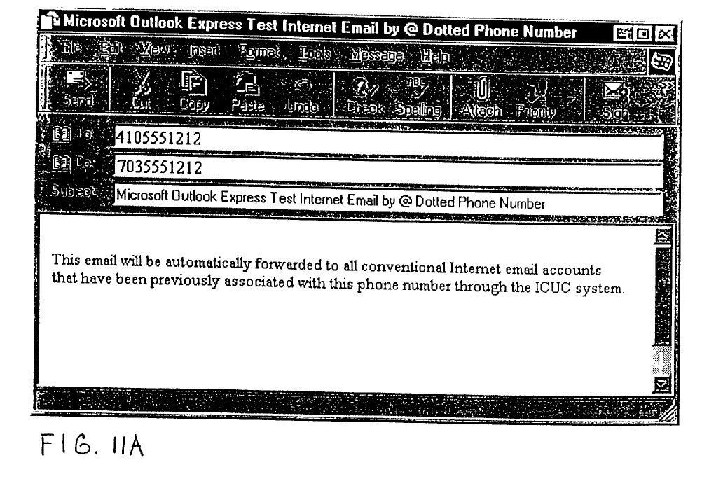

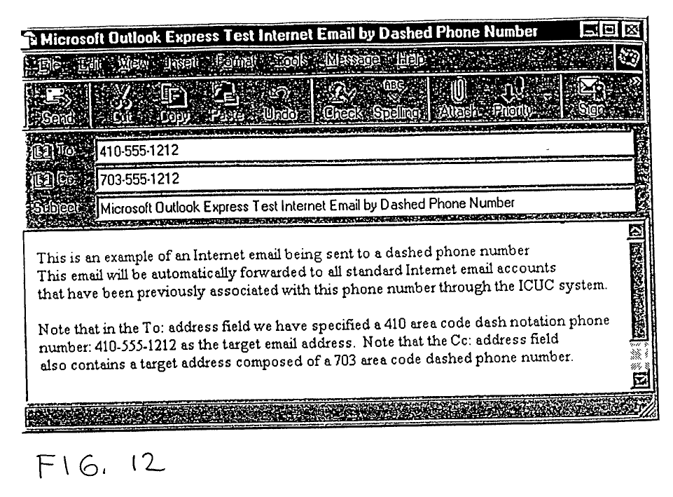

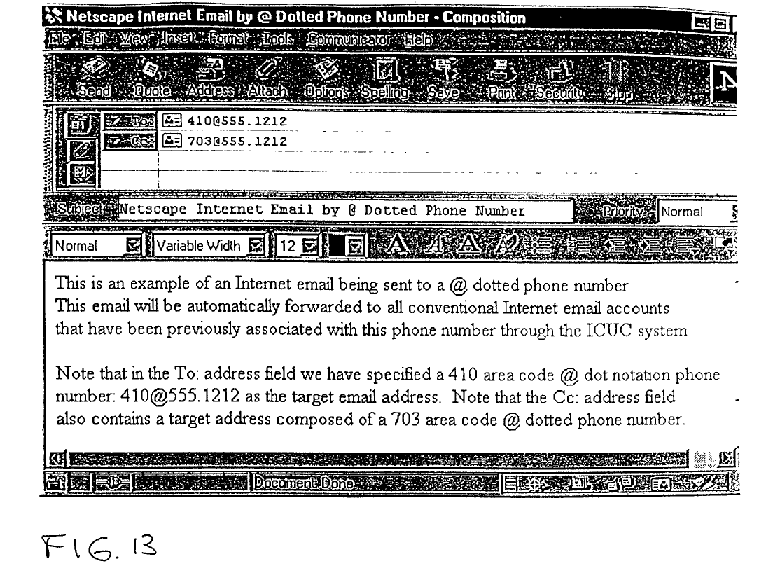

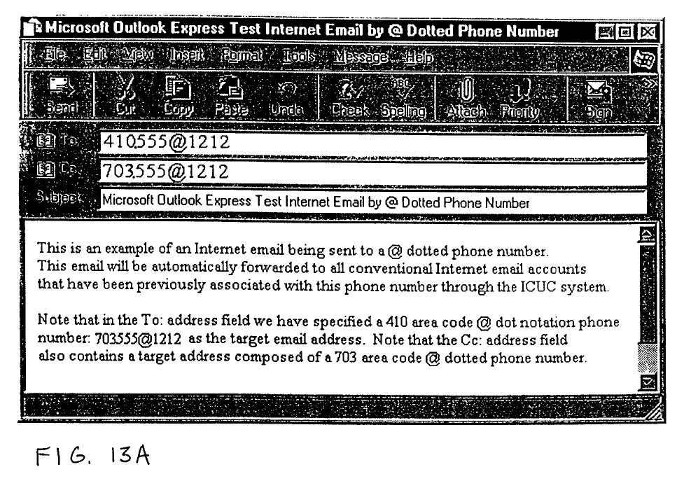

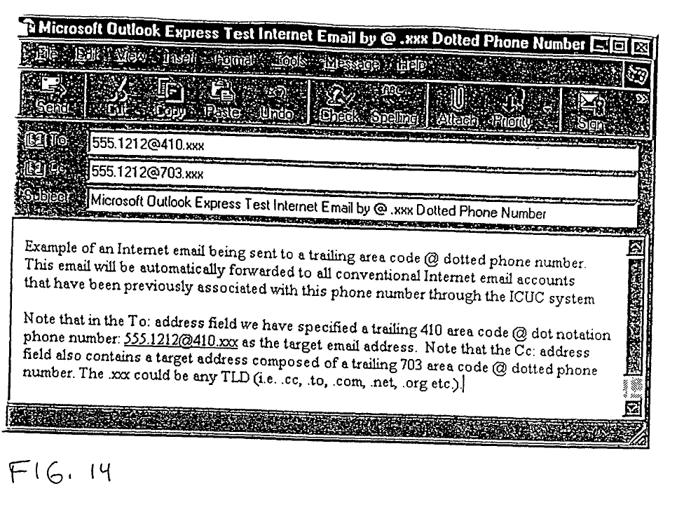

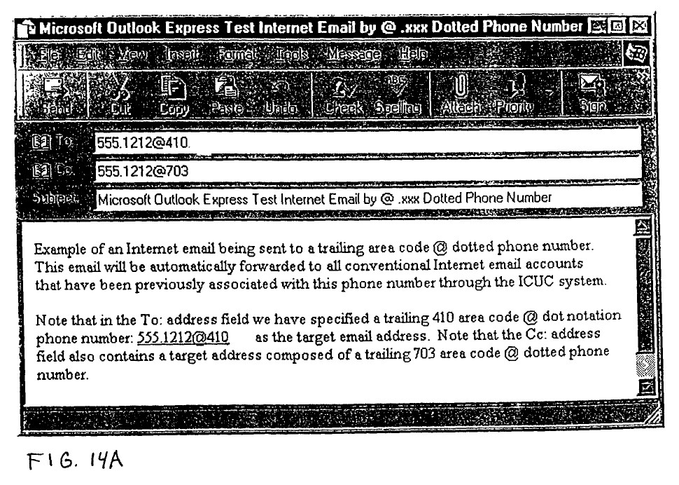

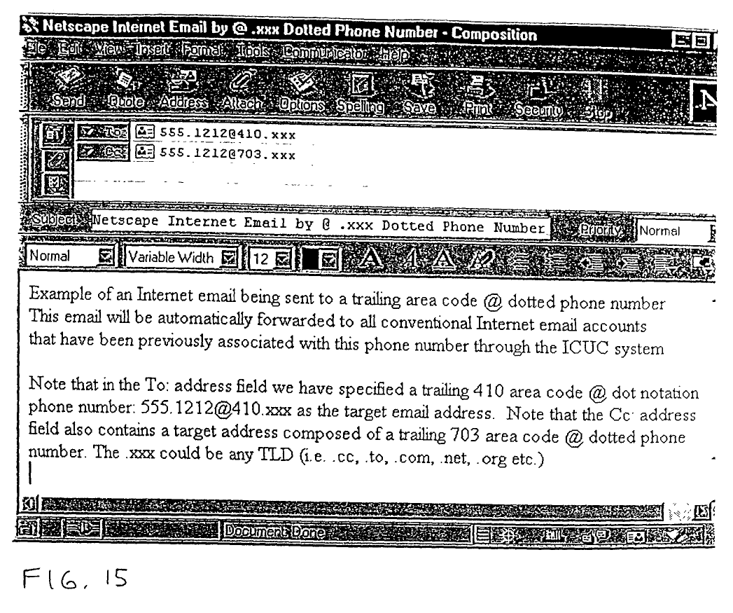

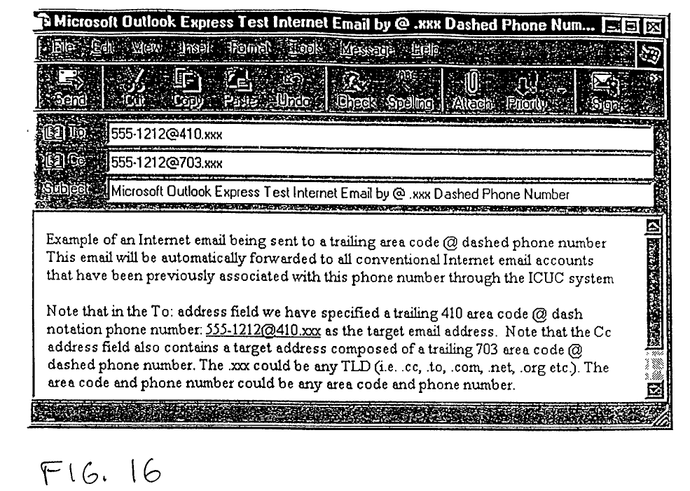

The same addressing scheme would apply to all other brands and types of Internet web browsing software as well. The examples would also apply to PDA's and PCD's regardless of the physical data entry characteristics of the URL address field. Note that in most examples the area codes shown are 410, 703 or toll free 800 with a telephone number of 555-1212 however the invention covers all combinations of area codes joined with all combinations of telephone numbers. The invention covers all international telephone number formats, custom handle and IP number formats as well.

The same addressing scheme would apply to all other brands and types of Internet e-mail and instant/immediate messaging software as well. The examples would also apply to PDA's and PCD's regardless of the physical data entry characteristics of the To: and Cc: address fields. Note that in most examples the area codes shown are 410, 703 or toll free 800 with a telephone number of 555-1212 however the invention covers all combinations of area codes joined with all combinations of telephone numbers. The invention covers all international telephone number formats, custom handle and IP number formats as well.

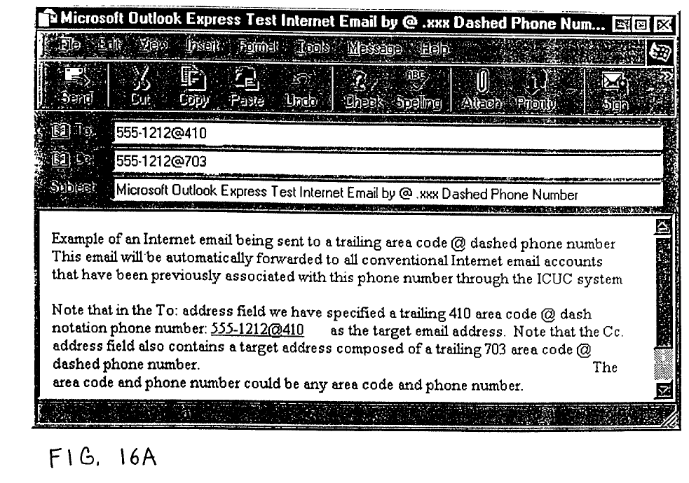

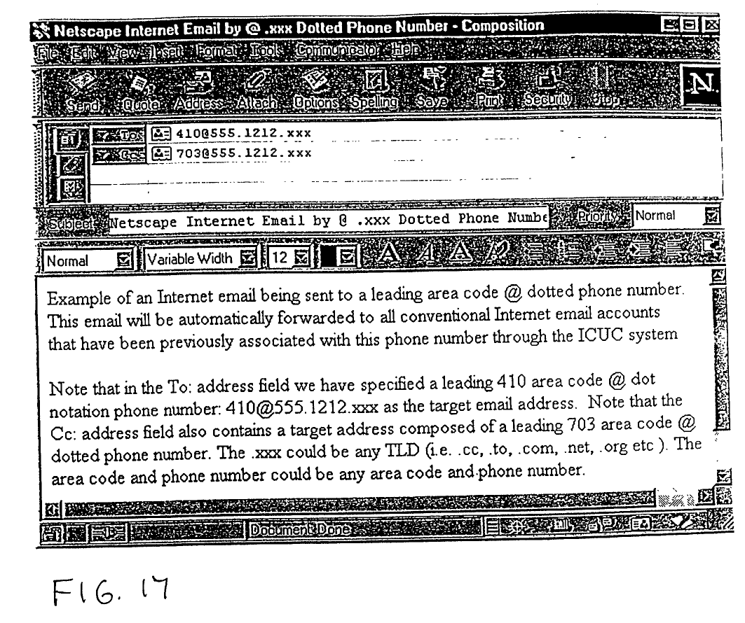

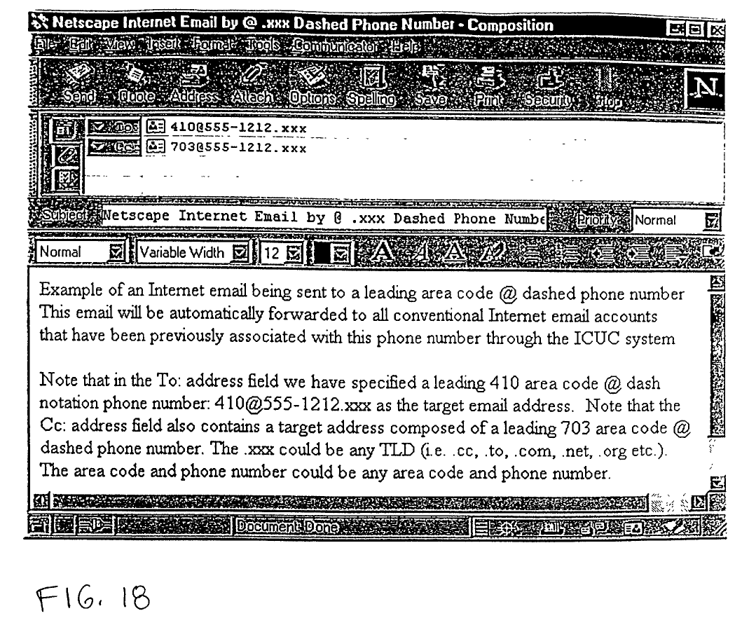

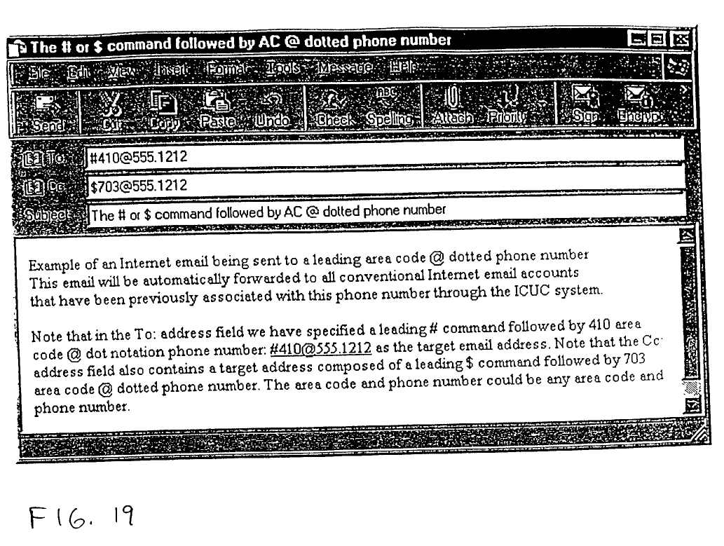

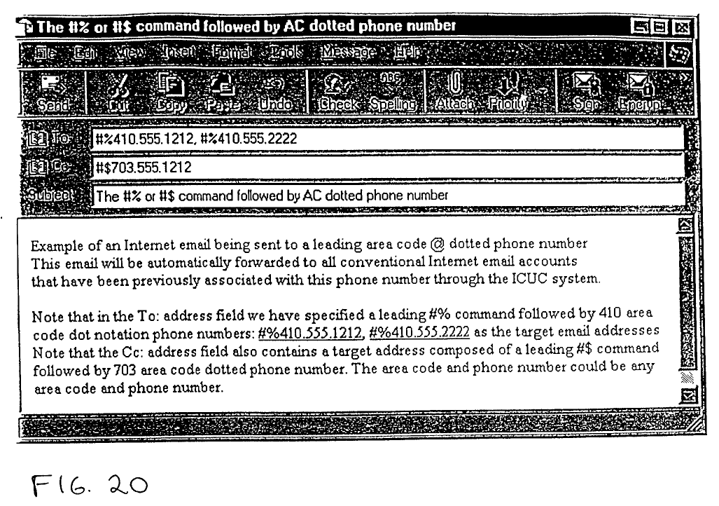

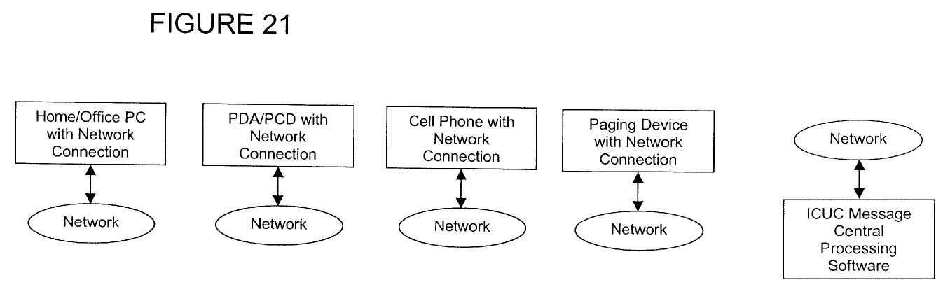

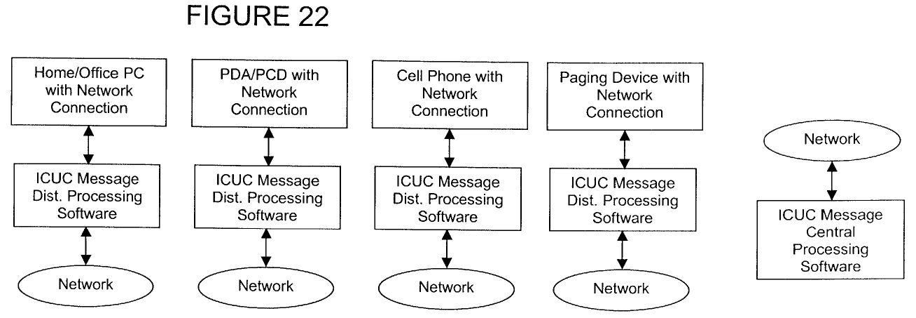

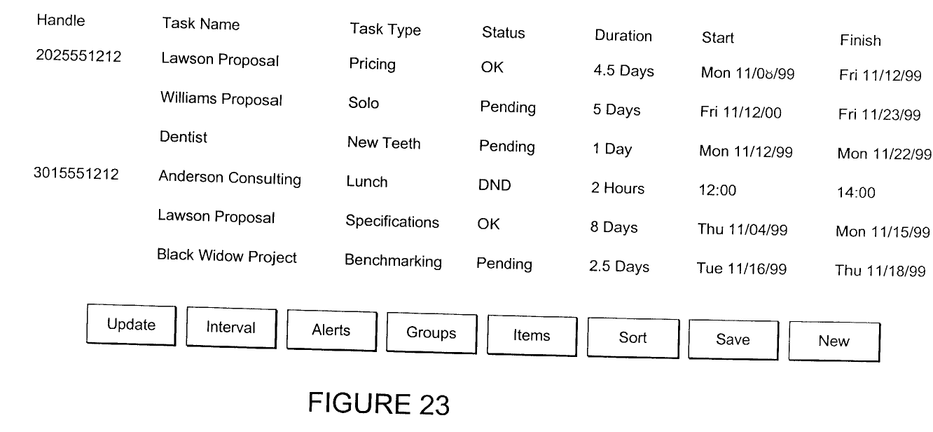

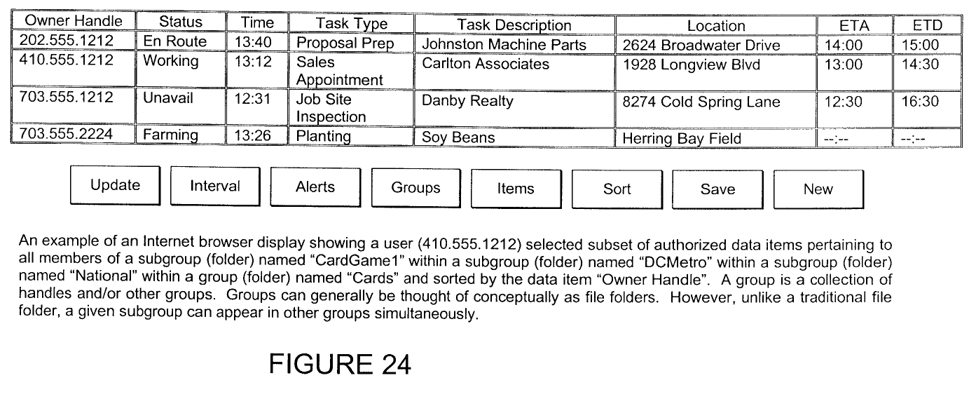

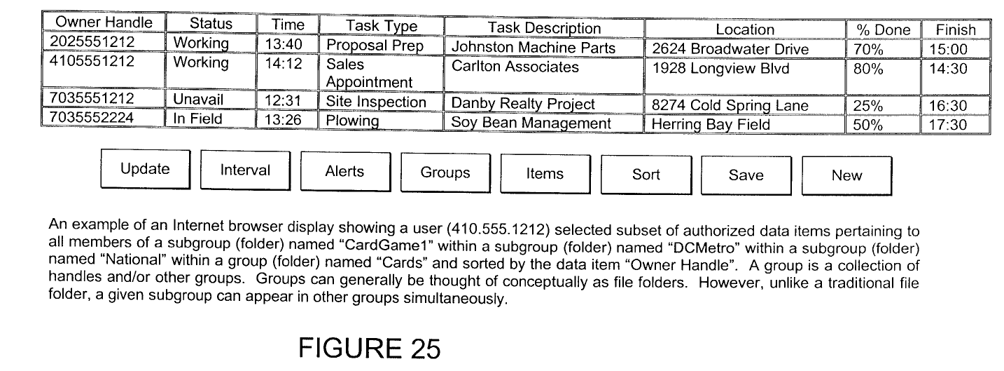

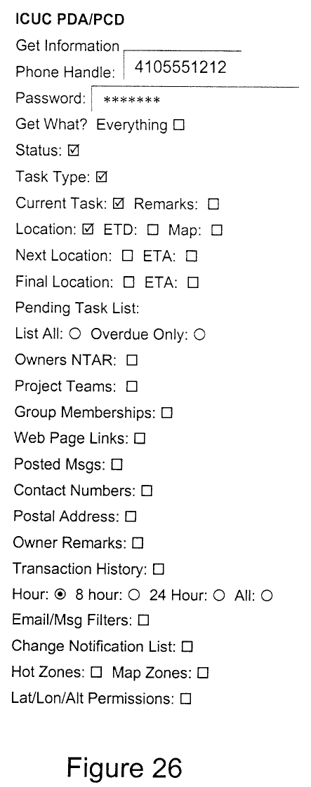

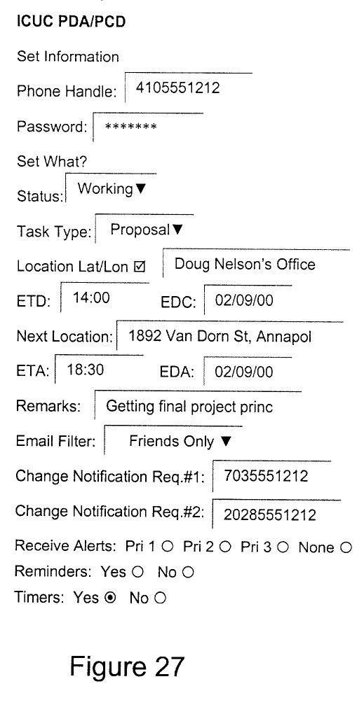

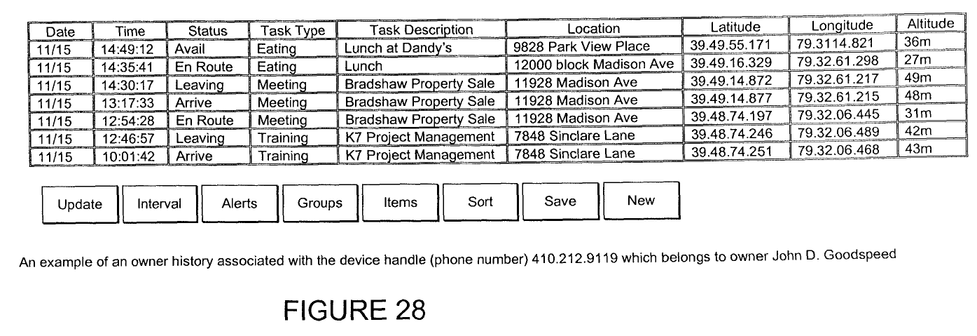

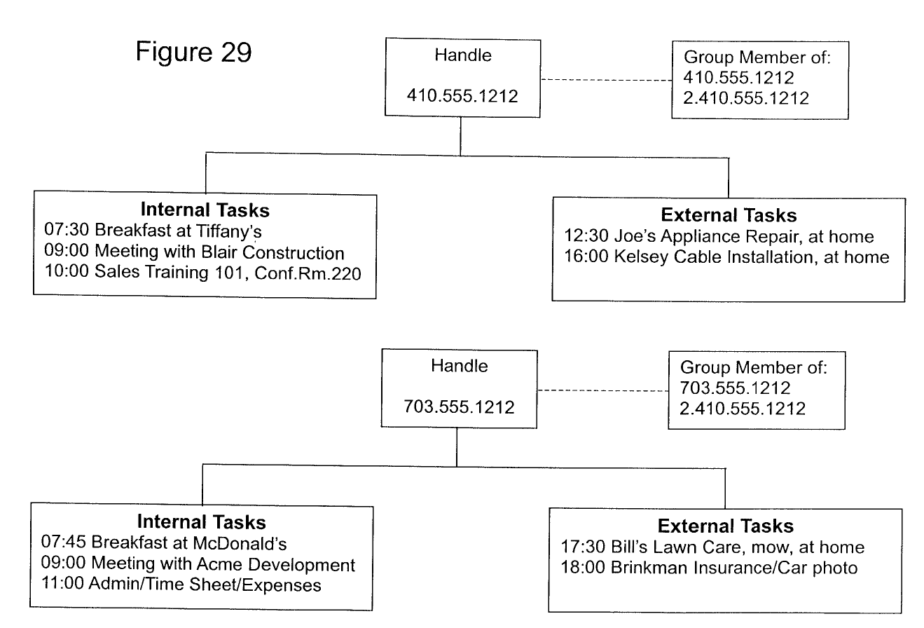

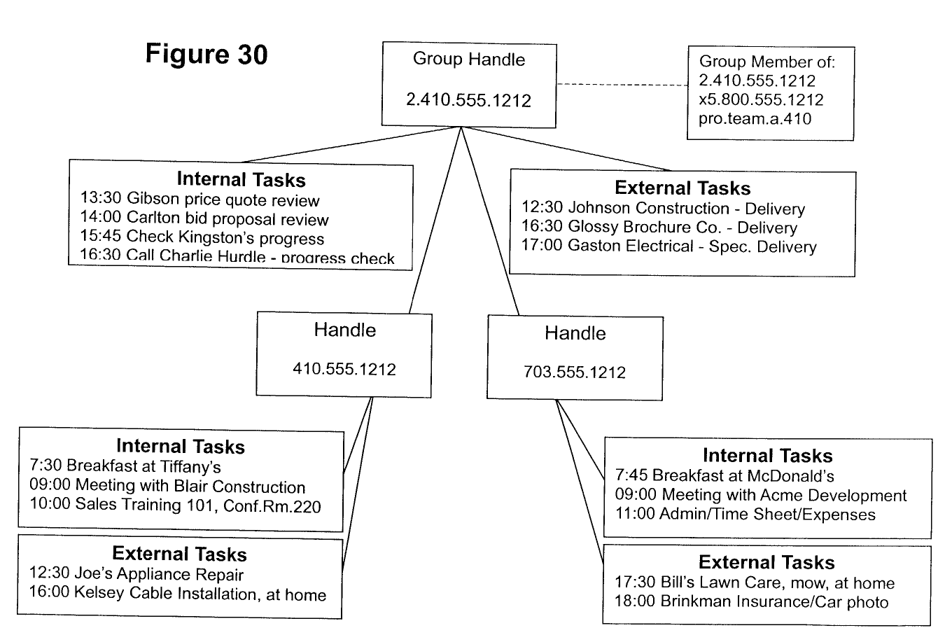

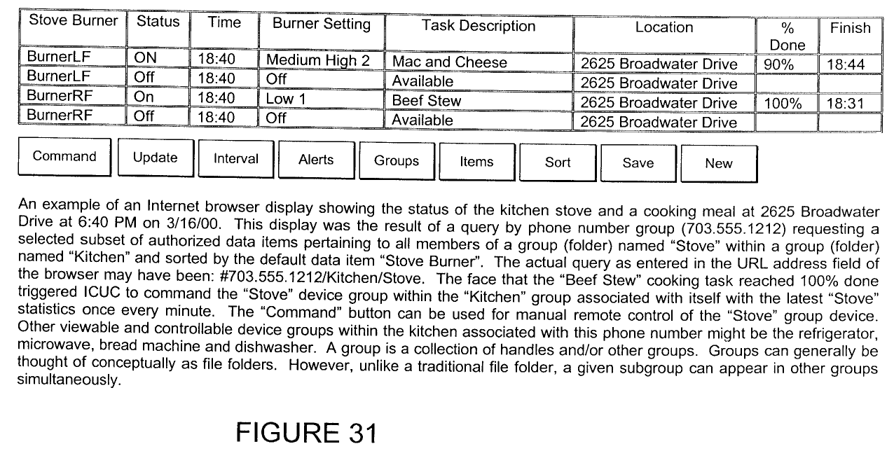

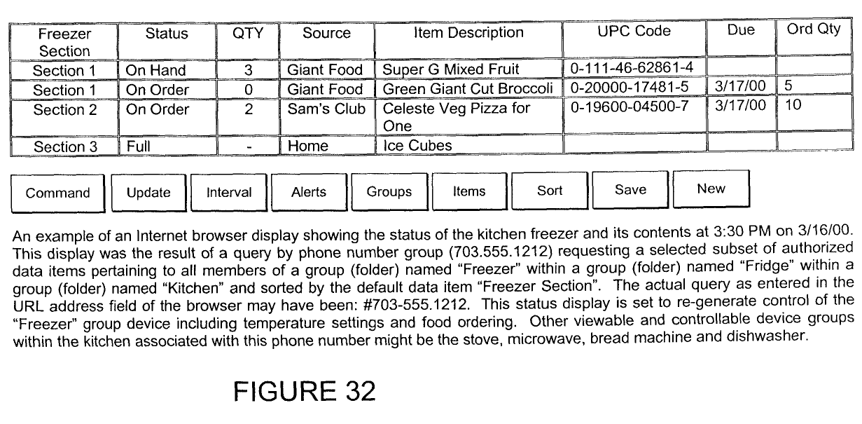

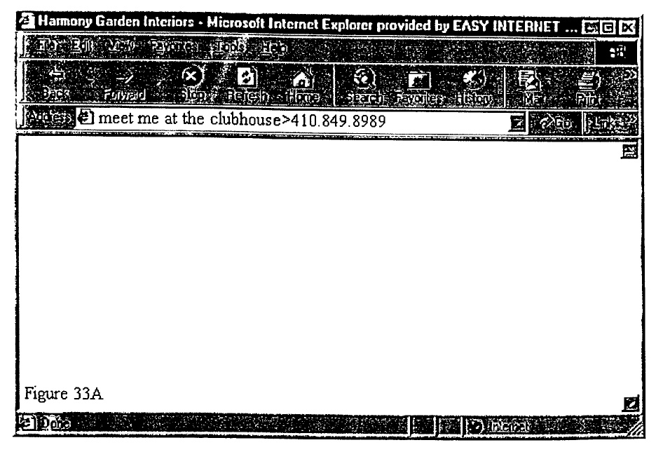

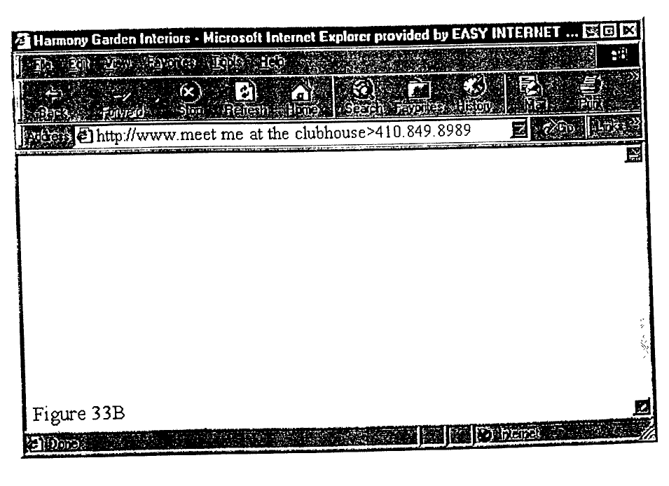

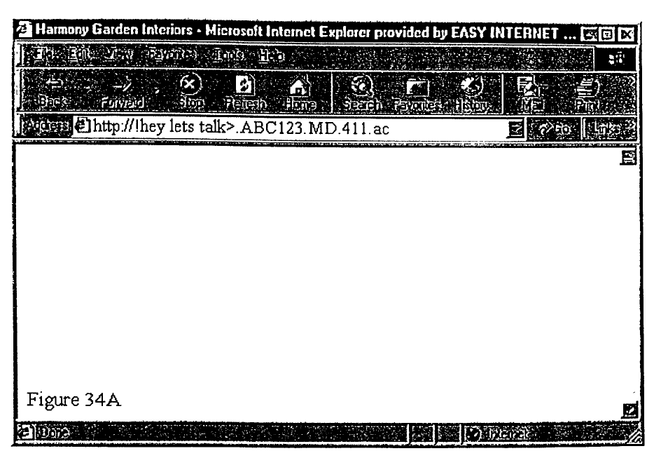

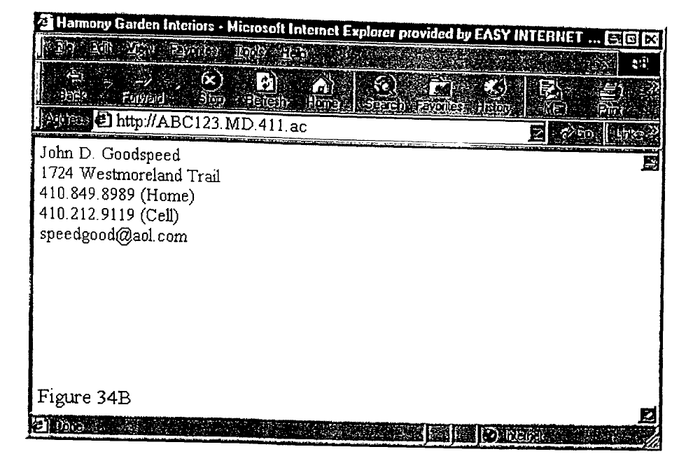

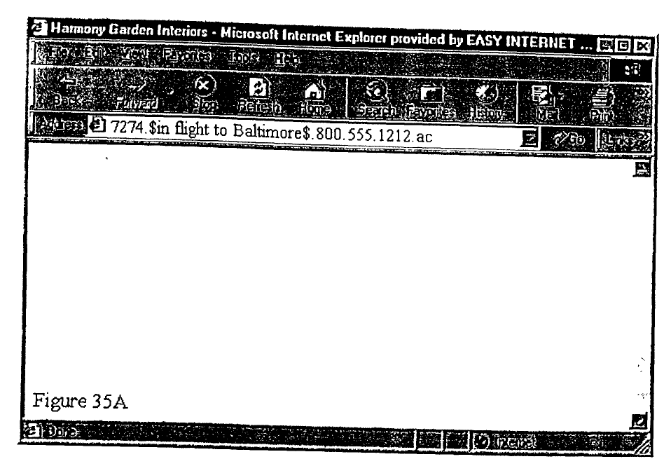

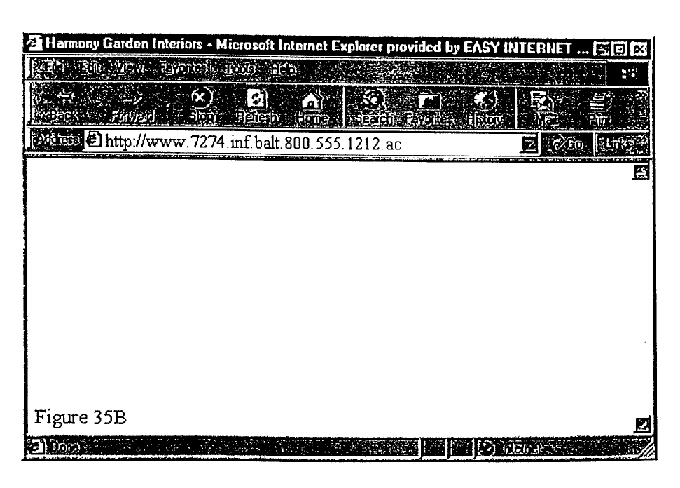

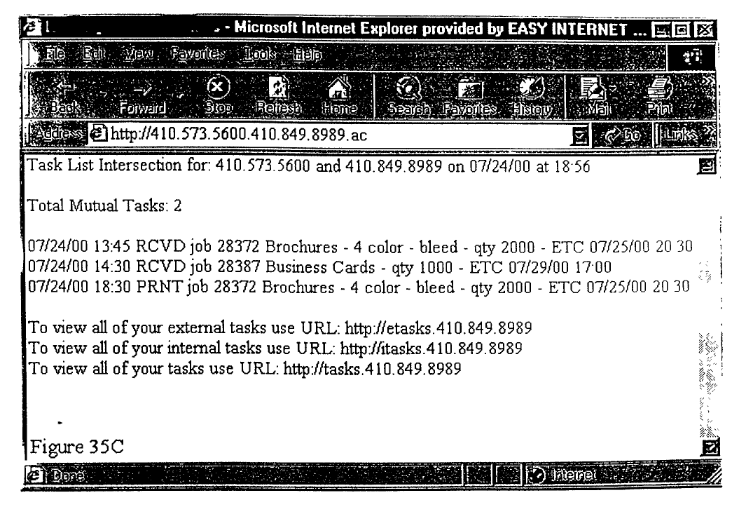

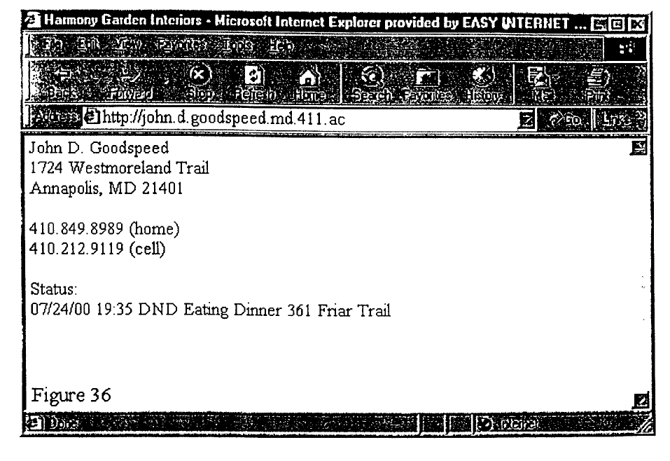

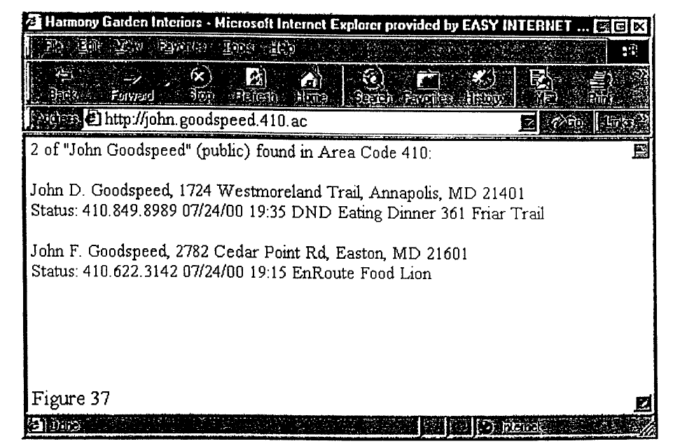

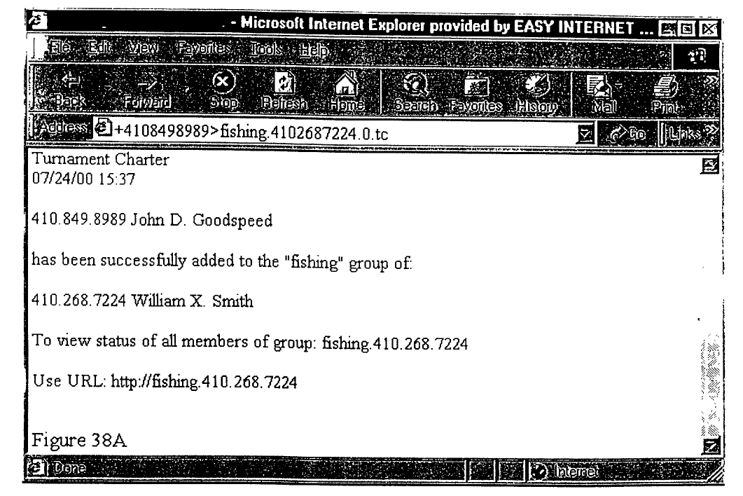

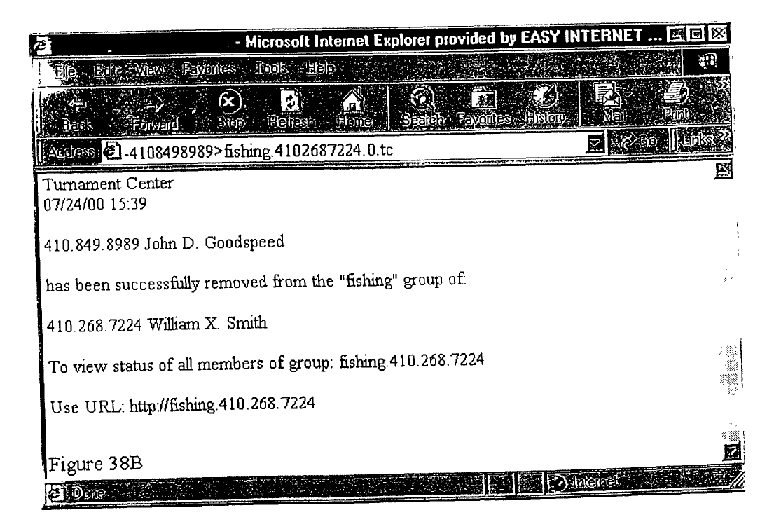

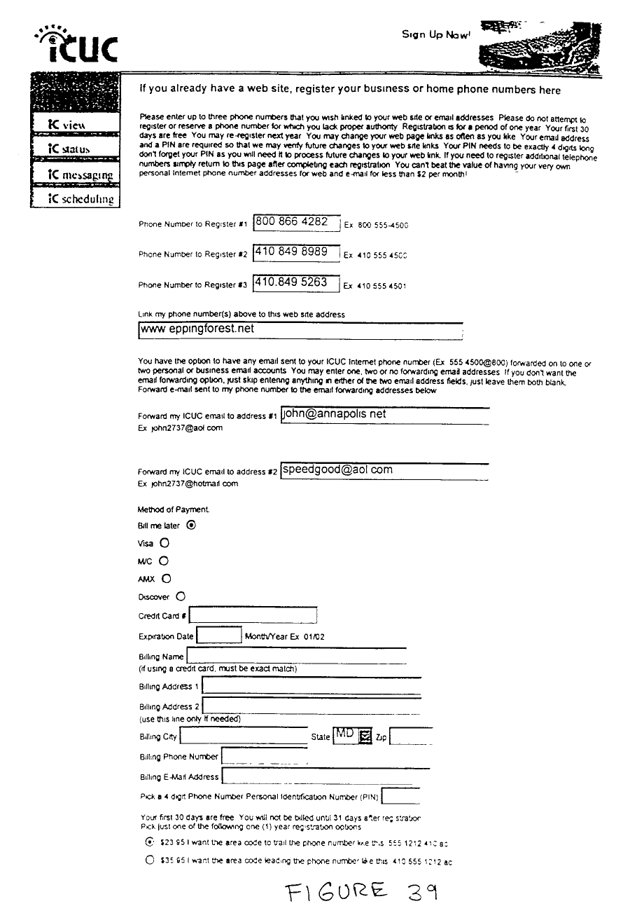

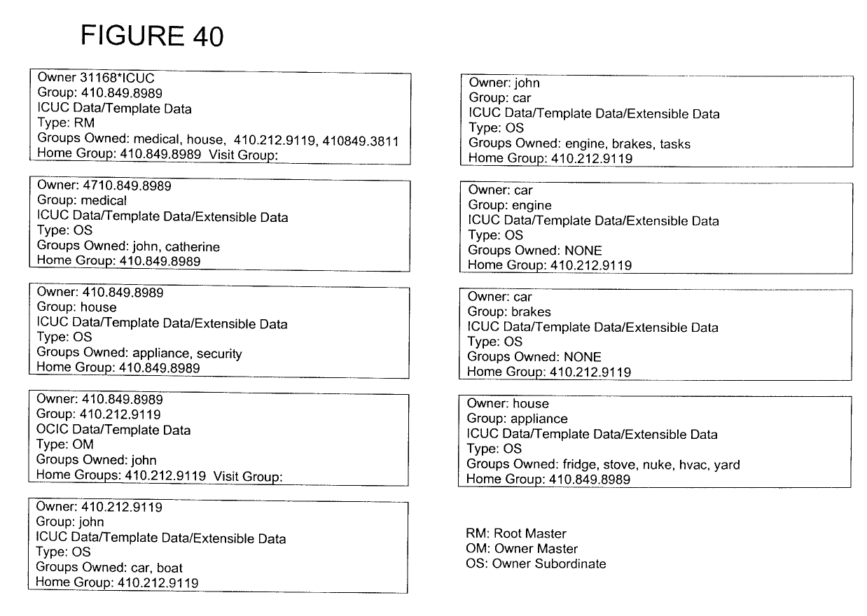

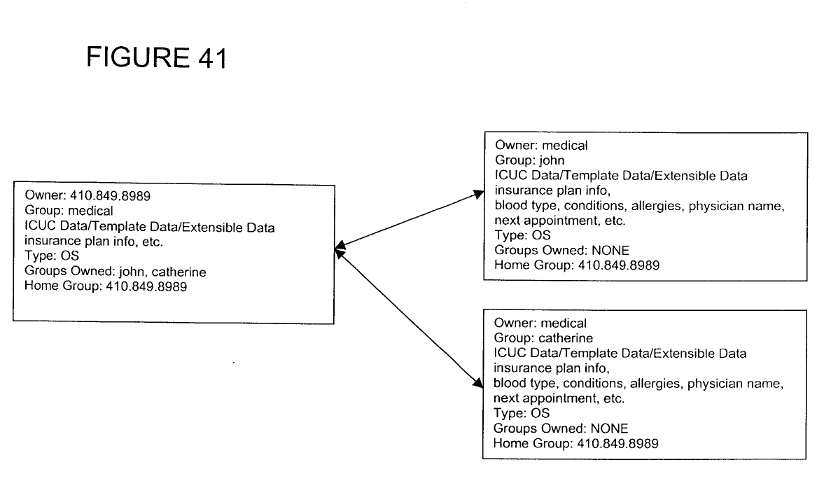

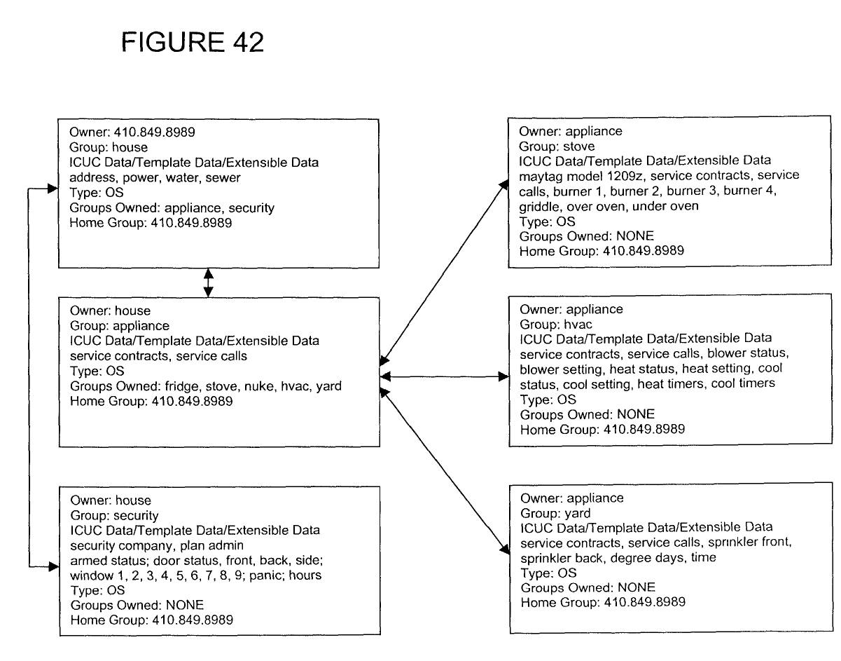

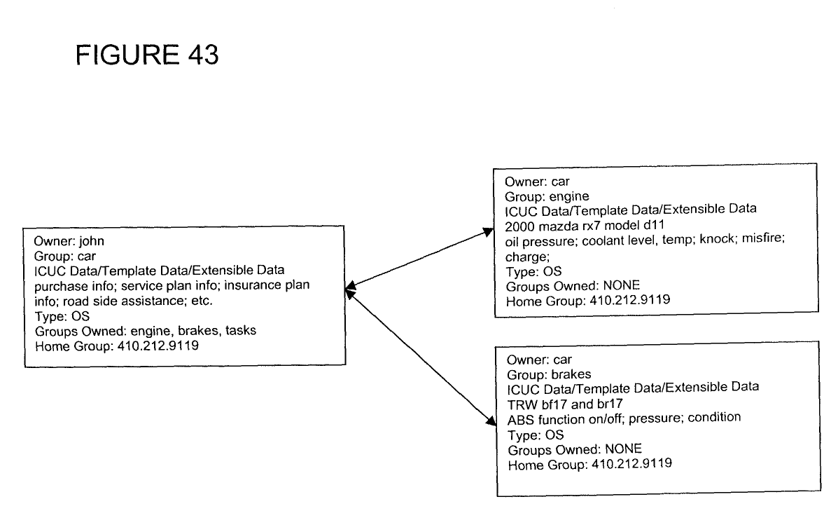

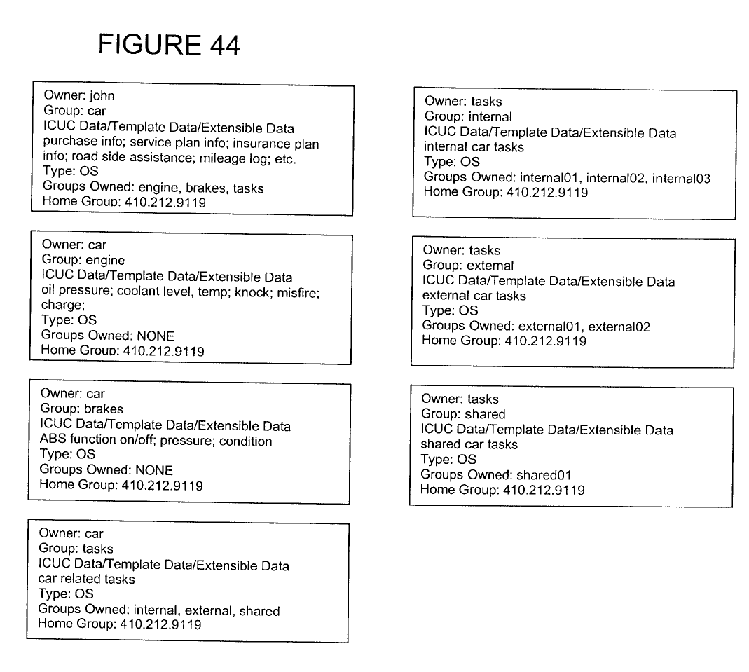

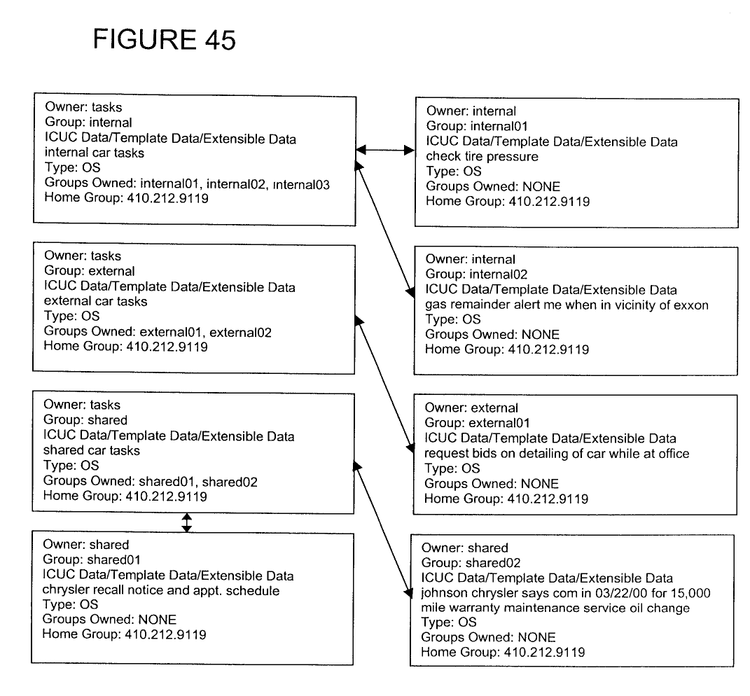

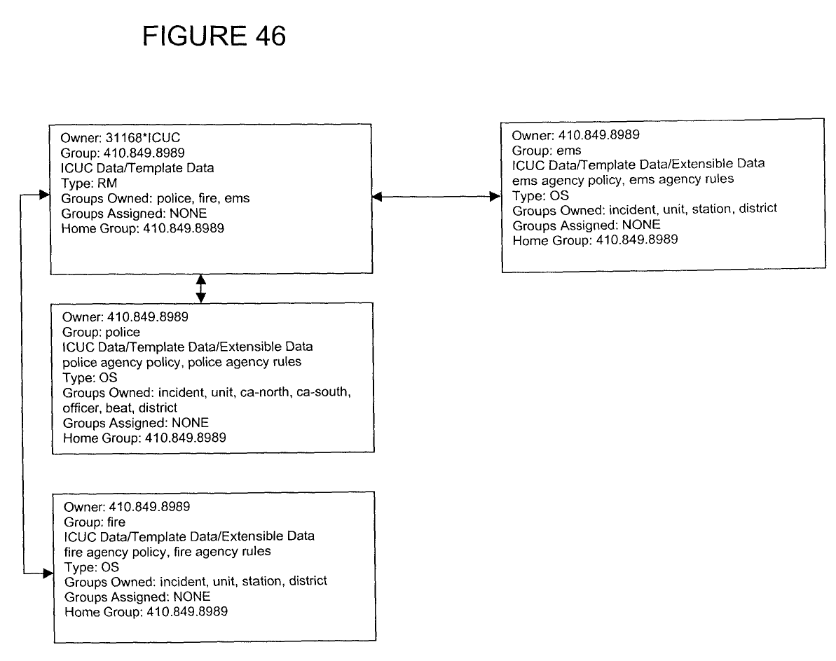

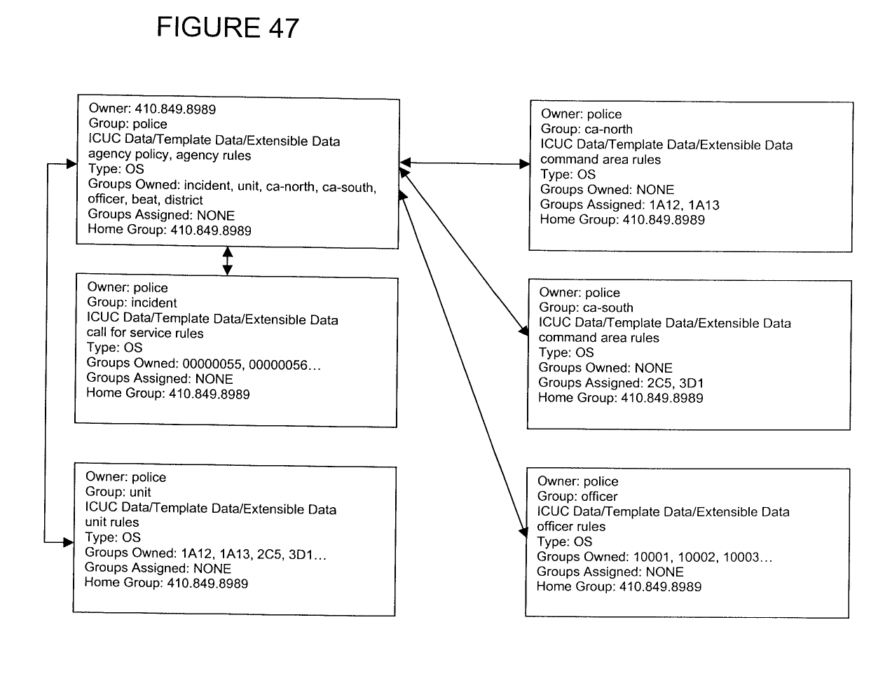

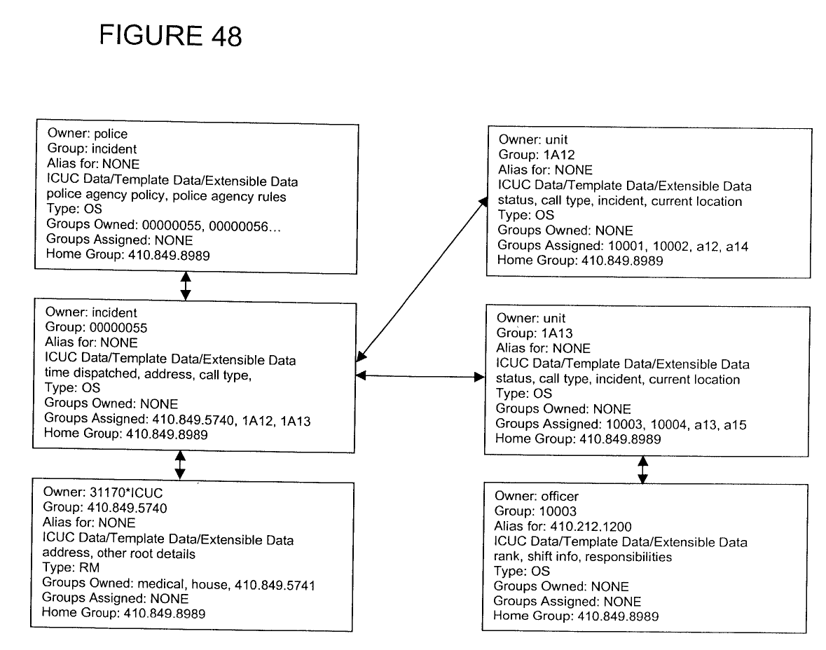

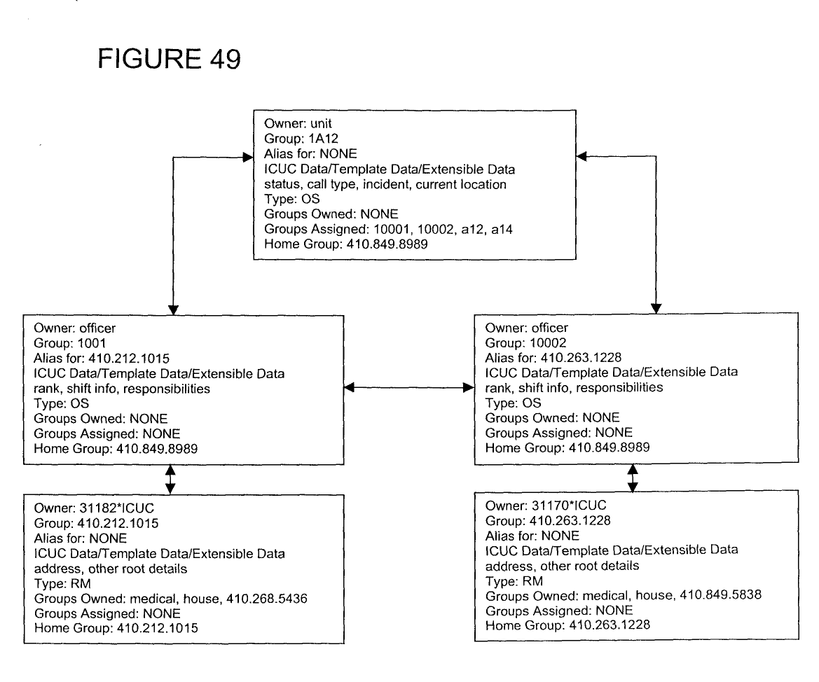

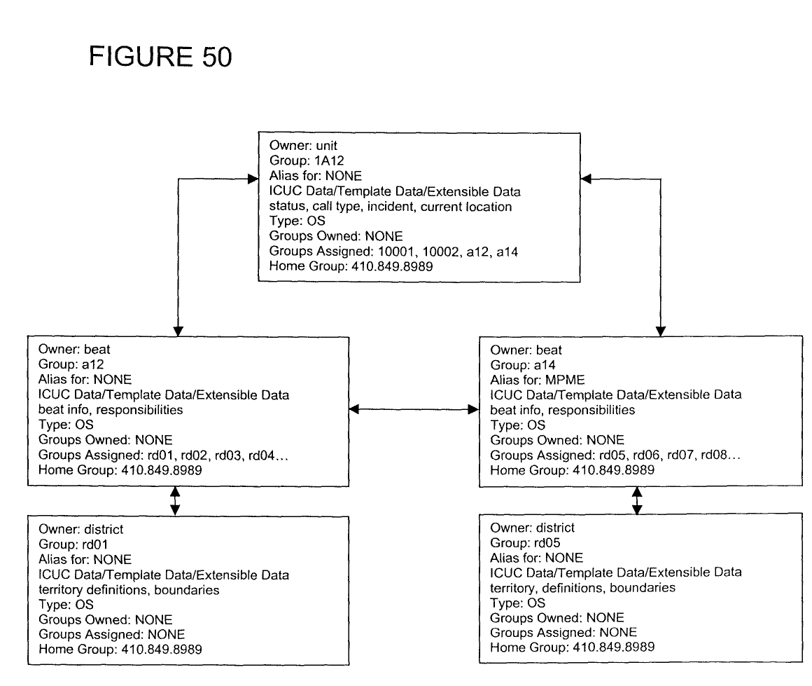

FIGS. 11 through 20 show example e-mail screen prints of Microsoft Outlook Express® and Netscape Communicator® browser e-mail screens employing the telephone number URI message addressing invention in some of its various forms as derived from the prototype example addresses listed in Table 1. These FIGS. (11 through 20) do not show every instance of a Table 1 prototype in use. However, each example prototype shown in Table 1 would work interchangeably with the examples shown in FIGS. 11 through 20. The examples would also apply to all other Internet e-mail programs or applets.

FIG. 21 is a diagram of the communications network behind the web site access, status and location tracking and setting invention when the URL address is of the form 555.1212.800.zzz or 800.555.1212.zzz where zzz is any Internet Top Level Domain (TLD). The “Network” component of this diagram may be either the public Internet or a private Intranet. This method of messaging requires no custom invention software specification or implementation on the remote devices. This method does require invention protection for the method of using a numeric telephone number as a URL address.

FIG. 21 is also a diagram of the communications network behind the messaging invention when the message To: or Cc: address is of the form 555.1212@800.zzz or 800@555.1212.zzz (Table 1) where an @ is used and zzz is any Internet Top Level Domain (TLD). The “Network” component of this diagram may be either the public Internet or a private Intranet. This method of messaging requires no custom software specification or implementation on the remote devices. The Network component of FIG. 21 relies upon already existing Internet routing, DNS and e-mail processing software. The invention is the use of a pure numeric telephone number as an e-mail message or instant message address without need of having to remember a corporate identifier domain. The invention provides for the worldwide management of the purely numeric telephone number domains on its own Internet servers.

FIG. 22 is a diagram of the communications network behind the web site access, status and location tracking and setting invention when the URI/URL address is one of the forms listed in Table 1 not directly compatible with currently deployed Internet software. The invention Message Dist. Processing Software specification and implementation procedure executing upon the distributed network nodes (PC, laptop, PDA/PCD etc.) adjusts for the appropriate Internet Top Level Domain (TLD) and adjusts for a syntactically correct DNS resolvable URL address automatically. The “Network” component of this diagram may be either the public Internet or a private Intranet.

FIG. 22 is also a diagram of the communications network behind the messaging invention when the message To: or Cc: URI/URL address is one of the forms listed in Table 1 not directly compatible with currently deployed Internet software. The invention Message Distributed Processing Software specification and implementation procedure executing upon the distributed network nodes (PC, laptop, PDA/PCD etc.) adjusts for the appropriate Internet Top Level Domain (TLD) and adjusts for a syntactically correct DNS resolvable To: or Cc: URI address automatically. The “Network” component of this diagram may be either the public Internet or a private Intranet.

FIG. 23 shows a sample screen print of a custom invention display applet (Java/Jscript/JavaScript/VB/Perl etc.) that has been user customized to show only members belonging to the group known as the “ProposalTeam”. The “ProposalTeam” group is a member of the “DC” group that in turn is a member of the “Eastern” group. The applet is set to automatically display the latest status information every 10 minutes. The display was 7 minutes old. The user has instructed the applet to organize the display by telephone number handle. The user has instructed the applet to display a subset of available data composed of and in order of: Task Name, Task Type, Status, Duration, Start time and Finish time. This is but one of the many display formats that the user might create.

FIG. 24 shows a sample screen print of an Internet browser based invention display that has been user customized to show only members belonging to the subgroup named “CardGame1” (itself a member group of “DCMetro” itself a member group of “National” itself a member group of “Cards”). The display has been user customized to show only the current status activity sorted by handle. Also included are the user/invention Estimated Time of Arrival and the user/invention Estimated Time of Departure. This is but one of the many display formats that the user might have created.

FIG. 25 shows a sample screen print of an Internet browser based invention display that has been user customized to show only members belonging to the group named “CardGame1” (itself a member of group “DCMetro” itself a member of group “National” itself a member of group “Cards”). The display has been user customized to show only the current status activity sorted by handle. Also included are the user/invention Estimated % complete and the user/invention Estimated Time of Completion. This is but one of many display formats that the user might have created.

FIG. 26 shows a sample of a PDA/PCD information query applet. The query is initiated by a telephone number entry directly into the applet's telephone number handle field along with an authorizing password.

FIG. 27 shows a sample of a PDA/PCD information update applet. The update is initiated by a telephone number entry directly into the applet's telephone number/handle address field. A password for authenticating the status update is also provided.

FIG. 28 shows a sample screen print of an Internet browser based invention display that has been user customized to show only history for the member owner belonging to the device telephone number handle 4102129119 from 10:00 AM to 3:00 PM. This display could have been initiated by the entry of 410.212.9119/1000-1500 in the browser address entry field.

FIG. 29 shows an example of handles and how they each have associated internal and external task lists. The handle's group memberships are also shown. Every handle is a group. Every group may be a member of one or more groups.

FIG. 30 shows the possible arbitrary nested nature of group memberships as well as the possible independent internal and external task lists associated with each group. Every handle is a group. Every group may be a member of one or more groups.

FIG. 31 shows a sample screen print of an Internet browser based invention display that shows the handle “Stove” which belongs to handle “Kitchen” which belongs to the North American telephone number 703.555.1212 handle which represents a particular home within the invention. The “Stove” handle has been associated with the invention enabled appliance in the home kitchen known as the stove. Other telephone numbers belonging to the same owner or same household could also have been used to query this kitchen appliance.

FIG. 32 shows a sample screen print of an Internet browser based invention display that shows the handle “Freezer” which belongs to handle “Fridge” which belongs to handle “Kitchen” which belongs to the North American telephone number 703.555.1212 handle which represents a particular American home within the invention. The “Freezer” handle has been associated with the upper portion of the invention enabled appliance in the home kitchen known as the refrigerator (handle “Fridge”). Other telephone numbers belonging to the same owner or same household could also have been used to query this kitchen appliance.

FIG. 33A shows an instant message being sent from the URI/URL line of an Internet browser.

FIG. 33B shows the same instant message being sent from the URI/URL line of an Internet browser as FIG. 33A, but with an optional http://www “user comfort” lead off.

FIG. 34A shows the use of a car license plate as an e-mail address.

FIG. 34B shows the use of a car license plate as a web address to perform a 411 look-up of the owner's address and phone numbers, includes a http:// “formality” prefix.

FIG. 35A shows URI/URL entry of status in flight to Baltimore for telephone subscriber 800.555.1212 using the .ac Area Code TLD.

FIG. 35B shows URI/URL entry of status in flight to Baltimore for telephone subscriber 800.555.1212 using the .ac Area Code TLD with an http://www “user familiarity” prefix.

FIG. 35C shows URI/URL entry used to retrieve the intersection of mutual external task lists with an http:// “traditional” prefix.

FIG. 36 shows a 411 information area code phone number look-up by person's name and state.

FIG. 37 shows a query for current status of people named John Goodspeed within North American area code 410.

FIG. 38A shows one subscriber joining a tournament charter fishing group that belongs to another subscriber via one step direct command entry on the browser URI/URL address line.

FIG. 38B shows one subscriber leaving a tournament charter fishing group that belongs to another subscriber via one step direct command entry on the browser URI/URL address line.

FIG. 39 shows an example initial subscriber sign-up procedure form.

FIGS. 40-50 depict detailed group and handle formal ownership arrangement examples.

### DETAILED DESCRIPTION OF THE PREFERRED EMBODIMENTS

The preferred embodiment of the present invention is discussed in detail below. While specific configurations are discussed, it should be understood that this is done for illustration purposes only. A person skilled in the relevant art will recognize that other components and configurations may be used without departing from the spirit and scope of the invention.

This invention is the embodiment of novel and original thinking in the form of executable computer code and includes a collection of design concepts, procedures, database schemas, specialized Domain Name System (DNS) entries, web based applets and regional processing computers connected via the global Internet.

By way of this invention, every telephone number worldwide becomes an identifying Internet URI/URL handle or access key for use in information storage, transmission, retrieval and continuous monitoring/observation. This invention allows its users to monitor people, devices, equipment and resources and to be monitored by others by using various forms of telephone number URI/URL identifiers herein called handles. This invention allows users to publish for public or private access their telephone number or multiple telephone numbers and/or other handle(s) which include within them a telephone number. A handle may be any unique arbitrary collection of letters, numbers and special characters. A telephone number would be a type of handle, however not all handles are the same as telephone numbers. Some examples of handles include, but are not limited to name (FIGS. 36 and 37), postal address, e-mail address, pager number or pin, instant messaging address, Social Security Number, PDA/PCD network identification/serial number, IP address, license plate or tag number (FIGS. 34A and 34B) or other arbitrary user created identifier. The invention allows an owner to create and maintain a large set of handles. The invention maintains a cross reference list of all handles belonging to the same owner. Any handle which has as one of its component parts a telephone number formatted according to the rules of Table 1 shall be deemed to be owned (at least shared ownership if created by another party) and controlled by the owner/subscriber of that basic component telephone number. This invention makes the telephone number the unification address for electronic contact, messaging, status keeping and status seeking, tasking, schedule and time management, location tracking and ETD/ETA/ETC distance and speed calculation. The invention is worldwide in scope and supports all languages and telephone number formats and international Internet character sets.

People so authorized by the telephone number's owner/subscriber could check the telephone number owner/subscriber's current status, task list(s), physical location, ETD/ETA/ETC and other vital information (FIG. 24) by simply knowing any one of the telephone numbers or related handles of the person or thing for whom or for which they wish to check current status and location.

There would be no need to place a voice call to interrupt the party to determine their location, current assignment, status condition, pending tasks or other pertinent available information. Instead, the inquiring party would simply access the other party's current status, task, location, ETA/ETD/ETC and other information using any of the subject party's known telephone numbers or handles as an Internet compatible URI/URL query address.

This invention makes it possible to enter a North American telephone number or International telephone number or other related handle directly into any Internet address field be it as a direct URL web address or as a direct URI e-mail address and have it produce immediately useful results via the invention system.

The invention allows entering the sought after party's telephone number in any Internet browser's URL address field or any e-mail address field or by using DTMF or voice commands on a telephone. These procedures will access the details of the target party's current status, current task assignment and location along with their pending internal/external/shared task schedule (to-do list) and any other pertinent subscriber defined information. Authorization is under the control of the telephone number's owner/subscriber.

Personal Digital Assistants (PDA) or Personal Communications Devices (PCD) or other fixed/mobile electronic (communications capable) devices may have telephone number(s) and/or other related handles symbolically linked to them by the subscriber. They may also be part of an associated PDA/PCD notification group or may be referenced by an assigned serial number or IP address. A fixed office, factory or home computer or other fixed position device may also have telephone number(s) and/or other handles symbolically assigned to them. They may be part of an associated PDA/PCD notification group or may be referenced by an assigned serial number or IP address. Any reference herein to a PDA/PCD capability will generally apply to mobile items such as cell telephones, pagers, computers, sensory and control devices, status updating, location tracking, navigation, electronic devices etc. as well as to any fixed position computer, device, sensor, apparatus, appliance, item of equipment etc. as well.

To save time, telephone numbers and handles can be specified to auto complete (and auto-submit) upon entry of a unique number of characters. The auto complete can be based upon either leading or trailing unique character sequences entered with respect to a given passage of time. The Invention is able to learn these unique sequences over time and/or by direct completion hints supplied by the owner.

The owner/subscriber of a telephone number or other handle can define public and private data layers (from superficial to detailed) of viewable information about themselves. The invention defines at least seven (7) levels/layers of access and update security. A data layer is a discrete subset of data items pertaining to the owner/subscriber which is derived from the complete set of all available information pertaining to the owner/subscriber. Each data layer may be independent of other data layers or may overlap any of the other layers. The owner/subscriber controls the ability of others be they group members, the general public, business associates, family or friends to see the various layers or modify any items therein. A public layer has no password assigned to it. A private layer has an access password assigned to it. By default, the general public may only be able to view a public layer that contains very minimal or perhaps no information about the owner/subscriber. Some family members may be authorized to view a layer that contains all information pertaining to the owner/subscriber. Business associates may be authorized to view, and modify elements of, a layer that contains the task schedule and project assignment collaboration list but little else. Therefore each authorized user may have a different view of the owner/subscriber and his or her or its data element details depending upon which owner/subscriber assigned data layer passwords they are in possession of.

The viewer can create a personal viewing template for any given owner or group. This personal template may define fewer data items for display than are authorized for display. This is handy when the user simply wants brief summary information displayed and continuously updated. Personal viewing templates may be saved for re-use at a later time. An example would be a template that shows just the current status and location of three children within a family that automatically updates on screen every 60 seconds.

An owner or other authorized user (subject to security constraints) may be able to set any of the owner's data elements such as current status and location, current internal/external/shared task, future internal/external/shared tasks or post remarks or custom information in any of several ways, such as:

A method is to access their own telephone number's Internet status web monitoring site via entry of any one of their personal or business telephone numbers entered as a URL/URI address (see Table 1) in any form of Internet browser operating upon any type of Internet browser enabled device operating upon any type of Internet connection. For some PDA/PCD devices the telephone number is entered (or selected from a list or spoken) into a single data access retrieval field of a previously downloaded PDA/PCD custom status and location retrieval and update applet (FIG. 26 and FIG. 27). This might be done in cases where the PDA/PCD has no directly available general purpose Internet browser wherein a URL/URI can be entered.

Once their current status, location and other custom information defined by the owner/subscriber are displayed either in a browser form or upon a custom Internet communications applet the authorized user may then update these items. Updates are under authorization by caller-ID, serial number ID, password protection, digital certificate or other trusted authentication (i.e. voice/finger/retina print) scheme (with encryption) if desired.

Another method is to send an e-mail which e-mail has the To: address (specified as defined in Table 1) being the telephone number in question for which the status update, task or location is to now be set. The subject line and/or the body contain the authorization code, authentication/encryption information (PGP etc.), status code, task code, location, ETD/ETA/ETC and other possible owner defined information.

Voice commands may be used instead of a selection device (mouse, trackball, touchpad, stick, eye movement tracking, brainwave/thought detection, nerve impulse) or typing. In general commands may be entered via any input medium that is available upon or within the source Internet connected device. Sometimes using a selection device or typing a command will be more appropriate or efficient than giving an audible command. An example given in spoken form will have a counterpart in a selecting device or typing. Options or techniques shown in one example are generally applicable to other examples.

By speaking to the PC/PDA/PCD using a short status update phrase such as “at hospital” or “en route” or “delivering” or “location” or “working at office” or “working at job site” or “in flight”. If so authorized, these examples of spoken phrases will cause the PC/PDA/PDC to transmit the appropriate commands (with authentication) to update the status of the device and its owner via a direct telephone number URI/URL entry that includes the prefixed command status codes. For example, the spoken command “working at office” might generate the URL/URI: 8294.91.410.849.2052.ac

where 8294 is the authorizing PIN needed to perform this update, 91 (Table 2) is the subscriber established numeric code for “working at office”, 410.849.2052 is the subscriber telephone number for which status is to be updated and .ac is the Internet telephone “Area Code” TLD. The actual transmission to the Internet from the URI/URL line would be:

8294.91.410.849.2052.ac

and this would accomplish in one step the setting of telephone number 410-849-2052 subscriber's status to that of being “working at office”. The URI/URL could also be entered as:

8294.wrkg.410.849.2052.ac

because this subscriber has a Table 2 entry defining the abbreviation “wrkg” to mean “working at office”.

Speaking “8005551212 in flight to Baltimore” will place the device with the handle 8005551212 and/or owner thereof in a status of “in flight” with a remark of “Baltimore”. An owner's device may be able to use a default handle and PIN if none given, thus speaking “in flight to Baltimore” could suffice to set the status by automatically generating the URL/URI command:

7274.36.19.800.555.1212.ac

where 7274 is the default authorizing PIN of this device needed to perform this update, 36 (Table 2) is the subscriber established verb code for “in flight” and 19 (Table 2) is the subscriber established location code for “Baltimore”, 800.555.1212 is the subscriber phone number to be updated and .ac is the Internet telephone “Area Code” TLD. The actual example Internet transmission from the URI/URL line would be:

7274.36.19.800.555.1212.ac

and this would accomplish in one motion the setting of telephone number 800.555.1212 subscriber's status to being “in flight to Baltimore” for the rest of the world to be able to see. Note that the owner defines the precedence of verb over location over object or vice versa, that is why there is no invention conflict between the use of 36 and the 19 from Table 2, the order of their appearance on the URI/URL entry automatically prevents conflict. Alternatively the command could have been submitted to the Internet as URI/URL:

7274.$in flight to Baltimore$.800.555.1212.ac

where there might have been no established codes for “in flight” or “Baltimore” and so the plain words were transmitted instead with surrounding dollar “$” signs indicating that this is indeed a plain language status update (FIGS. 35A and 35B). Because Table 2 has abbreviations for both InFlight (inf) and Baltimore (balt) the command could also have been submitted to the Internet as URI/URL.

7274.$inf balt$.800.555.1212.ac

or even as

7274.inf.balt.800.555.1212.ac

Speaking “location 4102129119” will cause The invention to attempt to immediately determine via direct device query the current location latitude/longitude (LAT/LON) and altitude of the communications device associated with telephone handle 410-212-9119. As soon as the device responds with its location the status monitor will visually reflect the new location and a message (voice or text) will be returned indicating the current location of the device and, security permitting, progress along route, ETD/ETA and other possible owner defined information. For example, the automatically generated Internet URI/URL address command line entry might be: location.410.212.9119.ac

where the keyword “location” will cause (subject to any security constraints in effect) a latitude/longitude/altitude (LAT/LON/ALT) and associated common place name to be returned (FIG. 28) for North American telephone number 410.212.9119 to the issuer of the URI/URL address line query.

Speaking “map 8775551212” will cause the display of a map highlighting the location of the communications device associated with handle 8775551212 along with a display of its (or its owner's) current status, progress along route and ETA. For example, the automatically generated Internet URI/URL address command line entry might be:

map.8775551212

where the keyword “map” will cause (subject to any security constraints in effect) a map centered on the latitude/longitude (LAT/LON) and showing altitude if available of the device to be returned for North American telephone number 8775551212 to the issuer of the URI/URL address line query. Note that in this example the entire telephone number 8775551212 is serving as its own invention supported TLD.

Speaking “show (group) 8005551212” will cause the display of some or all (depending upon access level security constraints) of the status, task, location and general information pertaining to the device and/or owner associated with handle 8005551212. If the keyword group were included with the show command then the resulting display will be for all members of the group associated with handle 8005551212. For example, the automatically generated Internet URI/URL address command line entry might be:

show.group.800-555-1212

where the keywords “show” and “group” will combine to cause (subject to any security constraints in effect) a display of the handle, task name, task type, status, duration and task start/finish information (FIG. 23) pertaining to all of the devices and/or owners associated with groups which are in turn associated with telephone handle 8005551212 which is North American telephone number 800-555-1212 to the issuer of the URI/URL address line query. Note that in this example the entire telephone number 800-555-1212 is serving as its own invention supported TLD.

Speaking “listen 8005551212 (compare (with) (profile) spy 2)” will command the remote device associated with handle 8005551212 to auto-answer and immediately open its audio capabilities for real-time monitoring of the speech or sounds within the vicinity of the device. If the optional “compare spy 2” is included, the received information will be compared with the previously stored profile image named “spy 2”. Unacceptable contrasts between the profile and currently received sound information will be highlighted. For example the generated Internet URI/URL address command for this function might be:

compare.spy2.listen. 555.1212.800.com

which automatically performs the entire task returning to the requester the comparative results.

Speaking “view 8005551212 (match (with) (profile) boat)” will command the remote device associated with handle 8005551212 to auto-answer and immediately open its video capabilities for real-time monitoring of the sights and possibly speech or sounds within the vicinity of the device. If the optional “match boat” is included, the received information will be matched with the previously stored profile image named “boat”. Unacceptable contrasts between the profile and currently received information will be highlighted. For example the generated Internet URI/URL command address for this function might be:

match.boat.view. 555.1212.800.ac

which automatically performs the entire task returning to the requester the comparative results.

Speaking “sense 7035551212 (compare (with) (profile) smith 3)” will command the remote device associated with handle 7035551212 to auto-answer and immediately open its medical and/or environmental and/or sense capabilities for real-time monitoring and reporting. Some monitored conditions might include the temperature, humidity, smoke, gas, carbon monoxide and other environmental factors, mechanical conditions (i.e. industrial processes, equipment, appliances), vehicle conditions (i.e. oil/fuel level, engine and brake performance) within the range of the device. Sensed medical conditions may include but are not limited to brain activity, heart activity, glucose level, blood pressure, and respiration rate. If the optional “compare smith 3” is included, the received information will be compared with the previously stored profile image named “smith 3”. Unacceptable contrasts between the previously stored profile and the currently received information will be noted, highlighted and alerts transmitted. For example the generated Internet URI/URL address for this function might have been: compare.smith3.sense.555.1212.703.org

which automatically performs the entire sensory comparative task returning to the requester the comparative results and alerting others if the differing results are beyond those specified in the profile.

Speaking “status 7035551212 stove” will command the “stove” (subgroup) appliance associated with telephone number handle 7035551212 to report back on the current status of its burners and oven etc (FIG. 31). Speaking “status 3015551212 fridge” will command the “fridge” (subgroup) of appliances associated with telephone number handle 3015551212 to report back on their current status of refrigeration and freezer conditions etc. As always, an owner's device may be able to use a default handle if no handle is explicitly given such that all that need be spoken (or selected/typed) is “status stove”, “status fridge” or “contents fridge”. The device upon which the command is issued can then supply its own handle to qualify the command. Examples of the generated URI/URL handles would be:

fridge.301.555.1212.ac or stove.703.555.1212.ac

Speaking “close (or stop) area code 4108492052” will command the remote device to stop actively pursuing what it was originally commanded to do and return to its normal inactive state (to disconnect or hang-up). Example URI/URL:

close.8492052.410.org

Speaking “task 573.5600.410.849.8989.410” will query the invention for intersection points between the task lists telephone subscriber 573.5600.410 and of telephone subscriber 849.8989.410 displaying any task relationships the two parties have in common. For example if subscriber 849.8989.410 dropped off a large print job at Kinko's in Annapolis whose phone number is 573.5600.410 then this task query would show the current status and estimated time to completion of the print job (FIG. 35C). The telephone numbers could also have been entered with leading area codes. A PIN number could have been required to limit access to this information. Examples of the generated valid URI/URL handles would be:

573.5600.410.849.8989.410.ac or 849.8989.410.573.5600.410.ac

or

410.573.5600.410.849.8989.ac or 410.849.8989.410.573.5600.ac

or

task.410.573.5600.ac or task.410.849.8989.ac

or

task.410.573.5600 or task.410.849.8989

Location updates may be made either manually or automatically. Automatic latitude/longitude/altitude (lat/lon/alt) location updates (needed for mapping, proximity events, historical reference, algorithmic decisions etc.) are performed whenever a status, task, data item or call is transmitted or received. The PDA or PCD under command of the invention (via scheduled (repetitive) command (or script invocation) on a task list) or under immediate owner command can be asked to supply lat/lon/alt updates as often as desired depending upon safety or tracking requirements.

The invention will automatically relate predefined radii from predefined lat/lon/alt coordinates to a particular invention or owner defined common place name. An owner many define as many common place names as required for their application. For example a given radius and altitude from the coordinates of an owner's office might be given the common place name “Office 16^{th} Floor”. This allows for the shorthand entry of certain owner defined commands such as “Working” or “En Route” or “Unavailable”. If the owner issues a status of “Unavailable” from within the pre-defined radius and altitude of the coordinates owner labeled as “Office 16^{th} Floor” their world wide viewable status would automatically become “Unavailable at Office 16^{th} Floor”. If the owner issues a status command of “En Route” or “Here” from within the pre-defined radius and altitude of the coordinates invention labeled as “1400 block Maple Ave.” their world wide viewable status and location would automatically become “En Route” or “Here” from/at “1400 block Maple Ave.”. Depending upon circumstances device owners participating in the invention may have control over the “if and when” and physical length and/or relative truncation of lat/lon/alt transmissions and/or the degree of public visibility thereof.

The invention remembers each received lat/lon/alt waypoint together with its date and time. Over the course of time the invention builds a travel history database by device owner of routes and waypoints and relative elapsed travel time between waypoints and direction of travel between these points together with an accumulation of averages thereof. Over time the invention correlates the waypoints and directions of travel between points together with date and time of day with physical roads or routes. The invention becomes increasingly familiar with a particular PDA or PCD owner's travel habits and patterns through comparisons of current course, route type, time of day and destination with historical course, route type, time of day and destination. Therefore, the invention is able to render ever improving real world predictions of owner waypoint and destination ETA. Furthermore, the invention is simultaneously aware of all owner histories over all routes over a broad range of dates and times. The invention may have knowledge of, or a good prediction of, the route being taken, together with a known or predicted destination. The invention will offer alerts to the owner of possible poor conditions (construction, congestion, accidents, advancing weather, etc.) that may be encountered en route to the (known or predicted) next waypoint or final destination. The invention will offer alternative routes to the owner(s) to possibly help them avoid upcoming poor conditions. The invention can alert each given owner because the invention is aware (in real time) of the progress of other invention participating owners who are at varying distance ahead on the same (or opposite) predicted route. The invention is aware (in real time) of the progress of other invention participating owners on other possible alternative routes. The invention is aware (in real time) of the progress of other invention participating owners at the local metropolitan, regional, national and international level. The invention can sense an unnatural stop along a given route and generate an alert both to other invention users, public safety officials and the news media. The invention is also aware of real time weather conditions and their direction and speed of movement and can alert members accordingly. In addition, any invention participant on a given route can issue a “traffic/weather/caution alert” which is made available to other invention participants to the rear (or ahead traveling in the opposite direction) on the same route. The invention will also attempt to continuously issue revised owner ETA (FIG. 24) based upon the real time progress of other owners (plural) of whom the invention is aware that are currently navigating through the good or poor condition up ahead on this owners predicted or known route. Those members of the public worldwide so authorized will also be able to see the dynamic changes to any given owner's ETA as they happen. If the owner's ETA is outside of the acceptable range needed for a scheduled appointment an alert will be sent to the most appropriate devices of the person or persons with whom the owner was to meet. This invention feature saves the owner the time and frustration of having to personally contact the parties with whom he is trying to meet at a now impossible time.

Manual updates may also be entered for more specific location remarks such as 1428 Grand Ave, 14^{th} floor, Suite 1400 (city and state can default automatically).

Any authorized person, member of the general public or automated system may hear and/or view the most recent and historical status and location of any telephone number associated device, handle or the owner thereof in any of several ways:

Authorized users on the Internet may view and/or hear the most recent and historical status, activity and location updates for any telephone number, related handle or the owner thereof. This query for current and historical status and location information can be accomplished by entry of a telephone number or other related handle as a URI/URL address (as specified in Table 1) in any form of Internet browser on an Internet enabled device connected to the Internet. This query for current and historical status, location and other information can also be accomplished by sending an e-mail query directly to the telephone number or related handle URI (see Table 1) requesting a return e-mail containing the requested information.

Authorized users via telephone may hear the playback of the most recent and historical status, location and information updates for any telephone number, handle or the owner thereof. This query for status and information is accomplished by entry of a personal or business telephone number entered as DTMF tones. Assuming that the sender of the DTMF encoded telephone number and query command is authorized, they will be given an audible announcement as to the status, location and other owner provided information associated with the telephone number (or handle) just entered via DTMF tones.

An e-mail query may be sent to any known telephone number or handle address (of a form specified in Table 1) to query that handle and owner's status. If the subject line or body leads off with a particularly specified and agreed upon query indicator character(s) (Ex. ++), a responding e-mail will be returned which contains the latest status, location and other specified information for the telephone number just previously queried via e-mail.

Every status, task and location change update may be time and date stamped for historical tracking purposes at the owner's discretion. Such captured historical information can be made available to others by means of data layer authorization. Assuming a prior grant of permission by owner, such historical data shall also be available to Public Safety Agencies for use in emergencies.

Telephone number (handle) owners may opt to become group participants in multiple simultaneous voluntary (possibly nested) groupings with other PDA/PCD owners (Table 3 and FIG. 29). These named (and perhaps nested) groupings (a group name may be an arbitrary collection of letters, numbers and special characters) of owners may then be displayed by browsers or custom applets ordered within their named groupings (possibly within groupings (within groupings . . . )) by various viewer specified criteria. Specific sorted display criteria for a specific group or subgroup might be by status and by name within status etc. depending upon the needs of the viewer. Depending upon the capabilities of the browser, applet, physical device and communications links multiple independent groups and subgroups can be displayed simultaneously. Regularly needed customized group views may be saved for recall and use later.

Owners may publish their various available groups (and available levels/layers thereof) for easy access by worldwide public and private viewers. For instance the owner (group) 7035551212 might in turn own a group called “kitchen” (kitchen.703.555.1212.ac) which in turn owns the groups “stove” (FIG. 31), “fridge” which in turn owns “freezer” (FIG. 32), “dishwasher” and “microwave” (stove.kitchen.703.555.1212.ac fridge.kitchen.703.555.1212 freezer.fridge.kitchen.703.555.1212 etc.). These published group and subgroup names would allow any authorized viewer worldwide to quickly determine that there is indeed a kitchen (group) with appliances that are sense capable and to find out if, for instance, the right rear burner of the “stove” (group) is on or off. Authorized users could determine the contents of the freezer and perhaps its current operating temperature. Assuming that the given worldwide viewer had permission they could also turn a particular burner on or off or change the temperature of the freezer.

Any owner (or device or computer resource) may create a group. A group has a handle assigned to it just as an owner does (FIG. 29). The creator of a group may automatically become the Group Leader and may be responsible for the permissions controlling who else may join the group (FIGS. 40 through 50). A Group Leader defines the physical and logical data characteristics of their group. A group leader can join his or her or its group as a subgroup to another existing group or to multiple other groups, subject to the permission of any existing group's group leader. A group leader can join to itself as many other groups as may have granted permission to be so joined. Group leader's can transfer or share their owner authority to or with another owner at any time. Both groups (via their group leader) and individual owners may opt out of groups at any time. Individual owners may grant varying degrees of special access and control authority to the group leaders of the groups (group by group grant specification) that they have joined.

A few examples of groupings are provided, (Table 3):

A grouping composed of all those telephone, PDA or PCD or PC owners working in collaboration on a particular company project or task force.

Subgroup might be those based west of Mississippi

Subgroup might be those based east of Mississippi

Subgroup might be those out of the office at this moment

A grouping might be composed of all those owners playing on the same baseball team.

Subgroup might be all of the pitchers on the baseball team

A group might be all of the HVAC environmental units on an office campus

Subgroup might be those HVAC units in a given building

Subgroup those HVAC units on a floor of a building

A group might be all firefighters working a fire

Subgroup might be those who's respiration or heart rate is extreme

A group might be all members required for a specialized surgical team.

A group might be a collection of couriers of donated transplant organs.

Subgroup might be air couriers

Subgroup might be ground couriers

A group might be all those awaiting a liver transplant in the United States

Subgroup awaiting liver transplant in Maryland

Subgroup awaiting liver transplant in Baltimore

A group might be all hospitals within a given metropolitan area.

Subgroup of those with a cardiologist available at this instant

Subgroup of those with an MRI system available at this instant

A group might be all agents working in all FEMA command centers.

Subgroup those working in FL, GA, SC, NC, VA, DE, MD

Subgroup those working in South Carolina

Subgroup currently On-Duty in South Carolina

Subgroup those working in Charleston

A secretary may assign all employees for whom he or she is responsible to a virtual office status whiteboard group itself in turn composed of more specific groups. Multi-member groups belonging to this office whiteboard group might be “sales” and “support” and “admin”. The secretary would probably define various handy status views so as to be able to quickly scan the status of all members of just say the “support” or “sales” group that he or she previously defined. Another status view might show all employees simultaneously and be automatically updated every 30 seconds. These groups would probably ultimately belong (be assigned to) the main office telephone number. An Example, the main office number is 703.445.5000 therefore the “sales” group URI/URL would be sales.703.445.5000.ac and the “admin” group URI/URL would be admin.703.445.5000.ac etc.

FIGS. 40 through 50 concentrate deeply on the concept and operations of groups and handles within the invention. Ultimately all groups and handles have as their root or base domain a telephone number of some type.

Group and Owner Relationships FIG. #40 diagrams the relationships between some of the various forms of group types within the invention. All groups within the invention are of one type or another. Some group types include: RM—Root Master, OM—Owner Master, OS—Owner Subordinate etc. A group is a collection of invention required and owner defined data buckets referenced by a unique handle. The uniqueness of a handle may be derived from qualifying it by its parent's handle.

The primary concept to be grasped from this diagram is that of the Root Master Group (RMG) group. The RMG is an owner which contains all of the master data pertaining to an owner such as the owner's real name, home or business address, phone numbers and their times of best use, rules base, password access tables, etc.

The RMG is the very top of the group food chain, it is a root node. For a typical member of the invention owner customer base the RMG would probably be their primary home phone number, which would become their RMG handle. Each and every RMG within all of the invention must be unique.

The RMG is needed so as to form the basis of a master mother-of-all-owners group for a given owner. The RMG contains core universally applicable information pertaining to the owner. In a RDBMS sense, the RMG is the single authoritative source for information such as name, address, email addresses, password security etc.

Any group created from or by the RMG will inherit the owner information (rules base, passwords etc.) contained in the RMG. This makes secondary or subordinate group creation faster, it avoids the need to redundantly specify base owner information.

The ultimate RMG owner is the invention itself. When an owner (customer/device) creates an RMG the RMG inherits specifications from an appropriate (customer/owner selected) invention pre-defined design template. These specifications may include pre-defined status codes, status types, rules base etc. These inherited specifications save time in setting up an RMG and provide consistency of form within the invention.

An Owner Master Group (OMG) is similar to an RMG but rather than being directly owned by the invention it is owned by an RMG. Like an RMG an OGM serves as a reference point for security, rules bases, abbreviations etc. Each and every OMG within all of the invention must be unique.

Either an OMG or an RMG may serve as a Home Group. A home group defines the basic invention rules of the road to all of its subordinate groups.

An Owner Subordinate Group (OSG) is in turn owned by either an RMG, an OMG or OSG parent. The OSG inherits its basic qualities and data buckets from its parent. An OSG may also contain data buckets whose definition was derived (inherited) from an invention template specification (i.e. Maytag Dishwasher Model 216A) and may contain an arbitrary number of additional owner defined custom data buckets. The inherited qualities or buckets can each be deleted or modified at any time by the owner, they were inherited to assist in quickly defining the new OSG, they are not hard and fast. An OSG does not have to be unique. Part of the power of the invention queries comes from the fact that an OSG name does not have to be unique.

Group ownership can be nested to an arbitrary depth (FIGS. 40 through 50). A group can own an arbitrary number of groups (FIGS. 40 through 50).

Group and Owner/Subscriber Relationships FIG. 41 diagrams the relationships between some of the various forms of the group type OS—Owner Subordinate etc. An OS group (OSG) is a collection of invention required and owner defined data buckets referenced by a unique handle. The uniqueness of a handle may be derived from qualifying it by its parent's handle. An OSG only need be unique within the realm of its immediate parent.

The unique handle to the outside world in this diagram would be formed as medical.410.849.8989 which would provide access the overall state of the medical group. The sub groups john and catherine would be accessed from the outside world as john.medical.410.849.8989 or catherine.medical.410.849.8989 respectively. The sub groups john and catherine could also be accessed from the outside world as john.medical.849.8989.410 or catherine.medical.849.8989.410 respectively. When logged into the Home Group 410.849.8989 (or 849.8989.410) there would be no need to include the Home Group in a reference to group medical or to group john or to group catherine as these groups are all unique within the 410.849.8989 RMG.

The primary concept to be grasped from this diagram is that of the Owner Subordinate Group (OSG). The OSG is an owner group used to contain much of the detailed data pertaining to a given class of owner information. A class of owner information might be medical information or household information or automotive information.

The OSG is a branch, twig or leaf in the tree structure. For a typical invention user the OSG would probably hold detailed data about various items of importance to its RMG or OMG owner.

The OSG is needed so as to form the foundation of detail data storage for a given owner. The OSG contains the idiosyncratic information pertaining to various topics of interest to the owner. In a RDBMS sense, the OSG is similar to a row in the database, however, unlike rows, one OSG can be nested inside another after another.

Any group created from or by an OSG will inherit the owner information (rules base, passwords etc.) contained in the creating OSG. This makes secondary or subordinate group creation faster, it avoids the need to redundantly specify base owner information.

The ultimate OSG owner is either an RMG or an OMG. When an owner RMG, OMG or OSG (customer/device) creates an OSG the OSG inherits its initial specifications from its owner. These inherited specifications save time in setting up an OSG and provide consistency of form within the invention.

An OSG will specify either an OMG or an RMG as its Home Group. A home group defines the basic invention rules of the road to all of its subordinate groups. An OMG or RMG also provides the point of reference within which abbreviations of OSG handles may be used.

An Owner Subordinate Group (OSG) is owned by an RMG, an OMG or another OSG parent. The OSG inherits its basic qualities and data buckets from its parent. An OSG may also contain data buckets whose definition was derived (inherited) from an invention template specification (i.e. Maytag Dishwasher Model 216A) and may contain an arbitrary number of additional owner defined custom data buckets. The inherited qualities or buckets can each be deleted or modified at any time by the owner, they were inherited to assist in quickly defining the new OSG, they are not hard and fast. An OSG does not have to be unique. Part of the power of the invention queries comes from the fact that an OSG name does not have to be unique. Thus a reference to john.410.849.8989 will access both john's medical information as well as john's car and boat information.

OSG group ownership can be nested to an arbitrary depth. Each OSG group can own an arbitrary number of other OSG groups.

Group and Owner Relationships FIG. 42 diagrams the relationships between some of the various forms of the group type OS—Owner Subordinate etc. An OS group (OSG) is a collection of invention required and owner defined data buckets referenced by a unique handle. The uniqueness of a handle may be derived from qualifying it by its parent's handle. An OSG only need be unique within the realm of its immediate parent.

The unique handle to the outside world in this diagram would be formed as house.410.849.8989 (or house.849.8989.410) which would provide access the overall state of the medical group. The sub groups appliance and security would be accessed from the outside world as appliance.house.410.849.8989 or security.house.410.849.8989 respectively. The sub groups appliance and security could also be accessed from the outside world as appliance.house.849.8989.410 or security.house.849.8989.410 respectively. When logged into the Home Group 410.849.8989 (or 849.8989.410 there would be no need to include the Home Group in a reference to group house or to group appliance or to group security as these groups are all unique within the 410.849.8989 RMG.

Notice that the OSG appliance is the owner of OSG fridge, stove, nuke, hvac and yard. Note that OSG stove contains the detailed specifications and real-time data for a specific Maytag model 1209z stove appliance. The Maytag 1209z specification template was retrieved from the invention manufacturer template library. The access to real-time details and controls pertaining to this stove can be had via query to stove.410.849.8989 or to stove.appliance.house.410.849.8989 the later being more formal and thus a little quicker to access the data. However, after a query to the informal stove.410.849.8989 the invention will automatically substitute the fully qualified name on subsequent queries.

The primary concept to be grasped from this diagram is that of the Owner Subordinate Group (OSG). The OSG is an owner group used to contain much of the detailed data pertaining to a given class of owner information. A class of owner information might be medical or household or automotive or any other information important to an owner.

The OSG is a branch, twig or leaf in the invention tree structure. For a typical invention user the OSG would probably hold detailed data about various items of importance to its RMG or OMG owner.

The OSG is the foundation of detail data storage for a given owner. The OSG contains the idiosyncratic information pertaining to various topics or devices of interest to the owner. In a RDBMS sense, the OSG is similar to a row in the database, however, unlike rows, one OSG can be nested inside another after another.

Any group created from or by an OSG will inherit the owner information (rules base, passwords etc.) contained in the creating OSG. This makes secondary or subordinate group creation faster, it also avoids the need to redundantly specify base owner information.

The ultimate OSG owner is either an RMG or an OMG. When an owner RMG, OMG or OSG (user/device) creates an OSG the OSG inherits its initial specifications from its owner. These inherited specifications save time in setting up an OSG and provide consistency of form within the invention.

An OSG will specify either an OMG or an RMG as its Home Group. A home group defines the basic invention rules of the road to all of its subordinate groups. An OMG or RMG also provides the point of reference within which abbreviations of OSG handles may be used.

An Owner Subordinate Group (OSG) is owned by an RMG, an OMG or another OSG parent. The OSG inherits its basic qualities and data buckets from its parent. An OSG may also contain data buckets whose definition was derived (inherited) from an invention template specification (i.e. Maytag Dishwasher Model 216A) and may contain an arbitrary number of additional owner defined custom data buckets. The inherited qualities or buckets can each be deleted or modified at any time by the owner, they were inherited to assist in quickly defining the new OSG, they are not hard and fast. An OSG does not have to be unique. Part of the power of the invention queries comes from the fact that an OSG name does not have to be unique. Thus a reference to john.410.849.8989 will access both john's medical information as well as john's car and boat information.

OSG group ownership can be nested to an arbitrary depth. Each OSG group can own an arbitrary number of other OSG groups.

Group and Owner Relationships FIGS. 43, 44 and 45 diagram the relationships between some of the various forms of the group type OS—Owner Subordinate and OM—Owner Master etc. An OS group (OSG) is a collection of invention required and owner defined data buckets referenced by a unique handle. The uniqueness of a handle may be derived from qualifying it by its parent's handle. An OSG only need be unique within the realm of its immediate parent.

The unique OSG handle to the outside world in this diagram would be formed as john.410.212.9119 (or john.212.9119.410) which would provide access the overall state of the john OSG. The OSG car and boat would be accessed from the outside world as car.john.410.212.9119 or boat.john.410.212.9119 respectively. The OSG car and boat could also be accessed from the outside world as car.john.849.8989.410 or boat.john.849.8989.410 respectively. When logged into the Home Group 410.212.9119 (or 212.9119.410) there would be no need to include the Home Group in a reference to OSG john or to OSG car or to OSG boat as these OS groups are all unique within the 410.212.9119 OMG.

Note that 410.212.9119 is an Owner Master Group (OMG) which is in turn owned by 410.849.8989 which is a Root Master Group (RMG). This relationship means that, depending upon what access options are set, 410.849.8989 may effectively be used as a home group for john, car and boat. Thus car.410.849.8989 would qualify to a unique and correct OSG. However, john.410.849.8989 would either yield the medical data from john.medical or both john.medical data and john.410.212.9119 data or ask for clarification as to which is desired. Any potential ambiguity among OSG is decided by option flags set at the RMG and/or OMG level.

Notice that the OSG car is the owner of OSG engine and brakes. Note that OSG engine contains the detailed specifications and real-time data for a specific Mazda RX-7 model D11 car engine. The Mazda RX-7 model D11 specification template was retrieved from the invention manufacturer template library. The access to real-time details and controls pertaining to this engine can be had via query to engine.410.212.9119 or to engine.car.john.410.212.9119 the later being more formal and thus a little quicker to access the data. However, after a query to the informal engine.410.212.9119 the invention will automatically substitute the fully qualified name on subsequent queries. Note that due to the OMG to RMG relationship an informal query of engine.410.849.8989 could also be used, flag settings permitting.

The primary concept to be grasped from this diagram is that of the Owner Subordinate Group (OSG) and its relationship to an Owner Master Group (OMG) and possibly to a Root Master Group (RMG). The OSG is an owner group used to contain much of the detailed data pertaining to a given class of owner information. A class of owner information might be medical or household or automotive or any other information important to an owner.

The OSG is a branch, twig or leaf in the invention tree structure. For a typical invention user the OSG would probably hold detailed data about various items of importance to its RMG or OMG owner.

The OSG is the foundation of detail data storage for a given owner. The OSG contains the idiosyncratic information pertaining to various topics or devices of interest to the owner. In a RDBMS sense, the OSG is similar to a row in the database, however, unlike rows, one OSG can be nested inside another after another.

Any group created from or by an OSG will inherit the owner information (rules base, passwords etc.) contained in the creating OSG. This makes secondary or subordinate group creation faster, it also avoids the need to redundantly specify base owner information.

The ultimate OSG owner is either an RMG or an OMG. When an owner RMG, OMG or OSG (user/device) creates an OSG the OSG inherits its initial specifications from its owner. These inherited specifications save time in setting up an OSG and provide consistency of form within the invention.

An OSG will specify either an OMG or an RMG as its Home Group. A home group defines the basic invention rules of the road to all of its subordinate groups. An OMG or RMG also provides the point of reference within which abbreviations of OSG handles may be used.

An Owner Subordinate Group (OSG) is owned by an RMG, an OMG or another OSG parent. The OSG inherits its basic qualities and data buckets from its parent. An OSG may also contain data buckets whose definition was derived (inherited) from an invention template specification (i.e. Maytag Dishwasher Model 216A) and may contain an arbitrary number of additional owner defined custom data buckets. The inherited qualities or buckets can each be deleted or modified at any time by the owner, they were inherited to assist in quickly defining the new OSG, they are not hard and fast. An OSG does not have to be unique. Part of the power of the invention queries comes from the fact that an OSG name does not have to be unique. Thus a reference to john.410.849.8989 will access both john's medical information as well as john's car and boat information.

OSG group ownership can be nested to an arbitrary depth. Each OSG group can own an arbitrary number of other OSG groups.

Group and Owner Relationships FIG. 46 diagrams the relationships between some of the various forms of the group type OS—Owner Subordinate and RM—Root Master etc. An OS group (OSG) is a collection of invention required and owner defined data buckets referenced by a unique handle. The uniqueness of a handle may be derived from qualifying it by its parent's handle. An OSG only need be unique within the realm of its immediate parent.

The unique OSG handles to the outside world in this diagram would be formed as police.410.849.8989 (or police.849.8989.410) which would provide access the overall state of the police OSG. The OSG fire and ems would be accessed from the outside world as fire.410.849.8989 or ems.410.849.8989 respectively. When logged into the Home Group 410.849.8989 (or 849.8989.410) there would be no need to include the Home Group in a reference to OSG police or to OSG fire or to OSG ems as these OS groups are all unique within the 410.849.8989 RMG.

Note that 410.849.8989 is a Root Master Group (RMG) which is in turn owned by 31168* invention which is the Super Master Group (SMG) which is part of the invention itself.

The primary concept to be grasped from this diagram is that of the Owner Subordinate Group (OSG) and its relationship to a Root Master Group (RMG). The OSG is an owner group used to contain much of the detailed data pertaining to a given class of owner information. A class of owner information might be police or fire or ems or any other information important to an owner.

The OSG is a branch, twig or leaf in the invention tree structure. For a typical invention user the OSG would probably hold detailed data about various items of importance to its RMG or OMG owner.

The OSG is the foundation of detail data storage for a given owner. The OSG contains the idiosyncratic information pertaining to various topics or devices of interest to the owner. In a RDBMS sense, the OSG is similar to a row in the database, however, unlike rows, one OSG can be nested inside another after another.

Any group created from or by an OSG will inherit the owner information (rules base, passwords etc.) contained in the creating OSG. This makes secondary or subordinate group creation faster, it also avoids the need to redundantly specify base owner information.

The ultimate OSG owner is either an RMG or an OMG. When an owner RMG, OMG or OSG (user/device) creates an OSG the OSG inherits its initial specifications from its owner. These inherited specifications save time in setting up an OSG and provide consistency of form within the invention.

An OSG will specify either an OMG or an RMG as its Home Group. A home group defines the basic invention rules of the road to all of its subordinate groups. An OMG or RMG also provides the point of reference within which abbreviations of OSG handles may be used.

An Owner Subordinate Group (OSG) is owned by an RMG, an OMG or another OSG parent. The OSG inherits its basic qualities and data buckets from its parent. An OSG may also contain data buckets whose definition was derived (inherited) from an invention template specification (i.e. Maytag Dishwasher Model 216A) and may contain an arbitrary number of additional owner defined custom data buckets. The inherited qualities or buckets can each be deleted or modified at any time by the owner, they were inherited to assist in quickly defining the new OSG, they are not hard and fast. An OSG does not have to be unique. Part of the power of the invention queries comes from the fact that an OSG name does not have to be unique. Thus a reference to police.410.849.8989 will access the police information as well as the police incident, unit, command area, and officer subordinate group information.

OSG group ownership can be nested to an arbitrary depth. Each OSG group can own an arbitrary number of other OSG groups.

Group and Owner Relationships FIG. 47 diagrams the relationships between some of the various forms of the group type OS—Owner Subordinate. An OS group (OSG) is a collection of invention required and owner defined data buckets referenced by a unique handle. The uniqueness of a handle may be derived from qualifying it by its parent's handle. An OSG only need be unique within the realm of its immediate parent. The immediate parent OSG in this case is police.

The unique OSG handles to the outside world in this diagram would be formed as police.410.849.8989 (or police.849.8989.410) which would provide access the overall state of the police OSG. The OSG incident and unit would be accessed from the outside world as incident.410.849.8989 or unit.410.849.8989 respectively. When logged into the Home Group 410.849.8989 (or 849.8989.410) there would be no need to include the Home Group in a reference to OSG incident, OSG unit, OSG ems, OSG ca-north, OSG ca-south or OSG officer as these OS groups are all unique within the 410.849.8989 RMG.

The primary concept to be grasped from this diagram is that of the Owner Subordinate Group (OSG) and its relationship to assigned groups. The OSG is an owner group used to contain much of the detailed data pertaining to a given class of owner information. A class of owner information might be police incident, unit, command area or any other information important to an owner. The unit collection group called unit owns (and probably created) all of the handles pertaining to police units. The command area group ca-north contains information specific to this command area as well as the handles for all of the units assigned to this command area.

The OSG is a branch, twig or leaf in the invention tree structure. For a typical invention user the OSG would probably hold detailed data about various items of importance to its RMG or OMG owner.

The OSG is the foundation of detail data storage for a given owner. The OSG contains the idiosyncratic information pertaining to various topics or devices of interest to the owner. In a RDBMS sense, the OSG is similar to a row in the database, however, unlike rows, one OSG can be nested inside another after another.

Any group created from or by an OSG will inherit the owner information (rules base, passwords etc.) contained in the creating OSG. This makes secondary or subordinate group creation faster, it also avoids the need to redundantly specify base owner information.

The ultimate OSG owner is either an RMG or an OMG. When an owner RMG, OMG or OSG (user/device) creates an OSG the OSG inherits its initial specifications from its owner. These inherited specifications save time in setting up an OSG and provide consistency of form within the invention.

An OSG will specify either an OMG or an RMG as its Home Group. A home group defines the basic invention rules of the road to all of its subordinate groups. An OMG or RMG also provides the point of reference within which abbreviations of OSG handles may be used.

An Owner Subordinate Group (OSG) is owned by an RMG, an OMG or another OSG parent. The OSG inherits its basic qualities and data buckets from its parent. An OSG may also contain data buckets whose definition was derived (inherited) from an invention template specification (i.e. Police Incident Record Master 14) and may contain an arbitrary number of additional owner defined custom data buckets. The inherited qualities or buckets can each be deleted or modified at any time by the owner, they were inherited to assist in quickly defining the new OSG, they are not hard and fast. An OSG does not have to be unique. Part of the power of the invention queries comes from the fact that an OSG name does not have to be unique. Thus a reference to police.410.849.8989 will access the police information as well as the police incident, unit, command area, and officer subordinate group information.

OSG group ownership can be nested to an arbitrary depth. Each OSG group can own an arbitrary number of other OSG groups.

Group and Owner Relationships FIG. 48 diagrams the relationships between some of the various forms of the group type OS—Owner Subordinate and group type RM—Root Master. An OS group (OSG) is a collection of invention required and owner defined data buckets referenced by a unique handle. The uniqueness of a handle may be derived from qualifying it by its parent's handle. An OSG only need be unique within the realm of its immediate parent. The immediate parent OSG in this case is police.

The unique OSG handles to the outside world in this diagram would be formed as police.410.849.8989 (or police.849.8989.410) which would provide access the overall state of the police OSG. The OSG incident and unit would be accessed from the outside world as incident.410.849.8989 or unit.410.849.8989 respectively. When logged into the Home Group 410.849.8989 (or 849.8989.410) there would be no need to include the Home Group in a reference to OSG incident, OSG unit or OSG officer as these OS groups are all unique within the 410.849.8989 RMG.

The primary concept to be grasped from this diagram is that of the Owner Subordinate Group (OSG) and its relationship to assigned groups (including an assigned RMG). The OSG is an owner group used to contain much of the detailed data pertaining to a given class of owner information. A class of owner information might be a police incident, unit, officer or any other information important to an owner. The officer information collection group called officer owns (and probably created) all of the handles pertaining to police officer badge numbers. The officer group 10003 contains information specific to officer 10003 as well as indicating that the badge number (group handle) 10003 is also an alias for the officer's invention root master group handle of 410.212.1200.

The OSG is a branch, twig or leaf in the invention tree structure. For a typical invention user the OSG would probably hold detailed data about various items of importance to its RMG or OMG owner.

The OSG is the foundation of detail data storage for a given owner. The OSG contains the idiosyncratic information pertaining to various topics or devices of interest to the owner. In a RDBMS sense, the OSG is similar to a row in the database, however, unlike rows, one OSG can be nested inside another after another.

Any group created from or by an OSG will inherit the owner information (rules base, passwords etc.) contained in the creating OSG. This makes secondary or subordinate group creation faster, it also avoids the need to redundantly specify base owner information.

The ultimate OSG owner is either an RMG or an OMG. When an owner RMG, OMG or OSG (user/device) creates an OSG the OSG inherits its initial specifications from its owner. These inherited specifications save time in setting up an OSG and provide consistency of form within the invention.

An OSG will specify either an OMG or an RMG as its Home Group. A home group defines the basic invention rules of the road to all of its subordinate groups. An OMG or RMG also provides the point of reference within which abbreviations of OSG handles may be used.

An Owner Subordinate Group (OSG) is owned by an RMG, an OMG or another OSG parent. The OSG inherits its basic qualities and data buckets from its parent. An OSG may also contain data buckets whose definition was derived (inherited) from an invention template specification (i.e. Police Incident Record Master 14) and may contain an arbitrary number of additional owner defined custom data buckets. The inherited qualities or buckets can each be deleted or modified at any time by the owner, they were inherited to assist in quickly defining the new OSG, they are not hard and fast. An OSG does not have to be unique. Part of the power of the invention queries comes from the fact that an OSG name does not have to be unique. Thus a reference to police.410.849.8989 will access the police information as well as the police incident, unit, command area, and officer subordinate group information.

OSG group ownership can be nested to an arbitrary depth. Each OSG group can own an arbitrary number of other OSG groups.

Group and Owner Relationships FIG. 49 diagrams the relationships between some of the various forms of the group type OS—Owner Subordinate and group type RM—Root Master. An OS group (OSG) is a collection of invention required and owner defined data buckets referenced by a unique handle. The uniqueness of a handle may be derived from qualifying it by its parent's handle. An OSG only need be unique within the realm of its immediate parent. The immediate parent OSG in this case is police.

The unique OSG handles to the outside world in this diagram would be formed (fully qualified) as 1A12.unit.police.410.849.8989 (or 1A12.unit.police.849.8989.410) which would provide access to the overall state of the 1A12 OSG. The OSG 10001 and 10002 would be accessed from the outside world (fully qualified) as 10001.officer.police.410.849.8989 or 10002.officer.police.410.849.8989 respectively. When logged into the Home Group 410.849.8989 (or 849.8989.410) there would be no need to include the Home Group in a reference to OSG 1A12, OSG 10002 or OSG 10002 as these OS groups are all unique within the 410.849.8989 RMG.

The primary concept to be grasped from this diagram is that of the Owner Subordinate Group (OSG) and its relationship to assigned (internal OSG) groups and assigned group relationship to (external RMG) alias named groups. The OSG is an owner group used to contain much of the detailed data pertaining to a given class of owner information. A class of owner information might be a police unit, the officer(s) assigned thereto or any other information important to an owner. The officer information collection group called officer owns (and probably created) all of the handles pertaining to police officer badge numbers. The officer group 10001 contains information specific to officer 10001 as well as indicating that the badge number (group handle) 10001 also is an alias for the officer's invention root master group handle of 410.212.1015. The officer group 10002 contains information specific to officer 10002 as well as indicating that the badge number (group handle) 10002 also is an alias for the officer's invention root master group handle of 410.263.1228.

Even if the officer with badge number 10001 is away from her radio she can still be contacted 24 hours a day by sending the message to her badge number 10001 which the invention will in turn realize is an alias for her primary RMG handle of 410.212.1015. The invention will look up the RMG handle 410.212.1015 to further determine the very best method(s) by which to get the message through to the device most suitable and active at this moment associated with woman known by her badge number 10001.

The OSG is a branch, twig or leaf in the invention tree structure. For a typical invention user the OSG would probably hold detailed data about various items of importance to its RMG or OMG owner.

The OSG is the foundation of detail data storage for a given owner. The OSG contains the idiosyncratic information pertaining to various topics or devices of interest to the owner. In a RDBMS sense, the OSG is similar to a row in the database, however, unlike rows, one OSG can be nested inside another after another.

Any group created from or by an OSG will inherit the owner information (rules base, passwords etc.) contained in the creating OSG. This makes secondary or subordinate group creation faster, it also avoids the need to redundantly specify base owner information.

The ultimate OSG owner is either an RMG or an OMG. When an owner RMG, OMG or OSG (user/device) creates an OSG the OSG inherits its initial specifications from its owner. These inherited specifications save time in setting up an OSG and provide consistency of form within the invention.

An OSG will specify either an OMG or an RMG as its Home Group. A home group defines the basic invention rules of the road to all of its subordinate groups. An OMG or RMG also provides the point of reference within which abbreviations of OSG handles may be used.

An Owner Subordinate Group (OSG) is owned by an RMG, an OMG or another OSG parent. The OSG inherits its basic qualities and data buckets from its parent. An OSG may also contain data buckets whose definition was derived (inherited) from an invention template specification (i.e. Police Incident Record Master 14) and may contain an arbitrary number of additional owner defined custom data buckets. The inherited qualities or buckets can each be deleted or modified at any time by the owner, they were inherited to assist in quickly defining the new OSG, they are not hard and fast. An OSG does not have to be unique. Part of the power of the invention queries comes from the fact that an OSG name does not have to be unique. Thus a reference to police.410.849.8989 will access the police information as well as the police incident, unit, command area, and officer subordinate group information.

OSG group ownership can be nested to an arbitrary depth. Each OSG group can own an arbitrary number of other OSG groups.

Group and Owner Relationships FIG. 50 diagrams the relationships between some of the various forms of the group type OS—Owner Subordinate and group type RM—Root Master. An OS group (OSG) is a collection of invention required and owner defined data buckets referenced by a unique handle. The uniqueness of a handle may be derived from qualifying it by its parent's handle. An OSG only need be unique within the realm of its immediate parent. The immediate parent OSG in this case is police.

The unique OSG handles to the outside world in this diagram would be formed (fully qualified) as 1A12.unit.police.410.849.8989 (or 1A12.unit.police.849.8989.410) which would provide access to the overall state of the 1A12 OSG. The OSG 10001 and 10002 would be accessed from the outside world (fully qualified) as 10001.officer.police.410.849.8989 or 10002.officer.police.410.849.8989 respectively. When logged into the Home Group 410.849.8989 (or 849.8989.410) there would be no need to include the Home Group in a reference to OSG 1A12, OSG 10002 or OSG 10002 as these OS groups are all unique within the 410.849.8989 RMG.

The primary concept to be grasped from this diagram is that of the Owner Subordinate Group (OSG) and its relationship to assigned (internal OSG) groups and assigned group relationship to (external RMG) alias named groups. The OSG is an owner group used to contain much of the detailed data pertaining to a given class of owner information. A class of owner information might be a police unit, the officer(s) assigned thereto or any other information important to an owner. The officer information collection group called officer owns (and probably created) all of the handles pertaining to police officer badge numbers. The officer group 10001 contains information specific to officer 10001 as well as indicating that the badge number (group handle) 10001 also is an alias for the officer's invention root master group handle of 410.212.1015. The officer group 10002 contains information specific to officer 10002 as well as indicating that the badge number (group handle) 10002 also is an alias for the officer's invention root master group handle of 410.263.1228.

Even if the officer with badge number 10001 is away from her radio she can still be contacted 24 hours a day by sending the message to her unit 1A12 or badge number 10001 which the invention will in turn realize is an alias for her primary RMG handle of 410.212.1015. The invention will look up the RMG handle 410.212.1015 to further determine the very best method(s) by which to get the message through to the device most suitable and active at this moment associated with woman known by her badge number 10001.

An citizen message could also be sent to rd01.district.police.410.849.8989 which would then find its way to who ever is on duty for that district according to what beat or station zone it currently falls under.

The OSG is a branch, twig or leaf in the invention tree structure. For a typical invention user the OSG would probably hold detailed data about various items of importance to its RMG or OMG owner.

The OSG is the foundation of detail data storage for a given owner. The OSG contains the idiosyncratic information pertaining to various topics or devices of interest to the owner. In a RDBMS sense, the OSG is similar to a row in the database, however, unlike rows, one OSG can be nested inside another after another.

Any group created from or by an OSG will inherit the owner information (rules base, passwords etc.) contained in the creating OSG. This makes secondary or subordinate group creation faster, it also avoids the need to redundantly specify base owner information.

The ultimate OSG owner is either an RMG or an OMG. When an owner RMG, OMG or OSG (user/device) creates an OSG the OSG inherits its initial specifications from its owner. These inherited specifications save time in setting up an OSG and provide consistency of form within the invention.

An OSG will specify either an OMG or an RMG as its Home Group. A home group defines the basic invention rules of the road to all of its subordinate groups. An OMG or RMG also provides the point of reference within which abbreviations of OSG handles may be used.

An Owner Subordinate Group (OSG) is owned by an RMG, an OMG or another OSG parent. The OSG inherits its basic qualities and data buckets from its parent. An OSG may also contain data buckets whose definition was derived (inherited) from an invention template specification (i.e. Police Incident Record Master 14) and may contain an arbitrary number of additional owner defined custom data buckets. The inherited qualities or buckets can each be deleted or modified at any time by the owner, they were inherited to assist in quickly defining the new OSG, they are not hard and fast. An OSG does not have to be unique. Part of the power of the invention queries comes from the fact that an OSG name does not have to be unique. Thus a reference to police.410.849.8989 will access the police information as well as the police incident, unit, command area, and officer subordinate group information.

OSG group ownership can be nested to an arbitrary depth. Each OSG group can own an arbitrary number of other OSG groups.

Definition of terms used during the description of FIGS. 40 through 50:

Data Bucket: a data item, array or blob of a defined or undefined type. A data bucket might also contain a pointer to another group. In conventional terms a data bucket could just be an Integer or String etc. Edit codes or invention script procedures may also be associated with a given data bucket.

Owner: the handle, which is the key to the group, which in turn owns the group in question. For an RMG that owner would be the invention itself.

Group: the handle to the group in question.

Alias for: if other than NONE it holds the handle of the actual real entity represented by the group handle. The purpose of an alias is to allow for the invention RMG and OMG entities to have more appropriate or meaningful names within the context of a given work assignment or project. For instance the RMG handle 410.849.8989 (John Goodspeed) might also be known to some other project group context as president or team-lead etc. Through the use of the alias an RMG or OMG can have several different simultaneous group names used in different contexts within other RMG or OMG realms.

Invention Data: data buckets that are required by and/or provided by the invention. These might include specific device information, owner information etc. The RMG owner provides some of this information to any created group.

Template Data: data buckets selected by the owner from an invention sample template. The invention has default data bucket templates for many types of applications and purposes. Some of the templates are device specific and are supplied to the invention by manufacturers.

Extensible Data: custom data buckets contained in a group as defined by the group owner. Data types and edits supported include all major types such as alpha, numeric, binary etc.

Type: a code describing the type of group that this group is modeled after such as RM, OM, OS etc. The type guides the invention in the appropriate processing of the data contained within the group and its offspring.

Groups Owned: indicates the groups that are owned by this group. A group can create and therefore own from zero up to an arbitrary number of groups.

Groups Assigned: indicates what other independent groups have been assigned by the owner of this group to belong to this group. These groups are not owned in any way. These groups are merely associated by this owner for management convenience.

Home Group: the home group is the group whose rules base and abbreviation root shall apply to this group. The Home Group can be temporarily overridden by the specification of a Visit Group.

Visit Group: the group whose rules base and abbreviation root shall apply to this group until notice of rescission. The Visit Group allows a group to temporarily take on certain characteristics of an RMG or OMG other than the default Home Group. The Visit Group does not even have to be this RMG or one of its descendents. The Visit Group could be some other RMG or one of its descendents (permissions permitting).

Any invention viewing user (in particular a secretary, manager or dispatcher) may define a custom display Status View. A Status View is a template describing to the invention what owners and group members will be displayed (what group handles and their members (and possibly nested group handles and their members)). How the group data is displayed such as how the groups are sorted, nested, ordered, indented and which data items of which groups are displayed and maximum nesting levels displayed. How the data items are displayed such as text in tabular format, graphic on a given type of map background, a combination etc. How often the status view display is to be automatically updated (every 15, 30, 60, 120 seconds etc.).

A given status view (text, map, audible etc.) is designed by the viewer to take in to account their particular need for information as constrained by the device upon which they are viewing the information display. For example a mobile device (PDA/PDC) has constraints that a fixed high-resolution 21″ display does not have. Regularly needed customized status views may be named, numbered and saved for recall and reuse later. The viewing user is able to build a library of pre-defined status views for any particular need or purpose. A status view may also be modified at a later date.

Once defined, the status views can also be available for text to speech audio delivery via the public switched telephone network. The user simply calls Up the predefined “viewing” template via DTMF or voice command and access code entry.

For example, a group might be all of ones immediate family members, this group might be named “smith”. A command (via pointing device, typed, DTMF or spoken as appropriate) “map smith” would display a map showing the most recent location and status of all members of the “smith” family grouping. It would do this by defaulting the “smith” group to the root subscriber phone number of the person entering the command, smith.410.849.8957 is an example URI (note here 8957 serves as the invention TLD).

A command (via pointing device, typed, spoken or DTMF as appropriate) “status smith” by Internet or telephone might yield the audible response “Charles Smith, customer site, proposal preparation, 2200 block Broad Street, Dallas Tex., time 12:35; John Smith, at school, Broad Creek High School, Baltimore Md., time 12:50; Jane Smith, at home, working, 724 Giddings Glade Court, Baltimore Md., time 12:15”.

Location, proximity, status, activity, condition, task and timer events and alerts may be automatically triggered to alert specific groups or multiple group members according to owner or group predefined parameters. User settable timers may be associated with a variety of status code, task type, task list, schedule or reminder (such as alarm clock) events. User or invention defined system, computer or device command executions may also be associated with and triggered by alerts and events.

A group can request the invention on its behalf to monitor another group's status code, task type, task lists, schedule and other items looking for a specific pattern occurrence or change or persistence over time. The invention will then alert the monitoring group of any pattern change or pattern match when it occurs. The group being monitored can be notified as to what group is monitoring.

Events and alerts within the invention may trigger the execution of invention programming language scripts composed of sequences of invention programming language instructions. The invention programming language definition and syntax allows for the real-time event driven testing of device status, monitoring of device data streams and control of device functions. The invention programming language contains a subset of the elements of traditional interpretive programming languages such as Perl or Basic but adds extensions to make easy the monitoring and control of real world physical devices such as PDA/PCD, kitchen appliances, equipment, vehicles, craft, machinery, environmental controls etc. The invention programming language enables intelligent inter-device feedback loops to be quickly constructed and saved for event driven recall as needed. The invention programming language allows enabled devices within the invention network to intelligently interact with one another based upon sensed conditions both from within or around the device and from other external device feedback elsewhere on the invention network.

Alerts consist of highlighted visual information on browser and applet displays, e-mail or other message type alerts to multiple parties and/or multiple e-mail or message addresses of the same party. Numeric pages, alphanumeric pages and voice or other audible alerts (such as “Distinctive Ring”) via Internet and traditional telephonic means. Commands may cause the execution of software or the direct or indirect real world control of a machine, system or device.

An alert may be generated or received due to a specific status change, task type and time, location change, condition change, location proximity, scheduled event, timer expiration, audio pattern recognition, video pattern recognition or other defined event, command execution or stimulus.

For instance if a device current location has come inside or gone outside of one of a set of pre-established bounds (possibly governed by a particular range of date and/or time of day) for the owner of the PCD or PDA an alert may be automatically generated. If a predefined friend or foe comes inside or goes outside of a preset distance (owner defined hot zone) the owner will be alerted as to their presence or absence and to their distance and direction relative to your position. For example this is useful for monitoring the activities of children, the infirm, friends and employees and for the enforcement of restraining orders, house arrest or work release. A given hot zone may be defined as circular or rectangular. Multiple hot zones may be defined. Multiple entities may be members of multiple and overlapping hot zones. Instant hot zones can be established to view all those invention members within a defined distance who possess (or lack) a particular special capability (disabled, iron lung, locksmith, tow truck, off duty officer, paramedic, linguist etc.). The invention can then link the capable party with the needy party if the identified capable party is willing to assist. A PDA/PCD equipped mass transit vehicle with specialized handicap or other capabilities could, for instance, trigger an alert to a passenger in need when it comes within 500 meters or within a 2 minute ETA of the monitoring passenger.

For instance, an alert can be generated if a device (possibly a PDA or PCD), either self initiated or in response to a listen or view command, yields audio or video information which is either generally similar to or dissimilar to a set of owner pre-stored audio or video image reference archives. The normal activity audio/video reference archives may be defined for location, date and time of day. This allows the invention to generate an alert and/or execute a command if for instance a pipe has burst or a baby is crying or if a light is on or if a boat or car is missing from, or is present in, its slip or parking space.

For instance if a (invention or self initiated) sense command yields information which either is generally similar to or is generally dissimilar to a set of owner pre-stored sense condition image archives for date and time of day an alert can be generated. This allows the invention to generate an alert and/or execute a command if gas is leaking, smoke or CO2 is present, the humidity or temperature is too high or low, a door or window is open or any other acceptable or unacceptable environmental or mechanical condition is present. For example, an alert may be generated if a medical condition (sense condition) such as brain activity, glucose level, heart rate, respiration or temperature is either too high or too low. For example, an alert may be generated if a mechanical condition (sense condition) such as oil pressure or coolant level or engine temperature is either too high or too low. Devices within the invention network can sense one another's conditions via execution of the invention programming language procedures. The invention programming language procedures can be automatically initiated upon the occurrence of an invention or user defined event or alert. Thus, if device 1 is sensing high CO2 levels, then device 2 (which is monitoring device 1) can cause additional ventilators to turn on.

The invention calls for high performance PDA/PCD's to have the ability to transmit their lat/lon/alt location coordinates, surrounding environmental readings and sense conditions along with their status/task update code whenever an invention defined status button is pressed or otherwise activated (Ex. voice or pointer) by the PDA/PCD user or by an internal timer. The coordinates shall also be optionally forwarded upon call placement or call reception. The PDA/PCD shall also allow the central invention computer network to dynamically query the PDA/PCD's coordinates, surrounding environmental readings and other sense conditions (audio/video/physical/medical etc.) at any time without need of owner interaction. The invention query of device or PDA/PCD coordinate/environment/sense/medical/mechanical/electronic etc. information can occur at any interval from between once every trillionth of a second to once per 24 hours or at certain times not at all depending upon invention and user need definitions. Additionally, a minimum of three unique physical or soft or voice input buttons that can be pre-programmed for a variety of owner status and task update functions including but not limited to:

Button 1 would, if used first and by itself with no further input for a predefined period of time, automatically transmit an owner predefined status and task code along with the current lat/lon/alt if appropriate and available (could be used for emergency situations). This button would also work under user predefined voice activation such as “Working” or “En Route” or “Here” or “HELP!”. If button 1 is used after button 2 or button 3 then button 1 would supply a predefined object or verb or remark indicator. Automatic dialing or connection to an appropriate network node will be performed as required to complete communication of the information.

Button 2 would automatically transmit the following single digit as a user defined status and/or task code. Thus with just two pushes up to 12 status and/or task codes could be transmitted to the invention system. The lat/lon/alt would be included with the transmission if appropriate and available. This button would also work under voice activation as “status 4” or “status 12”. The functions of button 2 could also be any invention or user predefined noun or verb to be used in conjunction with button 1 or 3. Automatic dialing or connection to an appropriate network node will be performed as required to complete communication of the information.

Button 3 would cause the presentation of a soft menu of user defined invention functions to be selected by point and select or voice. Alternatively, button 3 could be used in conjunction with button 1 or 2 to provide any invention or user predefined noun or verb. This button would also work under voice activation as appropriate. Where appropriate and when available the lat/lon/alt would be included in the transmission. Automatic dialing or connection to an appropriate network node will be performed as required to complete communication of the information.

Status and task codes may also be communicated to the invention by way of the particular tld specified. For example: 410.849.8989.gs would indicate “get status” (gs) of the owner of telephone number 410.849.8989. Example: runaway.mp3.849.8989.410.tf would indicate “transfer file” (tf) named “runaway.mp3” of the said telephone number owner to the issuer of the url command. Example: ?.mp3.849.8989.410.tf would indicate show me the index of all mp3 files available for transfer (tf=transfer file) from the said telephone number owner to the issuer of the URL/URL command.

Example URI/URL:

they lets talk>.ABC123.MD.411.ac

would indicate to open a high priority (!) communication channel performing an “information” 411 area code (ac) device lookup of the cell telephone or other appropriate available device of the occupant of the vehicle with the Maryland (MD) license plate tag ABC123 and send (>) the conversation opening message “hey lets talk” to the found associated telephone or device (FIGS. 34A and 34B).

Example URI/URL:

want to meet me>849-8989.410 sends the instant message “want to meet me” to the appropriate device of telephone number owner 410-849-8989 where 410 is the actual TLD. Example URI/URL.

meet me at the clubhouse>410.849.8989

sends the immediate message “meet me at the clubhouse” to the appropriate device of telephone number 410-849-8989 owner/subscriber where 8989 is the actual TLD (FIGS. 33A and 33B).

Example URI/URL:

!kingston proposal canceled>proposal.888.455.6000>silverado.877.323.3000.ac

sends the high priority (!) message “kingston proposal canceled” to all team members of the “proposal” group of the corporation who's phone number is 888.455.6000 and to all members of the “silverado” group at the corporation who's phone number is 877-323-3000.

Example: to add (+) the owner of telephone number 410.849.8989 to (>) the Tournament Charter (TC or tc) fishing group run by the owner of telephone number 410.268.7224 the entry of the URI/URL:

+4108498989>fishing.4102687224.0.tc

would immediately perform that add function without need of further user browser interaction (FIG. 38A).

Example: to remove (−) the owner of telephone number 410.849.8989 from (>) the Tournament Charter (TC or tc) fishing group run by the owner of telephone number 410.268.7224 the entry of the URI/URL:

−4108498989>fishing.4102687224.0.tc

would immediately perform that remove function without need of further user browser interaction (FIG. 38B).

If the owner has spent more than a predetermined amount of time in a particular status or task state an alert may be generated. If no change of status of any kind has occurred for more than a predetermined amount of time during a given time range of day, while on a particular task, an alert may also be generated.

A status could include, but is not limited to: at home, at office, at school, at hospital, at headquarters, at court, at home depot, working, injured, on break, eating, en route, departing, available, unavailable, do not disturb, thinking, researching, sleeping, fishing, planting, mixing, picking, delivering, receiving, panic/emergency. Status Codes and descriptions may be pre-defined by selection from an invention template and/or may also be defined by an owner. An owner created Status Code description such as “En Route” may have both a mnemonic and a numeric owner assigned value associated with it such as “ER” and “3” respectively. A status may have an invention or owner defined expiration or other alert timer associated with it.

A current or pending task type (internal or external or shared) could include but is not limited to: Proposal Preparation, Proposal Review, Proposal Shipping, Sales Appointment, Sales Closing, Marketing Strategy, Job Site Inspection, Trial Preparation, Court Appearance, Surgery, Concrete, Permit Application, Airport Pickup, I-Beam Erection, Concrete, Home Appraisal or Vacation. Task Type definitions may be defined by various means by the owner. Task Types may be pre-defined by selection from an invention template or may also be defined by an owner. A task type may be a web link. A task can be pending indefinitely or scheduled to issue a warning, execute a procedure or transition automatically at a predefined date and time (perhaps repetitively) or upon an event trigger. An owner created Task Type description such as “Sales Appointment” may have both a mnemonic and a numeric owner assigned value associated with it such as “SA” and “2” respectively. Related tasks may be grouped together into task lists (FIGS. 23 and 29). There is no arbitrary limit to the number of tasks that may be assigned to a group or the owner thereof. Specific tasks or entire task lists may be transferred or copied from one owner to another owner. Specific tasks or entire task lists may be deleted by their owner. A task transfer, copy or deletion may trigger an alert.

A task type may have an invention or owner defined expiration, time-of-day or other alert timer associated with it. A task type may be a specific owner or invention command (either direct or via URI/URL) to automatically do something at a particular (perhaps repetitive) time of day or upon satisfaction of a particular status code for a particular task. The task type command may cause an alteration of another task or status code (cascading command) or execution of a stored procedure or cause a real world action to occur such as turning on the house lights or sprinkler system or unlocking doors associated with a device or resource. Other examples include but are not limited to execution of a listen, view, sense, location, proximity, show, map or other command.

Group leaders (owners) can establish a rules base table for status and task types. The rules base table is optional but can be used to prevent or caution an owner from making a predefined rules “mistake”. For instance a rule could be established that a status of “at court” cannot be directly followed by a status of “fishing” without an intervening status of “departing”, “available”, “en route” etc. The rules base table can be created and applied to prevent or caution against any redundant or awkward status or task transition.

The Status Code and Task Type and their respective descriptions that are displayed when viewing an owner's status will be displayed as defined by that owner. If desired a translation can be made to conform and map other owners status and task information to that of the viewer.

A current or pending task description could include but is not limited to activities such as: 7:30 AM Breakfast meeting with new employees; 10:00 AM Appointment with doctor; Must pick up Bill's son after soccer practice; 7:00 PM Dinner with wife at The Palm in DC; A URL address. Descriptions may be short or long, they may help to clarify the status or task type.

A telephone number (or other related resource handle) record created within the invention automatically belongs to its creator who initially becomes its owner. An owner always belongs to at least one group. A group must always belong to at least one owner. A group is created when an owner initially creates a record for itself (that is to say, for one of its handles) within the invention system.

Every group (owner) can have an internal private task list, plus an external task list, plus a shared task list, plus as many group related task lists (internal or external or shared) as he or she is a group member (FIGS. 23, 25, 29 and 30). Each group that an owner becomes a member of can imply another set of available task lists for use by the owner and other member owners who belong to the same group. There is no arbitrary limit to the number of groups that an owner (group) may belong to simultaneously. There is no arbitrary limit to the number of groups that may be rolled up within one another as subgroups. There may be practical limits having to do with average Internet bandwidth and horsepower. Any limits will be table driven within the invention specification and extendible as technology permits.

An owner (group) automatically has the capability of an internal, external and shared task assignment list. A group (its owner and any other members) automatically has the capability of an internal, external and shared task assignment list. An owner is essentially a single member group of just his or her primary telephone number. A single member group has but one owner. The owner of a group is also by default its group leader. There is essentially very little difference between an owner and a group other than a group being an owner having granted the capability of having multiple members in addition to itself the Group Leader “owner”. An owner could create (and by default own) as many groups as he or she or it desires and there is no requirement that others ever join these groups, they could remain as single member/owner groups. Each instance of group creation yields the potential for an internal, external and shared task assignment list that can be private to members of that group or public depending upon the group leader's (owner's) decision. All groups are the management responsibility of an owner known as the Group Leader. Initially the creator of a group is its owner and therefore also its group leader. A group leader can hand off or share its group leader (ownership/management) responsibility to or with another member owner at any time assuming that the new prospective member owner is willing to accept or share the role. A group leader could be an executing computer process or intelligent device as opposed to a human being.

The owner (group) data record has the capability to become a personal information master record. This same record can then be used as the root node descriptor for any future created groups of this owner. In other words when an owner creates a new group that new group can inherit a copy of the owners personal information and design specification record, however the group leader (owner) is always free to modify that personal data or the group specifications at any time. When a group is created it starts out marked as private to its owner subject to the owner's creation of specific public and/or private accessible data layer security definitions. An owner is automatically the group leader of their initially created, single member, private group. The owner, as the group leader of their own group, can re-assign ownership (group leadership) to someone else. The core concept is that a group looks like, and behaves like, and is created just like any human owner record. In fact, a “public” group record is simply an ordinary owner (group) record to which other members (including other entire groups) are authorized to “belong”. A personal owner record is a group record that is marked as “private” to just its owner creator member, it becomes a “public” group record when the owner creator, or a newly assigned group leader, sets the flag indicating that the group is now “public”. Setting the public flag on a group allows it to theoretically accept the joining in of other groups be they single member (owner only) or multi-member (owner (group leader) plus other members or groups). The owner can continue control over whether or not other groups may join the owner's group even after the group is marked theoretically “public”. A group leader can force out any groups (be they single or multi member) it chooses to. There is no arbitrary maximum to the number of nested groups or members to a group and a given member or group can be a member of multiple other groups.

Groups feature owner defined data extensibility at the “owner”/“group” node level which allows a group leader (owner) to define or change the quantity, type, size, security and other specifications of data items that are stored and available for display and update. Security level permissions cover members within the group and also non-member view and update capabilities worldwide.

Groups support the concept of global and specific tasks and task creators. A specific task is assigned to just one member (or to a few) of a multi-member group and, subject to security, is only visible, updateable and can be deleted only by that specific group member and/or the task's creator. A global task is by default assigned to all member groups of the group and is visible and modifiable by all members of the group, however, subject to security, a global task can only be deleted by its creator.

The invention can produce both personal and project schedule and appointment calendars using real-time filters to show all tasks for all groups both internal, external and shared or any particular subset thereof together with highlights of conflicts. The invention also supports the uploading and importation of project schedule and task distribution information from external project management software such as Microsoft Project®.

Outside parties (human, biological or electronic) can create groups on behalf of other owners and/or add themselves to a group's external or shared task lists. An external (or shared) task list is typically made up of tasks or items that other people or resources are going to inform you of or perform on you or for you or upon something that you own or control or have responsibility for or an interest in. Examples of outside parties which might have reason to create a group for you and/or add an item to one of your external or shared task lists are personal and mass transportation companies, delivery and courier companies, repair and installation companies, contractors, doctors, dentists, banks, brokers, garages, manufacturers, vendors, warehouses, online and retail stores, managers, customers, coworkers and devices just to name a few.

An owner consults with their internal or shared task list(s) to see what task next needs to be performed as defined by themselves and/or a group (company, civic, church etc.) to which they belong. An owner consults with their external or shared task list(s) (FIG. 25) to see what others are scheduled to do next that may impact other external tasks, the owner or the owner's ability to carry out his or her or its internal or shared tasks. Example external tasks worth knowing the status and current location of might include an airplane/ship/train/bus/vehicle as to departure/enroute/arrival, car repair, pending delivery of critical item, restocking of critical item, the depletion of critical item, pizza delivery, installation of a new telephone line, dishwasher repair appointment, availability of a previously requested item or time slot. The invention allows businesses, professionals and others to manage themselves within the invention using task list(s) internal to themselves. They can then automatically link elements of their internal or shared task list(s) to other entities shared or external task list(s). This allows a device, person, service, business or professional practice etc. to keep you informed up to the minute as to their progress, condition and likely Estimated Time of Arrival or Availability (ETA) or Estimated Time of Completion (ETC).

For example an owner might check his or her or its external task list(s) to see if their doctor or dentist is running significantly behind schedule, in which case the owner might re-prioritize their internal task list to take advantage of the external schedule slippage. For example an owner might check his or her or its external task list to see if the telephone line or cable TV installation person or dishwasher repair person is ahead of or behind schedule and then adjust their personal internal or shared task list(s) accordingly. For example is the courier or package delivery or supply company on the way yet? How many stops are they making along the way and what stop number am I? How far away are they at this moment? As of this moment what is their anticipated ETA?

For example a home protection alarm system might automatically generate an external task on the local public safety department's E911 system external task list when a fire or breakin occurs, when a panic button is pressed, or when a PDA/PCD sensed restraining order violation, medical emegency or panic condition exists. The local public safety agencies can ask the invention to monitor the entire metropolitan area “group” for the occurrence of any unusual events and upon an event occurrence the invention can notify the appropriate dispatchers, officers, firefirghters or EMT's directly without need of an intermediate complaint taker. Example citizen URI/URL as entered at the public safety department:

security.410.849.2052.911.ac

or

medical.410.849.2052.911.ac

catherine.medical.410.849.2052.911.ac

john.medical.410.849.2052.911.ac

or

floorplans.410.849.2052.911.ac

or

hazards.410.849.2052.911.ac

or

priorvisits.410.849.2052.911.ac

The telephone number 410.849.2052 is in fact just a group within the public safety E911 realm, within its group are the sub-groups: security, medical, floorplans and hazards. Some of the information in these sub groups is maintained by the telephone number subscriber (such as family member medical conditions and allergies, the floorplans and any hazard warnings) and some is maintained by the public safety agency (such as reasons and outcomes of prior visits).

External and shared task assignments can go through status and location changes just as internal task assignments do. This means that the owner is free to schedule alert notifications to be automatically generated upon external status or external task changes or upon sudden conflict of an external or shared task list item with another external, internal or shared task list item or upon a given physical proximity of those performing the external or shared task. Therefore if the doctor or dentist office updates your external task list indicating it is running more than say 15 minutes behind you might automatically generate an alert to yourself. If the scheduled dishwasher repair person is suddenly detected within 200 meters of your house an hour ahead of posted schedule and you are alerted to this fact, you may not leave the house to run a planned errand at this time.

With this invention, if you know a telephone number, you have the immediate ability to access the telephone number's owner's status, activity, task, location, subgroup and other information and, subject to security constraints, update the status, pending internal/external/shared task list(s), leave remarks or create new groups and information. This is accomplished via any form of Internet browser, or via a custom designed Internet applet (i.e. computer telephony caller-ID applet), or via any form of Internet e-mail or electronic messaging. By calling a toll or toll free number and entering the DTMF tones for the telephone number to be queried or updated followed by the appropriate invention DTMF commands in response to prompts. Any query, update or creation will be subject to security constraints that the telephone number's owner/subscriber may have in place.

To facilitate those who must continuously and immediately maintain the status and task information of others such as secretaries and dispatchers the invention system features an adjustable multi-line command input applet. The applet allows for more efficient command and message entry than the URI/URL address line entry method (which is excellent for occasional use). This optimized applet shows the history of previously entered status and task update command lines and allows for the editing and/or reuse of any of these command lines to save time on typing. In addition this applet allows for the swapping of subject/verb order and automatic command line completion based upon historic keystroke and command entry analysis. Upon error detection the applet will position the cursor directly upon the character within the command line item most likely causing the error condition. This allows the user to make an immediate spot correction to the command line and to thus resubmit the command line with minimum keystrokes and maximum speed. The applet allows for simultaneous pointing or voice control of the command line while still maintaining the ability to mention the status/task condition (verb) either before or after the entry of the handle (subject).

A set of Internet and directly interconnected mobile, home, local, regional and central computers and associated attached distributed databases maintain for each telephone number or related handle the current and historical data sets. The status and remarks, previous status and remarks, current and pending task assignment list(s) and schedules, current task type, task anticipated/actual start/finish, task duration and milestones, task deadlines, constraints and dependencies, current and historical location information, timers, event triggers, security information as well as other pertinent handle information. Other such pertinent handle information would include, but is not limited to name, permanent address, permanent time zone, owner special medical conditions, owner primary care physician, blood type, drug, food, insect and other allergies, special capabilities (doctor/EMT/officer/tow/language etc.), owner usage customizations and preferences, custom data entry and storage field definitions, rules base, other related telephone numbers and their primary purpose and/or contact priority, current location, estimated time of departure, next location, estimated time of arrival, estimated current speed, final location, estimated time of arrival, estimated current speed, waypoint averages, statistical accumulations, time stamps for all status and location changes, related web site links, automated 3^{rd} party contact upon specific status change lists.

The invention maintains an audit trail of the most recent transactions processed against any of the owner's devices. For example the viewers of one's public and private information layers. This is maintained within the owner's owner history records (similar to a caller ID log). If the owner ever sees an audit trail ID (handle) of someone unknown either viewing or performing an update, the password has been compromised for that security level/layer, thus the owner has reason to change their password for that viewing/updating access level.

Actual telephone number theft or loss of telephone number access passwords can be fixed by the telephone number owner by using the telephone in question to call a special invention setup number whereby the invention can detect the Caller-ID number of the telephone. If the Caller-ID fails to detect the number, the invention can be asked via voice or DTMF command to call back the device on a number given by voice or DTMF. In either case, the owner can then set a new telephone number group password via DTMF or voice command. This new password will then also be usable via the Internet.

The owner of a telephone number handle can cause the invention to make available to public safety agencies their current location/direction, location/direction history, medical and other vital welfare information whenever they dial 911. In addition an owner can make all of their vital information available to public safety agencies via the .911.tld (where the .tld is any (optional) top-level domain) system. For example the health and safety information associated with telephone 410.555.1212 entered as 410.555.1212.911.tld would be accessible only to public safety agencies and the telephone/PDA/PCD owner and would contain telephone owner or business supplied information to aid police, fire and EMS in assisting an emergency call. Any telephone number prefixing .911.tld will bring up that telephone's associated safety information database, augmented by current PDA/PCD location, if it exists. Each and every telephone owner and real estate owner will be encouraged to populate this database, including items such as owner pictures, physical characteristics, building and land characteristics, building access and floor plans, hazardous materials, stand pipes, hydrant, water sources (pools, ponds, streams etc.), medical and disability information. A universal public safety Computer-Aided Dispatch (CAD) interface will be provided however, no special CAD interface is required. With this invention any Internet browser will accept a telephone number or other handle with .911 appended such as 410.555.1212.911.tld(.tld is any optional top level domain) as a single step direct emergency information retrieval browser address. Since the domain is purely numeric and requires no initial form download and subsequent submittal, access is very quick even from a PDA/PCD. The physical building or site characteristics and its content (safety/hazard) related information may be that which best matches the most current physical location of the PDA/PCD at the time it was used as a key to access the .911.tld database. Thus, even a stranger to an area may call 911 and because of the coordinate transmission the public safety agency will be able to access the pertinent 911.tld sub-group information due to the inventions ability to cross reference addresses to telephone numbers.

This invention also allows members to publish any (or all) of their telephone numbers or related handles as their primary electronic messaging or e-mail address or addresses. Others worldwide could then e-mail a message directly to them by simply knowing any one of the telephone numbers or handles of the recipient. There would be no need to call their number to get their e-mail address, instead, you would simply e-mail directly to any one of their known telephone numbers. You do not have to know which particular number is best to e-mail to at a particular time of day because the invention will take care of that detail for you automatically.

If the recipient is not yet an invention member they will receive a voice call from the invention on the telephone number to which the e-mail was sent. The voice call from the invention will ask the owner of the number to please join the invention now and get their waiting e-mail and any attachments thereto.

If you knew that John Doe's home telephone number was 800.555.1212 you could simply send your e-mail to 800.555.1212 or 800-555-1212 (see Table 1) instead of to the vanity address JohnDoe63@transco.com which is much harder to have to remember. With this invention, if you know a telephone number, any telephone number, you automatically know the electronic contact address.

The invention allows users with multiple telephone numbers to associate their telephone numbers and handles with one another such that a message sent to any one of the associated handles can be automatically forwarded to any one or more of the associated telephone numbers or handles (FIG. 39). The message will be reformatted as needed to become compatible with the device to which it is being forwarded. The message can be automatically examined by owner defined table driven rules based procedures for content type and specific contents and reformatted, split apart and/or re-routed as specified. Alerts can be generated based upon the results of automated examination. The user who owns the associated handles can change the way in which a message to any one of their handles is routed to other electronic addresses. Those addresses can be telephone numbers, handles, vanity e-mail addresses, ICQ/AOL instant message addresses or any other common form of electronic high level communications address scheme. A copy of the e-mail is also made available in the inventions telephone number based e-mail system, thus a telephone number owner can retrieve any mail sent to their telephone number directly from any Internet browser.

The invention provides for a uniform method of contacting another person via various forms of electronic messaging using any of that person's assigned telephone numbers or handles. This allows users to keep some of their telephone numbers private while exposing other telephone numbers or handles to some of the public or to the public at large. A message sent to a publicly listed number can, at the owner's discretion, be forwarded on to a device that is associated with one of the owners private telephone numbers or handles (such as cellular telephone or PDA). The owner of the numbers can change the mapping criteria by which messages (all or of specific types or from particular persons or sources) to one telephone number get routed to another telephone number, handle or messaging system as often as they like. The mapping criteria are programmatic procedures that are guided by rules and values tables created by the owner to be tested against message types and contents as they are received by the invention.

The invention allows for recipient users to specify sifting, filtering and prioritization and connection routing to incoming messages. The owner may specify that certain message types or real time communications from certain known users or with certain key contents may be routed and/or duplicated and/or transformed one way while messages of another type or from certain other users be routed and processed a different way (perhaps even discarded).

The invention keeps track of the location and type of device that is associated with each telephone number. It knows the capabilities of each device based upon its type and will make the needed conversions to a message such that it can be routed from one device type (PC, laptop, fax, TV, PDA/PCD etc.) to another.

The invention tracks what device(s) the owner is using or what device(s) are preferably available from moment to moment. Therefore it can route (or re-route) real time message or interactive conversation traffic (voice/video/text) to the most capable device. Suppose a user is working at their home (or office) PC workstation and another Internet user wants to establish a real time Internet conversation (one to one or conference) with the home PC user's known PDA/PCD telephone number. The invention will automatically redirect the real time conversation (or conference) to take place upon the more comfortable, appropriate and cost effective PC workstation instead of on the PDA/PCD. The invention allows the remote user the simplicity of initiating the communication using any known telephone number of the intended recipient(s). The invention then takes care of the real time details of connecting the communication to the most appropriate recipient party device at any given moment in time. Any unique recipient owner handle (such as a telephone number, vehicle license tag number (FIGS. 34A and 34B) (useful car to car) or other handle) can initiate a communication either one to one or conference.

Once a message is received at one of the target numbers and reviewed by the recipient it can then be deleted such that any of the other copies of the message that were forwarded to any of the recipient's other numbers or e-mail accounts are automatically deleted as well. This automatic deletion feature is important so as to prevent owners from having to read the same message redundantly upon multiple vanity address e-mail servers. This is accomplished via computer to computer and inter-device message management command language SMTP, POP and IMAP protocols.

All messages passing through the inventions regionally distributed central processing facilities may be encrypted and are stamped with a serial number, date and time such that they can be authenticated later. The messages can also be verified through a certificate authority, PGP or personal finger/voice/retina print. This serialization and certification of messages allows users to have a very high degree of confidence that a message originated within the invention system and received through the invention system is valid and is not SPAM in that the sender is also a known and verified invention address. The serial number would be difficult to fake from outside the invention system.

Depending upon the e-mail system being used by the sender (i.e. Microsoft Outlook, Netscape Communicator, AOL, custom mailer or some type of Personal Digital Assistant (PDA) or Personal Communications Device (PCD)) the sender would enter the target recipient's e-mail address in any one of the forms listed in Table 1.

All of the invention technologies apply to private and public 2^{nd}, 3^{rd}, 4^{th}, 5^{th} and Nth level domains in addition to gTLD's and ccTLD's (tld's). Thus any of the formats shown in Table 1 could substitute a private or corporate tld plus 2^{nd} and/or 3^{rd} level domain in the Uniform Resource Identifier for the “zzz” tld symbolic placeholder. Example: Hewlett-Packard is hp.com therefore:

$I need a printer>415.555.1212.hp.com would be a valid message forwarding address that would be processed by the invention. This allows corporations to outsource the invention's powerful capabilities while still controlling the look and feel of the invention services.

Table 1 lists various forms of acceptable telephone number or handle entry. The reason for the many different telephone number and handle address formats listed in Table 1 is to give examples of most of the likely ways that a person might enter a telephone number (North American (NANC/NANPA) or international) or other related handle. The additional special characters that may prefix or suffix a telephone number or handle are shorthand invention commands. These commands are used to convey command and control information to the invention itself, the regional and central computers, the network routing equipment and end user devices. An example of a command would be a command character indicating that the data following the command is not a North American or international telephone number but rather some other form or class of handle. Refer to the drawings for some actual examples of some these URL web and URI e-mail telephone number format inventions in actual use.

TABLE 1

| | |
|---|---|
| 8005551212xeeee | 800@555.1212xeeee.zzz |
| \800\555\1212\xeeee\ | 800@555-12l2xeeee.zzz |
| 800.555.1212xeeee | 800.555@1212xeeee.zzz |
| 800-555-1212xeeee | 800-555@1212xeeee.zzz |
| (800)555-1212xeeee | 8005551212xeeee@100.zzz |
| (800)555.1212xeeee | 800-555-1212xeeee@100.zzz |
| (800)s555-1212xeeee | 800.555.1212xeeee@100.zzz |
| (800)s555.1212xeeee | 8005551212xeeee.100.zzz |
| 5551212800xeeee | 800-555-1212xeeee.100.zzz |
| \555\1212\800\xeeee\ | 800.555.1212xeeee.100.zzz |
| 555.1212.800xeeee | 8005551212xeeee.411.zzz |
| 555-1212-800xeeee | 800.555.1212xeeee.411.zzz |
| 555@1212.800xeeee | 800-555-l2l2xeeee.411.zzz |
| 555@1212-800xeeee | john.q.public.411.zzz |
| 555.1212@800xeeee | \meet\us\in\lobby.849.8989.410.zzz |
| 555-1212@800xeeee | \i\am\late\soccer.8498989.410 |
| 800@555.1212xeeee | \game\called\off\soccer.8498989.410 |
| 800@555-1212xeeee | \i\am\late\soccer.410.849.8989.zzz |
| 800.555@1212xeeee | \i\am\late\4\soccer.410.849.8989 |
| 800-555@1212xeeee | \cancel\titan\proposal.4108498989 |
| 800.555.1212xeeee.zzz | \4l08498989\tball.4108492004.0.zzz |
| 800-555-1212xeeee.zzz | \i\need\help\800\555\1212.ibm.com |
| (800)555-1212xeeee.zzz | john.q.public.411.XX.zzz |
| (800)555.1212xeeee.zzz | john.q.public.411.XX.ccccc.zzz |
| (800)s555-1212xeeee.zzz | 8005551212xeeee.911.zzz |
| (800)s555.1212xeeee.zzz | 800.555.1212xeeee.911.zzz |
| 555.1212.800xeeee.zzz | 800-555-1212xeeee.911.zzz |
| 555-1212-800xeeee.zzz | 555.1212.800.911.zzz |
| 555@1212.800xeeee.zzz | john.q.public.911.zzz |
| 555@1212-800xeeee.zzz | john.q.public.XX.911.zzz |
| 555.1212@800xeeee.zzz | john.q.public.XX.ccccc.911.zzz |
| 555-1212@800xeeee.zzz | john.q.public.yyy.zzz |
| | john.q.public.yyy.ccccc.zzz |
| | n.n.n.n.100.zzz |
| | n.n.n.n.n.100.zzz |
| | n.n.n.n.n.n.100.zzz |
| | an.n.nb |
| | an.n.n.nb |
| | an.n.n.n.nb |
| | an.n.n.n.n.nb |
| | an.n.n.n.n.n.nb |
| | amb |
| | am\mb |
| | am\m\mb |
| | am\m\m\mb |
| | am\m\m\m\mb |
| | am\m\m\m\m\mb |
| | am\m\m\m\m\m\mb |
| | am\m\m\m\m\m\m\mb |
| | am\m\m\m\m\m\m\m\mb |
| | am\m\m\m\m\m\m\m\m\mb |
| | am\m\m\m\m\m\m\m\m\m\mb |
| | am\m\m\m\m\m\m\m\m\m\m\mb |
| | am\m\m\m\m\m\m\m\m\m\m\m\mb |

Table 1 Definitions:
The “a” represents a quantity of none, 1 or 2 of space, period, comma, #,
*, @, !, $, %, \hat{ }, &, -, _, :, ;, <, >, |, “, ‘, ?, ˜, ′, {, }, [, ], =,
+, \, or /.
The “b” represents a quantity of none, 1 or 2 of space, period, comma, #,
*, @, !, $, %, \hat{ }, &, -, _, :, ;, <, >, |, “, ‘, ?, ˜, ′, {, }, [, ], =, +, \, or /.
The “n” represents a quantity of from 1 to 16 digits each digit ranging in
value from 0 through 9. The “m” represents a quantity of from 1 to 32
characters each character ranging in value from 0 through 9 or from
a through z or from A through Z.
The “\” represents a quantity of 0, 1 or 2 of space, period, comma, #,
*, @, !, $, %, \hat{ }, &, -, _, :, ;, <, >, |, “, ‘, ?, ˜, ′, {, }, [, ], =, +, \, or /.
The .zzz represents any 1 to 10 character Internet or Intranet Top Level
Domain (TLD or ccTLD) such as .com, .net, .org, .ac, .ca .0, .1, .33, .410,
.1212, .12345, .123456, .1234567, .12345678, .123456789, .1234567890
or any future TLD or ccTLD authorized by USDOC or ICANN or private
party TLD.
The 100 can be any 3 digit NANC/NANPA/invention defined area/
special/reserved code.
The 555 can be any 3 digit NANC/NANPA/invention defined
combination.
The 800 can be any 3 digit NANC/NANPA/invention defined
combination.
The 1212 can be any 4 digit combination.
The “s” represents a space or blank.
The “-”(dash), “.”(period), “@” and “( )” are literal.
Some or all of the listed table entries may be proceeded by optional
quantity from 0 to 4 of space, period, comma, #, *, @, !, $, %, \hat{ }, &, -,
_, :, ;, <, >, |, “, ‘, ?, ˜, ′, {, }, [, ], =, +,
\ or /, followed by an optional 1, 2, 3 or 4 character(s) each ranging from
0 to 9 or a to z or A to Z followed by a “-” (dash), “.” (period),
“(” (opening parenthesis) or space.
Some or all of the listed table entries may be succeeded by from 1 to 160
characters composed of any combination of a to z, A to Z, 0 to 9 or space,
period, comma, #, *, @, !, $, %, \hat{ }, &, -, _, :, ;, <, >, |, “, ‘, ?, ˜, ′, {, },
[, ], =, +, \, or /.
The john.q.public represents any person or business name whose
component parts (words) are delimited by period or comma with wildcard
search indicators #, @, !, $, %, ? each with meaning.
The “411”, “911” and “100” are literal. The “xx” or “ccccc” may come
before or after these.
The “yyy” represents any NANC/NANPA defined area code/special/
reserved code.
The “XX” represents an optional 2 or 3 character state/province/island/
country code.
The “ccccc” represents an optional 5 to 9 character postal code.
The “xeeee” represents an optional telephone number extension, x portion
may be “.” or “-” or “/” or “\” or “,” or “_” or “x”,
eeee portion may be any 1, 2, 3, 4 or 5 digit extension.
The use of the *, # , !, $, %, _, \, :, ;, <, >, |, “, ‘, ?, ˜, ′, {, }, [, ], =, +,
@, ( or ) as part of a browser URL address or e-mail address or
immediate/instant message address field is just one of the proprietary
aspects of this invention.
An optional http:// and/or www may be placed in front of a telephone
number URI/URL as a user comfort and early adoption familiarity option.
Anywhere that #or * or + characters are indicated as acceptable, so to is a
character from an international character set.

[image] [image] [image] [image] [image] [image] [image] [image] [image] [image] [image] [image] TABLE 3

410 (root-maryland)
212.9119 (John Goodspeed-cell)
242.4278 (John Stone)
247.2258 (Mike Bowen)
247.3227 (Skeet Mcgee)
258.2994 (Thad Malone)
263.6823 (Judy Brown)
288.2388 (Marlo Thomas)
342.2982 (Sugar Ray)
429.2432 (Margaret Thatcher)
638.8949 (Charlie Oak)
663.5339 (Wun Hunglo)
728.8284 (Simple Simon)
728.9294 (Betty Boop)
767.2984 (Paul Harvey)
832.4925 (Paul Williams)
842.2924 (Southpaw Johnny)
849.2002 (Edgar Kalb)
849.2788 (Bob Rider)
849.5263 (John Goodspeed-fax)
849.5264 (John Goodspeed-work)
849.5892 (Bob Blair)
849.8248 (Tunde Farrell)
849.8989 (John Goodspeed-home)
938.2949 (Ginger Rogers)
849.8989.410
212.9119.410
849.5263.410
849.5264.410
business
company
friends
bowling
sewing-circle
soccer
softball
business.849.8989.410
284.8299.301 (Laura Snodgrass)
627.2952.443 (Mike Johnson)
767.2984.410 (Paul Harvey)
mdnetwork.777.8484.800 (Business Associates International)
company.849.8989.410
employee.corporate.444.9494.800 (Iron Eagle Printing)
east
west
east.company.849.8989.410
284.4288.301 (Jason Matthews)
928.8248.443 (Shirley Temple)
west.company.849.8989.410
328.2829.415 (Tommy James)
248.2927.415 (James Jones)
482.9282.213 (Tammy Bakker)
829.3853.716 (Sally Sprite)
friends.849.8989.410
male
female
male.friends.849.8989.410
728.8284.410 (Simple Simon)
828.2592.443 (I. P. Daily)
mdsports.555.1212.800 (Sports Friends USA)
whitebook.212.9119.410 (John Goodspeed-cell)
female.friends.849.8989.410
334.9288.301 (Sally Struthers)
728.9294.410 (Betty Boop)
928.3925.443 (Phyllis Diller)
blackbook.212.9119.410 (John Goodspeed-cell)
bowling.849.8989.410
247.3227.410 (Skeet Mcgee)
258.2994.410 (Thad Malone)
342.2982.410 (Sugar Ray)
663.5339.410 (Wun Hunglo)
fridayteam.247.2258.410 (Mike Bowen)
sewing-circle.849.8989.410
334.9288.301 (Sally Struthers)
728.9294.410 (Betty Boop)
288.2388.410 (Marlo Thomas)
849.8248.410 (Tunde Farrell)
938.2949.410 (Ginger Rogers)
anne-arundel.thimbles.429.2432.410 (Margaret Thatcher)
soccer.849.8989.410
539.8277.301 (Mark Sedgewick)
638.8949.410 (Charlie Oak)
728.8284.410 (Simple Simon)
828.2592.443 (I. P. Daily)
softball.849.8989.410
842.2924.410 (Southpaw Johnny)
933.4928.443 (Mickey Mantel)
ballclub.242.4278.410 (John Stone)
ballclub.832.4925.410 (Paul Williams)
annapolis.mdsoftball.644.6464.800 (Softball USA)

What is claimed is:

1. A method of seeking, accessing or connecting to an object via the Internet comprising the steps of:
addressing the object by a telephone number known by the seeker to be related to the intended object;
using an Internet Uniform Resource Identifier (URI) or Uniform Resource Locator (URL) or other Resource Handle Identifier (RHI) compliant form of target object address where the highest level domain components (1^{st}, 2^{nd}, 3^{rd}, 4^{th}, 5^{th} level etc.) after the Top Level Domain (TLD) are comprised of telephone numbers and/or portions of telephone numbers and/or variations of telephone numbers;
using a telephone number including any or all of: a basic subscriber telephone number, national or international telephone number, extension, line number, exchange, area code, city code, local code, region code, country code, other code, custom prefix or suffix digits, delimiting characters, letters or special characters or characters of an international character set;
using a supported Top Level Domain (TLD) that is either a current TLD such as .com, .net, .org, .edu, .mil, .gov, .int, etc. or a future TLD such as .info, .pro, .museum, .biz etc. or a Country Code Top Level Domain (ccTLD) such as .us, .ca, .ac etc. or a custom TLD such as .X, .map, .enum, .e164, .0, .1 etc. or a TLD composed of a telephone number in its entirety or any specific portion thereof;
using a Domain Name System and Domain Name Server(s) (DNS) capable of translating and/or resolving any form of user submitted telephone number URI/URL/RHI into an actual or pseudo IP address;
using software in the form of applications or services capable of performing useful work with a resolved IP address such as standard message, e-mail, voice, video and multi-media software, web browsers, file sharing servers or any other software that would benefit from the conversion of a telephone number to an IP address.

2. A method of sending a message via the Internet to an Internet address associated with the intended recipient comprising the steps of.
sending a message to the intended recipient by addressing the message to a telephone number known by the sender to be related to the intended recipient;
using an Internet Uniform Resource Identifier (URI) or Uniform Resource Locator (URL) or other Resource Handle Identifier (RHI) compliant form of target message address where the highest level domain components (1^{st}, 2^{nd}, 3^{rd}, 4^{th}, 5^{th} level etc.) after the Top Level Domain (TLD) are comprised of telephone numbers and/or portions of telephone numbers and/or variations of telephone numbers;
using a telephone number including any or all of: a basic subscriber telephone number, national or international telephone number, extension, line number, exchange, area code, city code, local code, region code, country code, other code, custom prefix or suffix digits, delimiting characters, letters or special characters or characters of an international character set;
using a supported Top Level Domain (TLD) that is either a current TLD such as .com, .net, .org, .edu, .mil, .gov, .int, etc. or a future TLD such as .info, .pro, .museum, .biz etc. or a Country Code Top Level Domain (ccTLD) such as .us, ca, .ac etc. or a custom TLD such as .X, .map, .enum, .e164, .0, .1 etc. or a TLD composed of a telephone number in its entirety or any specific portion thereof;
using a Domain Name System and Domain Name Server(s) (DNS) capable of translating and/or resolving any form of user submitted telephone number URI/URL/RHI into an actual or pseudo IP address;
using software in the form of applications or services capable of performing useful work with a resolved IP address such as standard message, e-mail, voice, video and multi-media software, web browsers, file sharing servers or any other software that would benefit from the conversion of a telephone number to an IP address.

3. A method as in claim 2; wherein the message is a traditional Internet e-mail message.

4. A method as in claim 2; wherein the message is an instant or immediate message.

5. A method as in claim 2; wherein the Uniform Resource Identifier (URI) or Uniform Resource Locator (URL) or other Resource Handle Identifier (RHI) is comprised of a telephone number and/or other handle either symbolic of a telephone number and/or incorporating a portion of a telephone number and/or an identifying name or subgroup name or other entity handle at the telephone number location, and the component digits or natural conventional portions of the telephone number may be separated by, periods, dashes, at signs, international characters or other special purpose characters.

6. A method as in claim 5; wherein the telephone number is preceded by or followed by some arbitrary number letters and/or digits and/or special characters and/or international characters; and the characters preceding of following the telephone number may symbolically indicate direct (without need of filling out an interactive browser form) or indirect (requires an interactive browser form) actions to be taken against the included telephone number; and the characters preceding of following the telephone number may include an authorizing Personal Identification Number (PIN) and/or additional identification information.

7. A method as in claim 6; wherein the telephone number is being used as a direct e-mail (e-mail) source or destination address.

8. A method as in claim 6; wherein the telephone number is being used as a direct immediate message or instant message source or destination address.

9. A method as in claim 6; wherein the telephone number is being used as a direct web site retrieval address.

10. A method as in claim 6; wherein the telephone number is being used as a direct self contained URI/URL/RHI instant message or immediate message or web site message posting or bulletin board posting or e-mail destination address; and the message or e-mail is entered directly into the Internet web browser URI/URL address line as a single line entry of less than or equal to the maximum number of characters allowed by the application software.

11. A method as in claim 6; wherein the telephone number is being used as a direct self contained URI/URL/RHI instant message or immediate message or e-mail destination address; and the message or e-mail is entered directly into the Internet web browser or other application URI/URL address line as a single line entry of less than or equal to the maximum number of characters allowed by the application software.

12. A method as in claim 1; wherein the subscriber of a telephone number has the ability to establish one or more personal databases (objects) that can be made universally available by any telephone number subject to the security constraints imposed by the telephone number subscriber.

13. A method as in claim 1; wherein the subscriber of a telephone number has the ability to post and share one or more files or web pages (objects) that can be made universally available by any telephone number subject to the security constraints imposed by the telephone number subscriber.

14. A method as in claim 6; wherein the telephone number is being used as a direct self contained URI/URL/RHI command line for the purpose of directly or indirectly setting the activity and/or status of a telephone number or its owner or one of its member groups or member entities.

15. A method as in claim 6; wherein the telephone number is being used as a URI/URL/RHI for the purpose of directly or indirectly querying the activity and status of a telephone number or its owner or one of its member groups or member entities.

16. A master telephone number subscriber database comprising: all telephone numbers, name and address of telephone number subscribers, subscriber personal details, subscriber network access details, subscriber DTMF access and command entry definition details, subscriber voice activated access and command entry details, type of each telephone number (Ex. voice/fax/pager etc.), voice mail access pass codes, e-mail access pass codes, web access pass codes and other access permissions, grant lists and pass codes, associations between telephone numbers and subscribers, subscriber/device availability dates and times of day, subscriber assigned handles, subscriber billing, subscriber devices (Ex. PDA, pager, handheld computer, cellular/satellite/fixed telephone etc.), subscriber device locations, location details, subscriber locations, device query capabilities, device command capabilities, E164.ARPA compatible database records, command codes, group definitions, group members, group schedules, status history, location history, viewer history, update history, web page links, internal task lists and schedules, external task lists and schedules, personal calendars and schedules, status and activity codes and definitions, database individual element read/write security permission levels, grants and excludes, communication network owner/operator details, automatic message forwards, master status, activity and location code translation templates, subscriber status, activity and location translation templates, registered e-mail sources, trusted e-mail sources, subscribers blocked and/or allowed, subscriber rating within subscriber community, revelations, emergency contacts, E911 people guidance, E911 pet guidance, E911 personal property information, E911 real property information, E911 floor plans, E911 hazardous material information, subscriber special capabilities, subscriber vehicle and boat and plane information, watch lists, inform lists, device configurations, subscriber and device time zones, subscriber created extensible data sets; and any other relevant subscriber information.

17. A database as in claim 16, wherein the telephone number is the source, destination, root, object or key to or of all operations and every telephone number is associated with at least one subscriber and one device, perhaps more than one device, however not every device has an associated telephone number, thus telephone numbers are owned indirectly via the device when appropriate, an entire household of devices (Ex. tv's, stereo, microwave oven etc.) could own (be assigned to) a single telephone number.

18. A database as in claim 16, wherein identification handles are created by registered subscribers on behalf of devices, handles can give a device a personalized mnemonic touch, a device may be referenced by its handle by anyone on the Internet worldwide (subject to subscriber security constraints), a device can have more than one handle simultaneously. A device does not have to have a handle as it could be implicitly or explicitly associated with a telephone number. Ex: the handles “microwave” and “oven” might both be linked to the same physical device operating at a fixed residential telephone number location. The status display query URI/URL/RHI for this kitchen appliance would be microwave.410.849.8989.ac this would display the status of the specific kitchen device behind the handle “microwave” at the telephone number 410.849.8989 subscriber residence, alternatively the display query could have been oven.410.849.8989.ac and the same status/activity page would be displayed.

19. A database as in claim 16, wherein subscribers (telephone number owner/holder) control all devices and handles, all devices and handles must belong to a subscriber, only one subscriber can own a device or handle at any given instant, a subscriber may control many devices and handles simultaneously.

20. A database as in claim 16, wherein current device location, speed and direction are maintained and historically archived for subsequent retrieval and analysis.

21. A database as in claim 16, wherein is maintained a table of geographic location coordinates (LAT/LON) and their associated common everyday names (Ex. house/business name and address, road mile markers, intersections, parks, lakes, rivers, common place names etc.)

22. A database as in claim 16, wherein subscribers can create their own custom table of locations by LAT/LON vicinity and these locations can have custom subscriber designed impacts upon operations such as proximity alerts, command execution triggers, message generation, status/activity state changes etc. (Ex: office, home, beach house, club, retreat, mile marker, intersection etc.)

23. A database as in claim 16, wherein every “thing” or pseudo “thing”, which can set a status, have its status set or generate a status, be monitored or be commanded is a device; every device is unique, every device belongs to a subscriber, a device is generally associated with a subscriber location, location information can by dynamically updated by a location monitoring capable device. A device may be registered or unregistered. A registered device means that the device has been proven to exist and to belong to a known subscriber. (Ex: desk telephones, cell telephones, computers, pda, pcd, stoves, cars, furnaces, HVAC, microwaves, freezers, motors, health monitors etc.)

24. A database as in claim 16, wherein is a table noting when (date/time range) is a device available for receiving messages or commands and from whom is it willing (allowed subscribers/external entities) to receive messages or commands, temporary overrides are defined elsewhere.

25. A database as in claim 16, wherein details pertaining to what a device is capable of, what data can be queried of the device, what status conditions can it report. Ex: hvac system—what rooms are being heated or cooled—average usage—current temperature, stove with 4 or 6 burners—which are turned on/off, oven or freezer—temperature or home entertainment system—how many CD's are loaded, which one is currently playing.

26. A database as in claim 16, wherein details pertaining to what a device is capable of, what can device be commanded to perform, what status conditions can it report. Ex: hvac system—set rooms to be heated or cooled—min/max usage—set temperature, stove with 4 or 6 burners—turn right rear off and left front on, oven or freezer—set temperature and time to engage or home entertainment system—load a CD, start CD playing, stop CD playing if telephone rings.

27. A database as in claim 16, wherein is a table of the nouns, verbs and adjective subscriber defined command code language abbreviations and definitions. Some of these are shared universal templates available to be copied, privatized and then further customized by anyone anywhere.

28. A database as in claim 16, wherein groups are based at their core upon telephone numbers. Every group has a responsible subscriber/owner, the owner may be another group, groups can be nested n levels deep, a group can own multiple other groups, a group can be a member of multiple other groups, every telephone number is a group of at least one (itself) by default. Groups are ultimately treatable as lower level domains in a URI/URL/RHI format and are automatically relative to the operationally identical base TLD's .com, .net, .org, .ac, .vg, .tc, .tf, .pn, .ag etc. (at least one of these TLD's should always be up and operational for redundancy). We will not store the TLD as part of the group entry so as to have run time flexibility to migrate between TLD's or to have TLD's provide overarching shades of meaning or differentiation. In the group: rrburner.stove.appliance.house.849.8989.410 rrbumer (right rear burner) is a member of the stove group which is a member of the appliance group which is a member of the house group which is a member of the 849.8989.410 telephone number group. In addition, the stove group might also be a member of the maytag group. The 849.8989.410 entity is the root master group because it is a telephone number. The rrburner group is an owner subordinate group to the 849.8989.410 group.

29. A database as in claim 16, wherein the members of a group may be a mixture of devices and/or other entire groups (and any of their subordinate sub-groups)

30. A database as in claim 16, wherein tables will capture the status changes both of devices and of owners, an owner may have an overall status, however a subscriber owner's devices (stove, fridge, windows, doors) may be in many different status condition states simultaneously (Ex. on/off, open/closed, heating/cooling etc.) status change history tables are also maintained.

31. A database as in claim 16, wherein tables will capture the location changes of both devices and of owners, an owner may have a current location, however an owner's devices (Ex. pda, car, stove, cell telephone etc.) may be in many different geographic locations simultaneously, location history tables are also maintained.

32. A database as in claim 16, wherein an audit history table of who has viewed or attempted to view an owner's personal or public data is maintained, if view was from a unregistered user only the IP will be shown, also shown are registered users who tried to view data using an incorrect pin/password.

33. A database as in claim 16, wherein an audit history table of who has updated an owner's public or private data is maintained, if update was from an unregistered user only the IP will be shown, also shown is who tried to change data using an incorrect pin/password.

34. A database as in claim 16, wherein a table of web page links associated with an owner or telephone number is maintained, there may be several links associated with an owner or telephone number, a default public/private status condition and public/private personal information page may be associated with a subscriber telephone number.

35. A database as in claim 16, wherein is maintained a table containing personal internal task to-do list items pertaining to the telephone subscriber. Only the device/telephone number owner/subscriber can add to their Internal task to-do schedule list. The internal task list may be visible to both the subscriber and selected other parties subject to subscriber security settings.

36. A database as in claim 16, wherein is maintained a table containing personal external task to-do list items pertaining to the telephone subscriber. Generally, outsiders can append any message or schedule any task to any telephone number's external task list, in addition the owner can post an item here for the outside world to view, generally a task is something due in the next 24 hours, the owner can transfer an external task placed by another owner to his schedule calendar for a future date.

37. A database as in claim 16, wherein is maintained a calendar table where a subscriber's master schedules are kept, as these assignments draw near in time (˜24 hours) they are added to the task list (internal/external or both), others can attempt to add a schedule item to a subscriber (subject to security settings), first it will go to the subscriber's external task list, from there, if the subscriber approves, it may be transferred to the master schedule with confirmation back to the requester.

38. A database as in claim 16, wherein is maintained a table of status condition codes. By default, only a subscriber owned device can status its owner, however, an owner may want to allow others to status him with a specific status code (such as a dispatcher or family member) exceptions as to who can post a status can be defined per subscriber.

39. A database as in claim 16, wherein is maintained a table of public and private view and update security on a data element by data element basis per subscriber.

40. A database as in claim 16, wherein an owner may have up to five passwords for viewing and up to five passwords for performing updates. A password is associated with a security level, 0 is the most secure level and is reserved for system routines, and 7 is the least secure level and indicates general public access (non members) no password required. Level 6 is the default security level, makes items available to registered subscribers within the subscriber community, but not the general public. A level 6 can do all that a level 7 can, a level 5 all that levels 6 and 7 can, a 4 all that 5, 6 and 7 can etc. Passwords for a given level (from 1 to 6) can be the same or different for viewing and updating permissions.

41. A database as in claim 16, wherein a table is maintained of the actual corporations responsible for operating specific landline and/or RF networks and their associated rules and usage templates for e-mail and instant messaging formats.

42. A database as in claim 16, wherein a table defines the rules for message forwarding, a given message from a given source address will be forwarded to a given destination address based upon these forwarding rules, the rules include days of the week and times of day.

43. A database as in claim 16, wherein is maintained a table of e-mail addresses that are known to belong to registered users in as much as they were provided by registered subscribers themselves. To be a registered subscriber, must have received a valid Caller-ID ANI identification and PIN registration from at least one device belonging to a subscriber. Alternatively the subscriber can fax a billing statement and PIN for a device in question to complete the registration. The more devices the subscriber has registered the higher the confidence rating for a subscriber will be. Other members can use this confidence rating to make decisions about their willingness to converse. Negative feedback about a subscriber will also be tracked and can be used by other members to make transaction decisions.

44. A database as in claim 16, wherein is maintained a table of source subscribers from which this target subscriber does or does not wish to receive e-mail, instant messages, alerts or from which this owner does not want status, schedule and external task list items initiated, this can be recipient device specific so as to allow receipt of message to the home telephone number account but not to the PDA or cellular telephone number e-mail account or to the subscriber's external task list.

45. A database as in claim 16, wherein is maintained a table of ratings that subscriber community members bestow upon one another, there is no limit to the number of ratings that an individual subscriber can receive, however a given subscriber can only rate another particular subscriber once per system defined interval, only registered subscribers can give other subscribers ratings.

46. A database as in claim 16, wherein is maintained a table of permissions to allow subscribers to allow other registered subscribers access to their groups on a temporary or subscriber specific basis, this eliminates the need to give someone else a password to see your data, thus you can open the door to another owner for a day or a week and not have to change any of your passwords when their need to know evaporates, these permissions can be applied on a data set by data set basis.

47. A database as in claim 16, wherein is maintained a table of other subscribers such as neighbors, next of kin etc. who can be contacted with regard to the subscriber. May allow for an even faster first response than from E911, from a trusted neighbor for instance.

48. A database as in claim 16, wherein is maintained a table of information that may be helpful to emergency first responders such as neighbors, police, fire, and EMS. Can also be used for quick missing person or child identification picture posting.

49. A database as in claim 16, wherein is maintained a table of information that may be helpfull to emergency first responders such as neighbors, police, fire, and EMS. Can also be used for quick missing pet identification picture posting.

50. A database as in claim 16, wherein is maintained a table of information that may be helpful for crime investigation and property recovery by police or FBI. Can also be used for quick fixed property owner identification posting, images can be called up in the field by police, the pawn shop or concerned citizens.

51. A database as in claim 16, wherein is maintained a table of information that may be helpful to emergency first responders such as police, fire, and EMS. Can also be used for quick real property owner identification and floor plan/water availability/hazardous material fire fighting planing, other special real property tactical issues.

52. A database as in claim 16, wherein is maintained a table of what are the special capabilities of this subscriber (Ex. language, rescue, medical, tow truck etc.), indicates whether subscriber is generally available to volunteer their service in an emergency or for commercial hire.

53. A database as in claim 16, wherein is maintained a table of land vehicles, a subscriber may have several land vehicles, a device ID would also be permanently affiliated with a vehicle because a vehicle is a “thing” all “things” are devices, enforcement access is allowed if you want friendly cops to call you via cell telephone/pda prior to tow away or ticket or locking boot.

54. A database as in claim 16, wherein is maintained a table of watch lists allowing subscribers to monitor other subscribers and/or their devices for specific status condition changes or status remark keywords, this only works if the watching owner has password approval to the level of being able to view a particular subscribers status, or the watcher needs to be in the watched parties Revelations table.

55. A database as in claim 16, wherein is maintained a table of inform lists allowing subscribers to inform other subscribers and/or their devices of this owner's specific status condition changes or status remark keywords, this only works if the informing subscriber has password approval to the level of being able to view a particular other subscriber's status, or the informer needs to be in the informed parties Revelations table.

56. A database as in claim 16, wherein is maintained a table of configurations defining the specifications for desired display formats for various subscriber generated queries on various subscriber devices, defined from the point of view of the eye of the beholder.

57. A database as in claim 16, wherein is maintained a table of time zones, a description of time zones and their bearing on system parameters, zones are + or − relative to GMT.

58. A database as in claim 16, wherein is maintained a table of fields for a subscriber defined data set, subscribers can define data sets each of which is accessible on the web via any one of their telephone numbers.

59. A method as in claim 3; further comprising th e steps of: query of a master telephone number subscriber database relating all of the telephone numbers associated with a particular subscriber; and allowing or disallowing a particular application or service to perform operations upon, to or from the given telephone number.

60. A method for addressing an Internet website, comprising:
associating a telephone number with a desired website;
contacting said desired website by using said telephone number as an address for said desired website.

61. A method for sending an electronic message to an intended recipient over the Internet, said method comprising:
associating a telephone number with said intended recipient;
sending a message over the internet said intended recipient by using said telephone number as an address for said desired website.
